(19) United States
(12) Patent Application Publication
(10) Pub. No.: US 2011/0228236 A1
(43) Pub. Date: Sep. 22, 2011

(54) PRINTING APPARATUS

(76) Inventor: Satoshi YANAGITA, Saitama-shi (JP)

(21) Appl. No.: 13/042,058

(22) Filed: Mar. 7, 2011

(30) Foreign Application Priority Data
Mar. 19, 2010 (JP) P2010-064386

(51) Int. Cl. G03B 27/00

(52) U.S. Cl. 355/18

(57) ABSTRACT

A printing apparatus with low cost which precisely positions a lenticular sheet while not lowering the usage efficiency of the sheet may be provided. When a margin area is not intentionally formed at an edge portion of a lenticular sheet, based on the print data and the lenticular sheet size, an area serving as an image forming area will certainly be set even with the misalignment in print position of an image. When a margin area is intentionally formed at an edge portion of the lenticular sheet, based on the print data i.e. the set value of the margin area and the lenticular sheet size, the area serving as an image forming area will certainly be set even with the misalignment in print position of an image is calculated. An edge portion of the area necessarily serving as an image forming area obtained by steps S14 and S16 will be determined as the print position of a detection pattern.

### BACKGROUND OF THE INVENTION

1. Field of the Invention

The present invention relates to a printing apparatus, and more particularly, to a printing apparatus capable of producing a photo-print of a three-dimensional image (hereinafter, referred to as “3D print”).

2. Description of the Related Art

When a multi-viewpoint image is printed on a lenticular sheet, the lenticular sheet is scanned to measure the positions of lenses, the inclination of the lenticular sheet or the like, and an image is positioned with the lenticular sheet based on the measured result. However, depending on the types of sensors, the shapes of lenses or the like, the peak of a sensor output may become dull and deteriorates the detection accuracy. Accordingly, to make the peak position of a sensor output accurate, for instance, a method described in the following patent documents are used.

JP3471930B discloses an ink jet recording apparatus for recording an identification image in a margin and detects the positional difference between a lenticular sheet and an image to be printed based on the identification image.

JP2007-127521A discloses a printing apparatus that calculates pattern information corresponding to the lens pitch of a lenticular sheet by reading the lenticular sheet with a scanner.

### SUMMARY OF THE INVENTION

However, in the invention described in JP3471930B, since the identification image is recorded in a margin area, the margin area may increase. Therefore, there is a problem of reduction for the use efficiency of a lenticular sheet. Moreover, the invention described in JP2007-127521A has a problem that the apparatus may become expensive due to the usage of the scanner.

Therefore, the invention has been made in view of the above-mentioned problems and an object of the invention is to provide a printing apparatus capable of positioning a lenticular sheet with high accuracy at a low cost configuration without lowering the sheet-use efficiency.

In order to achieve the object, according to the present invention, there is provided a printing apparatus including: an image acquiring part for acquiring a multi-viewpoint image; a conveying part for conveying a lenticular sheet having a lens face in which a plurality of strip lenses are aligned continuously and a flat printing face arranged on the opposite side of the lens face; an image forming area setting part for setting an image forming area on the lenticular sheet to print the multi-viewpoint image based on the acquired multi-viewpoint image; a print position setting part for setting a print position of a detection pattern including a straight line, based on the acquired multi-viewpoint image, wherein the print position setting part sets the print position of the detection pattern in the image forming area to place the straight line portion of the detection pattern in parallel to the longitudinal direction of the lenses; and a printing part for printing the detection pattern at the print position of the detection pattern and for printing the multi-viewpoint image in the image forming area. Not that the wording “flat” printing face herein includes nearly flat printing face. Moreover, the “straight line portion” of the detection pattern herein may be a portion of the detection pattern partially being formed in straight line, or may be a portion of the detection pattern entirely being formed in straight line.

According to the printing apparatus with such configuration, the image forming area where an area in which an image is printed on is set onto the lenticular sheet and the print position of the detection pattern is set in the image forming area based on the acquired multi-viewpoint image. The detection pattern includes a straight line and the print position of the detection pattern is set to be parallel to the longitudinal direction of the lenses of the lenticular sheet. The detection pattern is printed at the set print position of the detection pattern and the multi-viewpoint image is printed in the image forming area. Therefore, the detection pattern including a straight line in parallel to the longitudinal direction with respect to the lenses of the lenticular sheet can be printed. As a result, detecting the inclination or the like of the lenticular sheet may become easier. Moreover, since the detection pattern is printed in the image forming area, provision of an area for printing the detection pattern is not necessarily required and may improve the use efficiency of the lenticular sheet.

Moreover, the printing apparatus according to the present invention may further include: a reading part for reading the detection pattern by irradiating light to the lenticular sheet and detecting the light reflected from or transmitted through the lenticular sheet; and first inclination detection part for detecting an inclination of the lenticular sheet based on the read result of the detection pattern, wherein the conveying part has a mechanism for correcting the detected inclination of the lenticular sheet.

With such printing apparatus, the detection pattern is read by irradiating light to the lenticular sheet and detecting the light reflected or transmitted by the lenticular sheet, wherein the inclination of the lenticular sheet is detected based on the read result, and the detected inclination of the lenticular sheet will be corrected. As a result, a multi-viewpoint image may be printed in high accuracy and printing time may reduce.

Further, the printing apparatus according to the present invention may further include a sheet size acquiring part for acquiring information representing the size of the lenticular sheet, wherein the image forming area setting part may set the image forming area based on the acquired information representing the size of the lenticular sheet.

With such printing apparatus, the information representing the size of the lenticular sheet will be acquired and the image forming area will be set based on the acquired information representing the size of the lenticular sheet. As a result, the image forming area may be set accurately on the lenticular sheet.

Furthermore, in such printing apparatus according to the present invention, sheet size information representing the size of the lenticular sheet may preferably be indicated on the lenticular sheet, and the sheet size acquiring part may preferably acquire the sheet size information.

With such printing apparatus, the information representing the size of the lenticular sheet is acquired by acquiring the sheet size information indicated on the lenticular sheet. As a result, the information representing the size of the lenticular sheet may be acquired with ease.

Moreover, in the printing apparatus according to the present invention, the image forming area setting part may determine whether a viewpoint-reduced area where the number of viewpoints to be printed is reduced exists in the image forming area, and the print position setting part may set the print position of the detection pattern in the viewpoint-reduced area when the viewpoint-reduced area is determined to exist.

With such printing apparatus, when a viewpoint-reduced area having a reduced number of viewpoints to be printed exists in the image forming area, the print position of the detection pattern is set in the viewpoint-reduced area. Accordingly, the detection pattern is printed in the area in which the multi-viewpoint image is printed with a small number of viewpoints. Since this area has low stereoscopic viewing quality and is thus cut off at the time of providing a printed product, the detection pattern is not displayed in a complete printed product.

Further, the printing apparatus according to the present invention may further include a trimming area setting part for setting a trimming area in the image forming area, and the print position setting part may preferably set the print position of the detection pattern in the area other than the trimming area.

With such printing apparatus, the print position of the detection pattern is set in the area other than the set trimming area in the image forming area. Accordingly, the detection pattern is printed in the area other than the trimming area. When the trimming area is cut off or is covered with a color at the time of providing a complete printed product, the detection pattern can be made to be invisible.

Here, the printing apparatus according to the present invention may preferably further include a cutting part for cutting the trimming area of the lenticular sheet on which the multi-viewpoint image is printed by the printing part.

With such printing apparatus, the trimming area is cut off after the printing of multi-viewpoint image. Therefore, in the complete printed product after cutting off the trimming area, the detection pattern is not visible within the lenticular sheet.

Moreover, in the printing apparatus according to the present invention, it is preferable that the image acquiring part may acquire a multi-viewpoint image with a flame added, the image forming area setting part may set an area in which the frame is printed, out of the area in which the multi-viewpoint image with the flame added is printed, on the lenticular sheet, and the print position setting part may sets the print position of the detection pattern in the area in which the frame is printed.

With such printing apparatus, when a multi-viewpoint image having a frame added thereto is printed, the print position of the detection pattern is set in the area in which the frame is printed and which is set on the lenticular sheet. Therefore, the frame and the detection pattern are printed to overlap with each other. As a result, detection pattern may be difficult to be seen and recognized.

Further, in the printing apparatus according to the present invention, the image forming area setting part may set an area to be printed in black in the image forming area based on the acquired multi-viewpoint image, and the print position setting part may set the print position of the detection pattern in the set area to be printed in black.

With such printing apparatus, the area to be printed in black is set in the image forming area based on the acquired multi-viewpoint image, and the print position of the detection pattern is set in the set area to be printed in black. Therefore, the multi-viewpoint image is printed in black overlapping with the detection pattern. As a result, detection pattern may be difficult to be seen and recognized

Further, in the printing apparatus according to the present invention, the image forming area setting part may preferably set an area to be printed equal to or less than the predetermined brightness in the image forming area based on the acquired multi-viewpoint image, and the print position setting unit setting part may preferably set the print position of the detection pattern in the area to be printed equal to or less than the predetermined brightness.

With such printing apparatus, the area to be printed equal to or less than the predetermined brightness (hereinafter, referred to as “low brightness”) is set in the image forming area based on the acquired multi-viewpoint image and the print position of the detection pattern is set in the set area to be printed in the low brightness. Therefore, the multi-viewpoint image can be printed in the low brightness with the detection pattern being overlapped. As a result, detection pattern may be difficult to be seen and recognized

Furthermore, in the printing apparatus according to the present invention, the printing part may preferably print the detection pattern in black.

With such printing apparatus, since the detection pattern is printed in black, the detection pattern can be read with ease. When the multi-viewpoint image is printed in black or in low brightness overlapping with the black detection pattern, the detection pattern may be difficult to be recognized.

Moreover, the printing apparatus according to the present invention may further include an average brightness calculating part for calculating an average brightness of the area by extracting an area having the same size as the detection pattern from the image forming area, wherein the print position setting part sets the print position of the detection pattern in an area of which the calculated average brightness is the lowest, and the printing part prints the detection pattern in an average color of the area where the calculated average brightness is the lowest.

With such printing apparatus, an area having the same size as the detection pattern is extracted from the image forming area, the average brightness of the area is calculated, the print position of the detection pattern is set in the area of which the calculated average brightness is the lowest, and the detection pattern is printed at the set print position in the average color of the area of which the calculated average brightness is the lowest. As a result, it is possible to make it difficult to see the detection pattern in the completed printed product in which the multi-viewpoint image has been printed.

Further, in the printing apparatus according to the present invention, it is preferable that the image forming area setting part may set an area to be printed in a predetermined color of three colors of Y, M, and C in the image forming area based on the acquired multi-viewpoint image, the print position setting part may set the print position of the detection pattern in the area to be printed in the predetermined color, and the printing part may print the detection pattern in the predetermined color.

With such printing apparatus, an area to be printed in a predetermined color of three colors of Y, M, and C is set in the image forming area based on the acquired multi-viewpoint image, the print position of the detection pattern is set in the set area to be printed in a predetermined color, and the detection pattern is printed at the print position in the predetermined color. Therefore, the multi-viewpoint image is printed around the detection pattern in the same color as the detection pattern. As a result, detection pattern may be difficult to be seen and recognized

Furthermore, in the printing apparatus according to the present invention, it is preferable that the image forming area setting part may set an area to be printed in a predetermined color and a color similar to the predetermined color in the image forming area based on the acquired multi-viewpoint image, the print position setting part may set the print position of the detection pattern in the area to be printed in the predetermined color and the color similar to the predetermined color, and the printing part may print the detection pattern in the predetermined color.

With such printing apparatus, an area to be printed in a color similar to a predetermined color of three colors of Y, M, and C is set in the image forming set area based on the acquired multi-viewpoint image, the print position of the detection pattern is set in the set area to be printed in the color similar to the predetermined color, and the detection pattern is printed at the print position in the predetermined color. Therefore, the multi-viewpoint image is printed around the detection pattern in the color similar to the detection pattern. Therefore, detection pattern may be difficult to be seen and recognized

Moreover, in the printing apparatus according to the present invention, it is preferable that the printing part may not print any image in the area in which the detection pattern is printed.

With such printing apparatus, since an image is not printed in the portion in which the detection pattern has been printed, the detection pattern can be made to form a body along with the multi-viewpoint image in a printed product in which the multi-viewpoint image has been printed. Therefore, detection pattern may be difficult to be seen and recognized, or may be impossible to be seen and recognized.

Further, the printing apparatus according to the present invention may further include a determining part for determining whether the print position setting part can determine a plurality of print positions for the detection pattern. Here, when the print position setting part can determine a plurality of print positions for the detection pattern, the print position setting part may preferably determine the print position of the detection pattern to any one of the print position closest to the reading part, the print position having the largest length in the direction parallel to the longitudinal direction of the lenses, and the print position closest to an edge of the lenticular sheet out of the plurality of print positions for the detection pattern.

With such printing apparatus, when the print position setting part can determine a plurality of print positions for the detection pattern, any one of the print position closest to the reading part, the print position having the largest length in the direction parallel to the longitudinal direction of the lenses, and the print position closest to an edge of the lenticular sheet out of the plurality of print positions for the detection pattern is determined as the print position of the detection pattern. Therefore, the print position of the detection pattern can be determined automatically. When the print position closest to the reading part is set as the print position, the moving distance of a sensor can be reduced. When the print position having the largest length in the direction parallel to the longitudinal direction of the lenses is set as the print position, it is possible to reduce the movement of the reading part in the lateral direction (the direction parallel to the longitudinal direction of the lenses), thereby reducing the time to be taken to detect the detection pattern. When the print position closest to the edge of the lenticular sheet is set as the print position, it is possible to print the detection pattern at a most invisible position.

Furthermore, in the printing apparatus according to the present invention, the detection pattern may preferably include a plurality of straight lines arranged in a direction perpendicular to the longitudinal direction of the lenses or in a direction parallel to the longitudinal direction of the lenses.

With such printing apparatus, the detection pattern including a plurality of straight lines arranged in the directions perpendicular or in a direction parallel to the longitudinal direction of the lenses is printed. Therefore, the inclination of the lenticular sheet can be detected with ease.

Here, in the printing apparatus according to the present invention, the detection pattern may preferably include a straight line representing the print position of the detection pattern.

With such printing apparatus, the detection pattern including the straight line representing the print position of the detection pattern is printed. Accordingly, it is possible to determine the print position of the multi-viewpoint image based on the detection pattern.

Moreover, in the printing apparatus according to the present invention, it is preferable that the multi-viewpoint image may be synthesized by dividing a plurality of images into long and thin striped units and arranging the units divided from the same image so as to be separated from each other, and the detection pattern may be a straight line having a width smaller than the width of the striped units.

With such printing apparatus, the detection pattern is printed in a straight line having a width smaller than the width of the striped units of the multi-viewpoint image synthesized by dividing a plurality of images into long and thin striped units and arranging the units divided from the same image to be separated from each other. Therefore, detection pattern may be difficult to be seen and recognized

Further, in the printing apparatus according to the present invention, the detection pattern may be formed of a text, a figure, or a combination of the text and the figure, and the printing part may preferably print the detection pattern so as to recognize that the detection pattern is formed a text, a figure, or a combination of the text and the figure.

With such printing apparatus, the detection pattern formed of a text, a figure, or a combination of the text and the figure is printed so as to recognize the text, the figure, or the combination of the text and the figure. Therefore, it is possible to detect the inclination of the lenticular sheet while exhibiting the text or the figure represented by the detection pattern.

Here, in the printing apparatus according to the present invention, the printing part may preferably print the detection pattern so that the longitudinal direction of the detection pattern is parallel to the longitudinal direction of the lenses.

With such printing apparatus, since the longitudinal direction of the detection pattern is parallel to the longitudinal direction of the lenses, it is possible to easily detect the inclination of the lenticular sheet.

Furthermore, in the printing apparatus according to the present invention, it is preferable that the printing part may print a straight line in parallel to the longitudinal direction of the detection pattern in adjacent to the detection pattern or may print a frame surrounding the detection pattern.

With such printing apparatus, a straight line in parallel to the longitudinal direction of the detection pattern is printed along with the detection pattern in adjacent to the detection pattern formed of the text, the figure, or the combination of the text and the figure. Alternatively, a frame surrounding the detection pattern formed of the text, the figure, or the combination of the text and the figure may be printed along with the detection pattern. Therefore, the inclination of the lenticular sheet can be detected with ease.

Moreover, the printing apparatus according to the present invention may further include a detection pattern information acquiring part for acquiring information on the detection pattern, wherein the printing part prints the detection pattern in a font including many straight line portions or a segment display including many straight line portions when the information of the detection pattern is representing the detection pattern included with a text.

With such printing apparatus, when the detection pattern includes a text, the detection pattern is printed in a font including many straight line portions or a segment display. Therefore, the detection pattern which may include many straight line portions may be printable.

Further, the printing apparatus according to the present invention may further include a detection pattern analyzing part for analyzing the directions and the lengths of the straight lines included in the detection pattern, wherein the printing part prints the detection pattern with the direction of the longest straight line being parallel to the longitudinal direction of the lenses, or with the direction in which the total length of the straight lines being the largest is parallel to the longitudinal direction of the lenses.

With such printing apparatus, the directions and the lengths of the straight lines included in the detection pattern are analyzed and the detection pattern is printed so that the direction of the longest straight line is parallel to the longitudinal direction of the lenses or so that the direction in which the total length of the straight lines is the largest is parallel to the longitudinal direction of the lenses. Therefore, the inclination of the lenticular sheet can be detected with ease.

Furthermore, in the printing apparatus according to the present invention, the printing part may preferably print the detection pattern with the enlarged detection pattern in the longitudinal direction of the lenses.

With such printing apparatus, the detection pattern is enlarged and printed in the longitudinal direction of the lenses. Therefore, the straight line portion is elongated and it is thus easy to detect the inclination of the lenticular sheet.

Moreover, in the printing apparatus according to the present invention, it is preferable that the printing part may print an arbitrary straight line at an arbitrary position of the lenticular sheet, the printing apparatus further comprising, a second inclination detecting part for detecting the inclination of the lenticular sheet based on the straight line printed at an arbitrary position of the lenticular sheet, wherein the conveying part corrects the detected inclination of the lenticular sheet, and the printing part prints the detection pattern on the lenticular sheet with the inclination being corrected by the conveying part.

With such printing apparatus, the inclination of the lenticular sheet is detected based on the straight line printed at the arbitrary position of the lenticular sheet, the detected inclination of the lenticular sheet is corrected, and the detection pattern is printed on the lenticular sheet of which the inclination has been corrected. Therefore, the detection pattern in parallel to the longitudinal direction of the lenses of the lenticular sheet can be printed.

The acquiring part may acquire a multi-viewpoint image including at least four images of which two images can be seen from the front side of the lenticular sheet at the time of printing the multi-viewpoint image on the lenticular sheet, the image forming area setting part may set an area in which an image not visible to the front side of the lenticular sheet out of at least four images is printed in the image forming area, and the print position setting part may set the print position of the detection pattern in the area in which the image not visible to the front side of the lenticular sheet is printed. Therefore, the detection pattern can be made invisible from the front side. As a result, detection pattern may be difficult to be seen and recognized

The acquiring part may acquire a multi-viewpoint image including at least four images of which two different images can be seen from different positions at the time of printing the multi-viewpoint image on the lenticular sheet, the image forming area setting part may set an area in which one desired image of the two different images is printed in the image forming area, and the print position setting part may set the print position of the detection pattern in the area in which the desired image is printed. Therefore, the detection pattern is visible to one eye of a viewer viewing the printed product. As a result, detection pattern may be difficult to be seen and recognized

According to the above-mentioned configurations of the present invention, a lenticular sheet can be positioned with high accuracy without lowering the sheet-use efficiency, and can lower the cost of the printing apparatus.

### BRIEF DESCRIPTION OF THE DRAWINGS

FIG. 1 is a diagram illustrating the appearance of a printing apparatus 10.

FIG. 2 is a diagram schematically illustrating the inside of the printing apparatus 10 at the time of feeding a printing medium.

FIG. 3 is a perspective view schematically illustrating the configuration of a clamper and a clamper conveying part.

FIG. 4 is a plan view schematically illustrating the configuration of the clamper and the clamper conveying part.

FIG. 5 is a diagram schematically illustrating the detection result of a photo interrupter.

FIG. 6 is a block diagram partially illustrating the configuration of the printing apparatus 10.

FIG. 7 is a flow diagram illustrating the process flow of printing a detection pattern on a lenticular sheet by the use of the printing apparatus 10.

FIG. 8 is a flow diagram illustrating the process flow of correcting the inclination of a lenticular sheet at the time of printing a detection pattern on a lenticular sheet by the use of the printing apparatus 10.

FIG. 9 is a diagram schematically illustrating the relationship of an image forming area and a printing position of a detection pattern.

FIG. 10 is a diagram schematically illustrating the relationship of the image forming area and the detection pattern.

FIG. 11 is a flow diagram illustrating the flow of a printing process.

FIG. 12 is a flow diagram illustrating the process flow of printing a detection pattern on a lenticular sheet by the use of another printing apparatus 10B.

FIG. 13 is a diagram schematically illustrating the relationship of an image forming area and a printing position of a detection pattern.

FIG. 14 is a flow diagram illustrating the process flow of printing a detection pattern on a lenticular sheet by the use of another printing apparatus 10C.

FIG. 15 is a diagram schematically illustrating the relationship of an image forming area and a printing position of a detection pattern.

FIG. 16 is a flow diagram illustrating the process flow of printing a detection pattern on a lenticular sheet by the use of another printing apparatus 10D.

FIG. 17 is a diagram schematically illustrating the relationship of an image forming area and a printing position of a detection pattern.

FIG. 18 is a flow diagram illustrating the process flow of printing a detection pattern on a lenticular sheet by the use of another printing apparatus 10E.

FIG. 19 is a diagram schematically illustrating the relationship of an image forming area and a printing position of a detection pattern.

FIG. 20 is a flow diagram illustrating the process flow of printing a detection pattern on a lenticular sheet by the use of another printing apparatus 10F.

FIG. 21 is a diagram schematically illustrating a process of extracting a black area from print data.

FIGS. 22A, 22B, and 22C are diagrams schematically illustrating the relationship of a black area and a print position of a detection pattern.

FIG. 23 is a flow diagram illustrating the process flow of printing a detection pattern on a lenticular sheet by the use of another printing apparatus 10G.

FIG. 24 is a diagram schematically illustrating a process of extracting a low-brightness area from print data.

FIG. 25 is a flow diagram illustrating the process flow of printing a detection pattern on a lenticular sheet by the use of another printing apparatus 10H.

FIG. 26 is a diagram schematically illustrating a process of extracting an area having the lowest average brightness out of areas with a predetermined width and a predetermined length from print data.

FIG. 27 is a flow diagram illustrating the process flow of printing a detection pattern on a lenticular sheet by the use of another printing apparatus 101.

FIGS. 28A, 28B, 28C, and 28D are diagrams schematically illustrating a process of extracting color areas of Y, M, C, and B from print data.

FIG. 29 is a diagram schematically illustrating the relationship of the color areas and a print position of a detection pattern.

FIG. 30 is a flow diagram illustrating the process flow of printing a detection pattern on a lenticular sheet by the use of another printing apparatus 10J.

FIG. 31 is a diagram illustrating a color solid.

FIG. 32 is a flow diagram illustrating the process flow of printing a detection pattern on a lenticular sheet by the use of another printing apparatus 10K.

FIG. 33 is a diagram schematically illustrating the relationship of print positions of multi-viewpoint images and lenses 100a in case of multi-viewpoint images including four images (hereinafter, referred to as “4-viewpoint images”).

FIGS. 34A and 34B are diagrams schematically illustrating the relationship of a print position of a detection pattern and the visibility of the detection pattern.

FIG. 35 is a flow diagram illustrating the process flow of printing a detection pattern on a lenticular sheet by the use of another printing apparatus 10L.

FIGS. 36A and 36B are diagrams schematically illustrating the relationship of a print position of a detection pattern and the visibility of the detection pattern.

FIG. 37 is a flow diagram illustrating the process flow of printing a detection pattern on a lenticular sheet by the use of another printing apparatus 10M.

FIGS. 38A to 38H are diagrams illustrating examples of a detection pattern including viewpoint information.

FIG. 39 is a flow diagram illustrating the process flow of printing a detection pattern on a lenticular sheet by the use of another printing apparatus 10N.

FIGS. 40A and 40B are diagrams illustrating examples of a detection pattern formed of a figure.

FIGS. 41A and 41B are diagrams illustrating examples of a detection pattern formed of a figure.

FIGS. 42A and 42B are diagrams illustrating examples of a detection pattern formed of a text.

FIGS. 43A and 43B are diagrams illustrating examples of a detection pattern formed of a figure.

FIG. 44 is a diagram illustrating an example of a barcode type detection pattern.

### DESCRIPTION OF THE PREFERRED EMBODIMENTS

Hereinafter, printing apparatuses according to preferred embodiments of the present invention will be described with reference to the accompanying drawings.

### First Embodiment

### Entire Configuration of Printing Apparatus

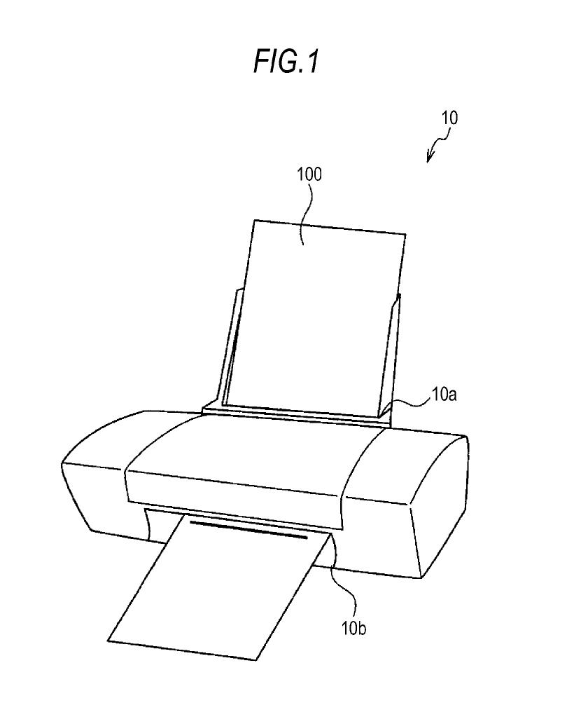

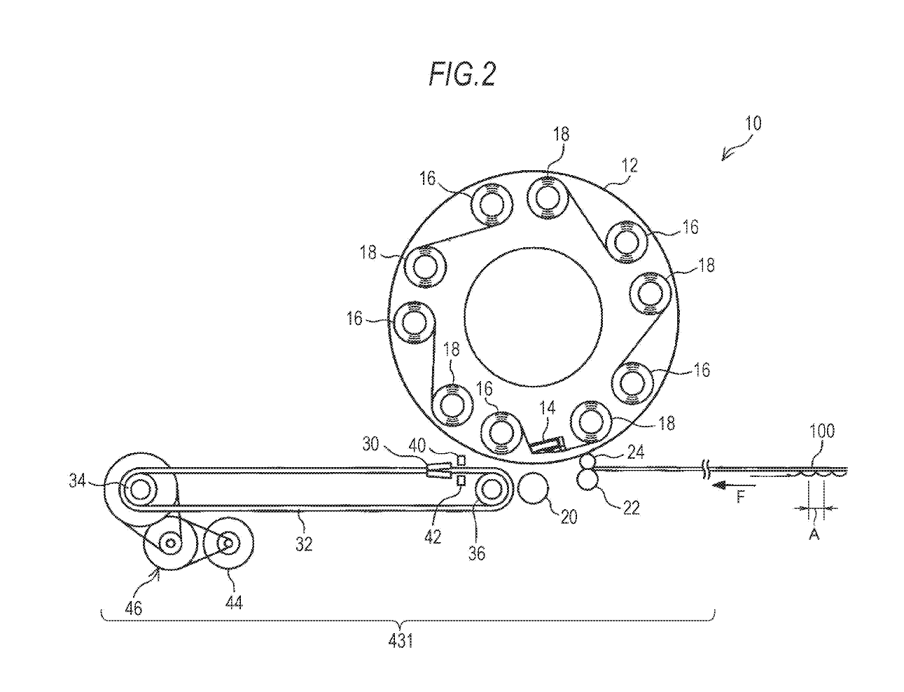

FIG. 1 is a front perspective view schematically illustrating the appearance of a printing apparatus 10 according to a first embodiment of the present invention. FIG. 2 is a diagram schematically illustrating the inside of the printing apparatus 10 and shows a state where a printing sheet is being fed.

As shown in FIG. 1, the printing apparatus 10 is a 3D printer that feeds a lenticular sheet 100 (to be described in detail later), which is formed of a transparent resin and has a lens face on which so-called lenticular lenses having a group of lenses and a printing face opposite to the lens face, from a sheet feeding part 10a on the back side and discharges the lenticular sheet from a sheet discharging part 10b on the front side.

The printing apparatus 10 is a sublimation printer using ink ribbons of Y (Yellow), M (Magenta), C (Cyan), K (black), and W (White) and repeats forward feed (in a direction from the sheet feeding part 10a to the sheet discharging part 10b at the time of printing: see arrow F in FIG. 2) and backward feed (backward feeding to print start position) for each print color as shown in FIG. 2. The ink ribbon of K is not essential, but the color of black may be printed using the ink ribbons of Y, M, and C.

As shown in FIG. 2, the printing apparatus 10 includes a sheet conveying mechanism 431 for conveying a lenticular sheet 100 mainly at the time of printing, for example, a ribbon-exchanging Gatling mechanism mounted with at least ink ribbons of Y, M, C, K, and W, and a thermal head 14.

Lenticular Sheet

As shown in FIG. 2, the lenticular sheet 100 is a plate-like member in which substantially arc-like strip lenses 100a are continuously formed at a constant pitch A on one surface (hereinafter, referred to as “lens face”) and the other surface (hereinafter, referred to as “printing face”) is formed substantially flat. An ink receiving layer is formed on the entire printing face of the lenticular sheet 100. When the printing face is subjected to a printing operation, printed ink is accumulated in the ink receiving layer and the stereoscopic viewing is possible by viewing the ink receiving layer from the lens face.

The lenticular sheet 100 is formed of a flexible transparent resin having thermal resistance corresponding to the printing operation of the thermal head 14, such as polycarbonate (PC), polyethylene terephthalate (PET), and acryl (PMMA), for example. The thickness of the lenticular sheet 100 is not particularly limited and is, for example, 0.3 mm.

Sheet Conveying Mechanism

The sheet conveying mechanism 431 includes a carrier roller 22, a capstan 24, a clamper 30, and a clamper conveying part moving the clamper 30.

The lenticular sheet 100 is set in the sheet feeding part 10a so that the longitudinal direction of the lenses 100a is substantially perpendicular to the conveying direction. The leading edge of lenticular sheet 100 introduced from the sheet feeding part 10a reaches the position of the carrier roller 22 as shown in FIG. 2. Here, by pressing the capstan 24 against the carrier roller 22 with the lenticular sheet 100 interposed therebetween and driving the carrier roller 22, the lenticular sheet 100 is carried.

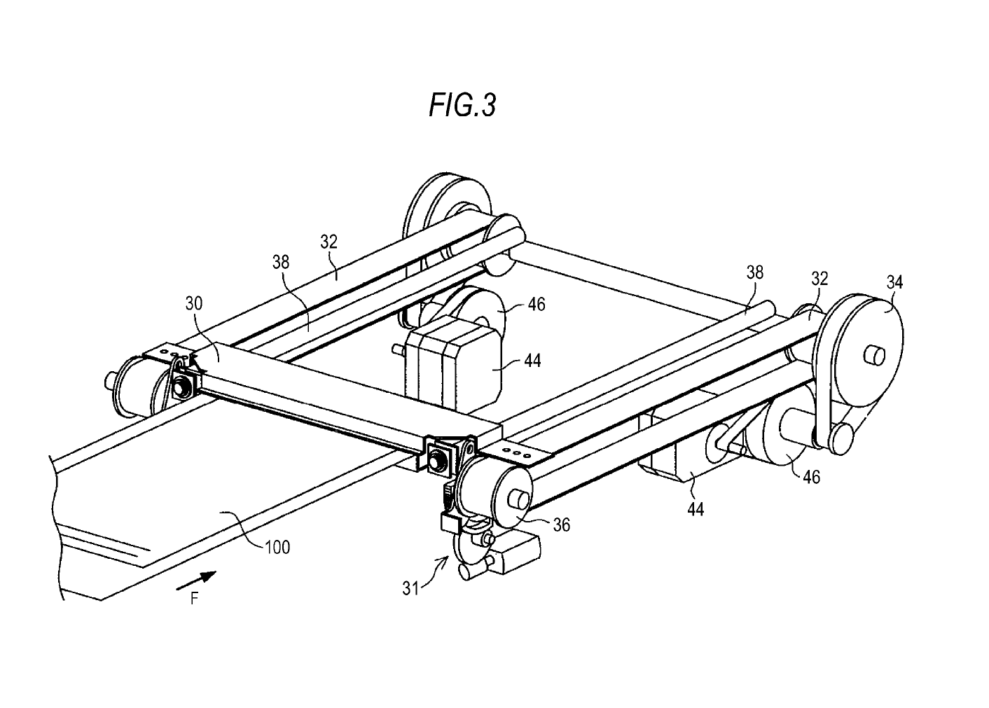

The conveying of the lenticular sheet 100 by the carrier roller 22 and the capstan 24 is carried out until the leading edge of the lenticular sheet 100 reaches the clamper 30 which is on standby at an initial position (the rightmost end in the movable range of the clamper 30 in FIG. 2). In the clamper 30, a pair of clamp members are normally urged in the closing direction by a spring, but the pair of clamp members are on standby in the open state against the urging force of the spring by a switching mechanism 31 (see FIG. 3) formed of a cam or the like, when the clamper is on standby.

When the leading edge of the lenticular sheet 100 reaches the clamper 30, the leading edge of the lenticular sheet 100 is clamped by the clamper 30 and the capstan 24 (see FIG. 2) is evacuated from the carrier roller 22. Thereafter, the lenticular sheet 100 is carried along with the clamper 30 by the clamper conveying part.

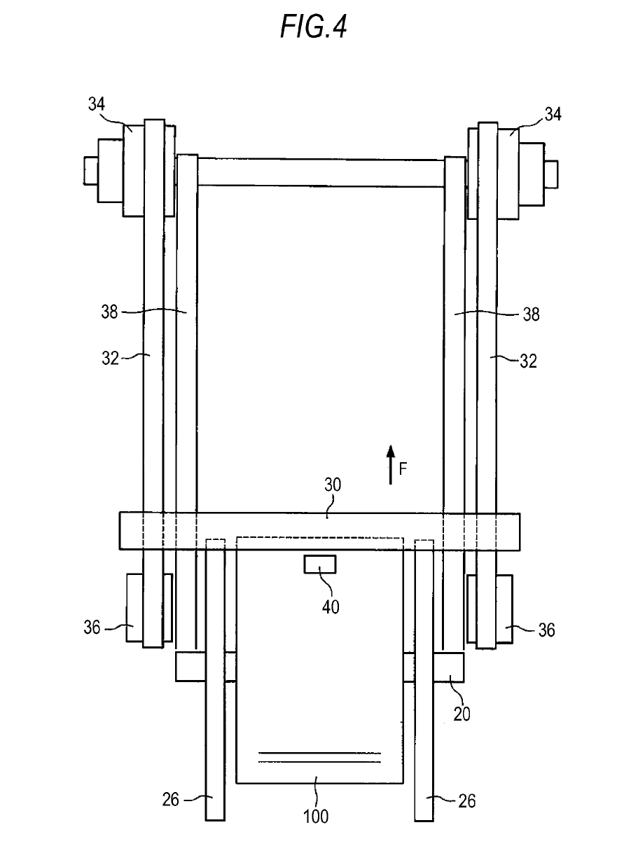

FIGS. 3 and 4 are plan views schematically illustrating the configurations of the clamper 30 and the clamper conveying part. The clamper conveying part includes a driving belt 32, a driving pulley 34, a driven pulley 36, and a guide rail 38.

A pair of driving pulleys 34 to be driven via reduction gears 46 by driving motors 44, respectively, are disposed at the right end in FIG. 3 and a pair of driven pulleys 36 are disposed in the vicinity of a platen roller 20.

The driving belts 32 are wound between the driving pulley 34 and the driven pulley 36, and the clamper 30 is fixed between the driving belts 32 with a bolt (not shown) as shown in FIG. 3.

Guide rails 38 guiding the clamper 30 in the vertical direction are disposed along the driving belts 32 and resin guides 26 (see FIG. 4) guiding the lenticular sheet 100 to the clamper 30 which is on standby at the initial position are disposed. Rubber guides may be used instead of the resin guides 26.

The width between a pair of resin guides 26 is greater than the width of the lenticular sheet 100 by a predetermined clearance, and the resin guides 26 guide the lenticular sheet 100 in the vertical direction.

As shown in FIGS. 2 and 4, photo interrupters 40 and 42 are disposed between the platen roller 20 and the clamper 30. The photo interrupter 40 emitting light is disposed above the conveying path of the lenticular sheet 100 (on the side close to a ribbon cage 12), and the photo interrupter 42 receiving light is disposed at a position opposed to the photo interrupter 40 with the conveying path of the lenticular sheet 100 interposed therebetween.

The photo interrupters 40 and 42 are movable in the lateral direction of FIG. 4. A predetermined area in the vicinity of the center in the horizontal direction (in the longitudinal direction of the lenses 100a) of the lenticular sheet 100 is read by the photo interrupter 42.

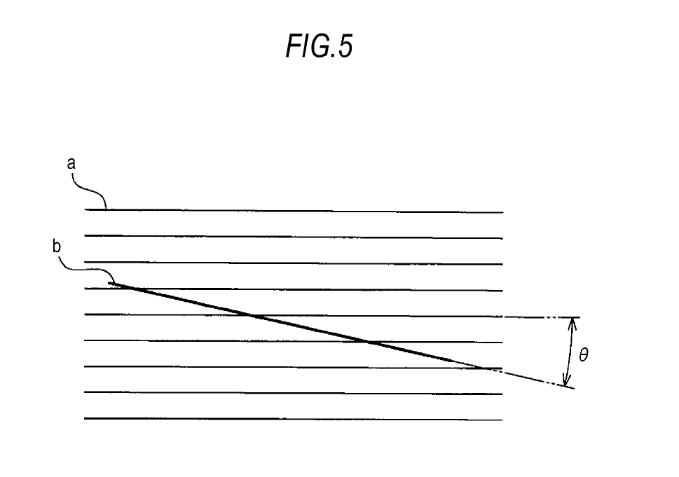

An example of a detection signal of the lenticular sheet 100 detected by the photo interrupter 42 is shown in FIG. 5. As indicated by reference sign a in FIG. 5, the brightness of the valleys of the lenses 100a of the lenticular sheet 100 is lowered (it goes black). When a detection pattern 100b (to be described in detail later) or a straight line pattern (to be described in detail later) is printed on the lenticular sheet 100, the printed part of the detection pattern 100b or the straight line pattern is lowered in brightness (it goes black), as indicated by reference sign b in FIG. 5. By calculating an angle θ formed by the longitudinal direction (reference sign a in FIG. 5) of the lenses 100a and the detection pattern 100b or the straight line pattern (reference sign b in FIG. 5), it is possible to detect an inclination (azimuth) of the lenticular sheet 100.

The adjustment of the azimuth (adjustment of the azimuth to 0) of the lenticular sheet 100 is carried out by clamping the leading edge of the lenticular sheet 100 by the use of the clamper 30, independently driving the pair of left and right driving pulleys 34, and slightly inclining the clamper 30 by the adjusted azimuth. Accordingly, the sheet rotates and the longitudinal direction of the lenses of the lenticular sheet becomes parallel to the scanning direction of the printer head. The method of adjusting the azimuth is not limited to the above-mentioned method, but various known methods can be used.

As described above, by adjusting the azimuth and then conveying the clamper 30 in the forward direction (in the direction of arrow F in FIG. 2), the lenticular sheet 100 is carried to a print start position and then the printing operation using the thermal head 14 is started. When the printing operation of one color is finished, a returning operation of reversing the driving pulleys 34 to move the clamper 30 in parallel to the right side (the opposite direction of arrow F) in FIG. 2 and returning the lenticular sheet 100 to the print start position again is performed.

Ribbon-Exchanging Gatling Mechanism and Thermal Head

As shown in FIG. 2, the ribbon-exchanging Gatling mechanism includes the ribbon cage 12, winding reels 16, and supply reels 18.

Five sets of the winding reel 16 and the supply reel 18 are arranged at a constant interval in the ribbon cage 12 and ink ribbons of Y (Yellow), M (Magenta), C (Cyan), K (Black), and W (White) are set onto the five sets of reels. The ribbon cage 12 is made to rotate by the Gatling mechanism (not shown) so that a desired ribbon is located at the position of the thermal head 14.

The winding reel 16 of a pair of the winding reel 16 and the supply reel 18 moving to the position of the thermal head 14 winds an ink ribbon thereon via a frictional clutch at a speed slightly higher than the moving speed of the lenticular sheet 100 at the time of printing and the supply reel 18 is braked so that a predetermined back tension acts on the ink ribbon. Accordingly, when the lenticular lens 100 moves at the time of printing, the ink ribbon is fed with (in synchronization with) the movement of the lenticular sheet 100.

The thermal head 14 is disposed inside the ribbon cage 12, is located at a print position coming in contact with the platen roller 20 with the ink ribbon and the lenticular sheet 100 interposed therebetween at the time of printing, and is located at an evacuated position to which it is evacuated from the platen roller 20 at the time of exchanging the ink ribbons or backwardly feeding the lenticular sheet 10.

As described later, the thermal head 14 is driven in accordance with a multi-viewpoint image for 3D image and sublimates and transfers the ink on the ink ribbon to the lenticular sheet 100.

Control System of Printing Apparatus

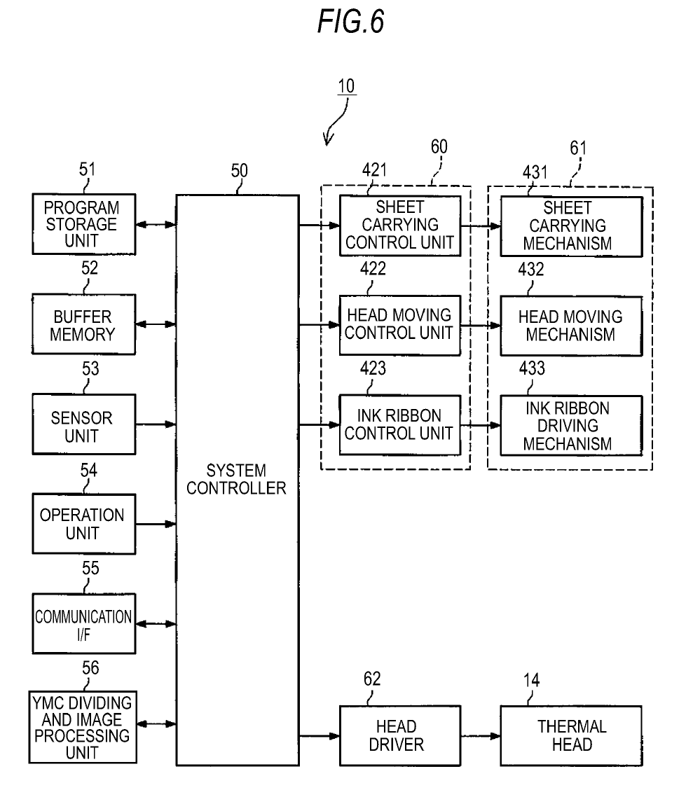

The control system of the printing apparatus 10 having the above-mentioned configuration will be described below. FIG. 6 is a block diagram illustrating the partial configuration of the printing apparatus 10.

The printing apparatus 10 includes a system controller 50, a program storage part 51, a buffer memory 52, a sensor part 53, an operation part 54, a communication interface (communication I/F) 55, an YMC dividing and image processing part 56, a control part 60, a mechanism part 61, a header driver 62, and a thermal head 14.

The system controller 50 is a portion comprehensively controlling the portions by the use of a 3D printing program and an example thereof is a CPU (Central Processing Unit). The 3D printing program is stored in the program storage part 51 formed of a computer-readable nonvolatile recording medium such as a ROM. The system controller 50 properly reads and executes the program stored in the program storage part 51.

The buffer memory 52 is a portion temporarily storing a two-viewpoint image (right and left images) received via the communication I/F 55 from a personal computer (PC) or a digital camera (not shown) or print data generated by the YMC dividing and image processing part 56. The size of sheets set into the sheet feeding part 10a and the print size of an image (the size of the image and the number of used lenses 100a), for example, are stored as the print setting information in the buffer memory 52.

The sensor part 53 includes the photo interrupters 40 and 42 shown in FIG. 4 or a sensor detecting positions or rotation angles of various members of the mechanism part 61, for example, and outputs the detected signals to the system controller 50.

The sensor part 53 detects a detection pattern 103 (to be described in detail later) recorded on the lenticular sheet 100 and outputs the detected signals to the system controller 50. The system controller 50 detects a degree of rotation (a degree of inclination) of the lenticular sheet 100 with respect to the conveying path of the lenticular sheet 100, a pitch, a print start position and the like based on the detected signals.

The operation part 54 includes a power switch, a print start switch, a switch setting the number of prints and the like and a signal resulting from the operation of the operation part 54 is input to the system controller 50.

The YMC dividing and image processing part 56 acquires colorful two-viewpoint images (right and left images) obtained by photographing the same subject with a 3D camera or the like and calculates the misalignment of feature points having the same feature (the inter-pixel misalignment (a degree of parallax)) from the right and left images for each pixel. The YMC dividing and image processing part adjusts the calculated degree of parallax for the 3D printing and then interpolates the adjusted degree of parallax to generate print data of a multi-viewpoint image including plural images. For example, in case of a multi-viewpoint image including six images, the YMC dividing and image processing part 56 color-converts six images of R, G, and B into images of Y, M, and C and generates Y signals, M signals, and C signals of six images from the color-converted print data. The YMC dividing and image processing part divides the Y signals, the M signals, and the C signals of six images into strip units with a predetermined width and sequentially arranges the striped units to generate the Y signals, M signals, and C signals of one image as print data.

The YMC dividing and image processing part 56 corrects the Y signals, M signals, and C signals of one image corresponding to the pitch A of the lenticular sheet 100 as needed when the pitch of the generated Y signals, M signals, and C signals of one image is different from the pitch A of the lenticular sheet 100.

The processes performed by the YMC dividing and image processing part 56 may be performed by a PC connected thereto via the communication I/F 55 and the results may be received via the communication I/F 55.

The system controller 50 outputs control signals to the control part 60 in accordance with the printing sequence and controls the driving of the mechanism part 61 by the use of the control part 60.

The control part 60 includes the sheet conveying control part 421, a head moving control part 422, and an ink ribbon control part 423.

The mechanism part 61 includes the sheet conveying mechanism 431, a head moving mechanism 432, and an ink ribbon driving mechanism 433.

The sheet conveying mechanism 431 is constructed by a clamper conveying part including the carrier roller 22, the capstan 24, the clamper 30, the driving motor 44 and the like shown in FIG. 2 and the like. The sheet conveying control part 421 conveys the lenticular sheet 100 introduced through the use of the sheet conveying mechanism 431 to the platen roller 20 and conveys the lenticular sheet 100 in parallel at the time of printing.

The head moving mechanism 432 includes an actuator not shown and the head moving control part 422 moves the thermal head 14 through the use of the head moving mechanism 432 between the print position where the thermal head comes in contact with the platen roller 20 and the evacuation position.

The ink ribbon driving mechanism 433 includes a Gatling mechanism (not shown) rotating the ribbon cage 12 and a reel driving mechanism driving five sets of the winding reel 16 and the supply reel 18 disposed in the ribbon cage 12. The ink ribbon control part 423 rotates the ribbon cage 12 through the use of the ink ribbon driving mechanism 433 and feeds the ink ribbon.

In the thermal head 14, plural heating elements are arranged in a direction perpendicular to the conveying direction of the lenticular sheet 100. The system controller 50 controls the temperatures of the heating elements through the use of a head driver 62 so as to have the concentration corresponding to the print data for each straight line based on the print data stored in the buffer memory 52, sublimates the ink of the ink ribbon to transfer the ink to the lenticular sheet 100, subsequently conveys the lenticular sheet 100 through the use of the sheet conveying mechanism 431 by one straight line, and performs the thermal transfer of ink on the straight lines by sequentially repeating theses processes.

Operation of Printing Apparatus

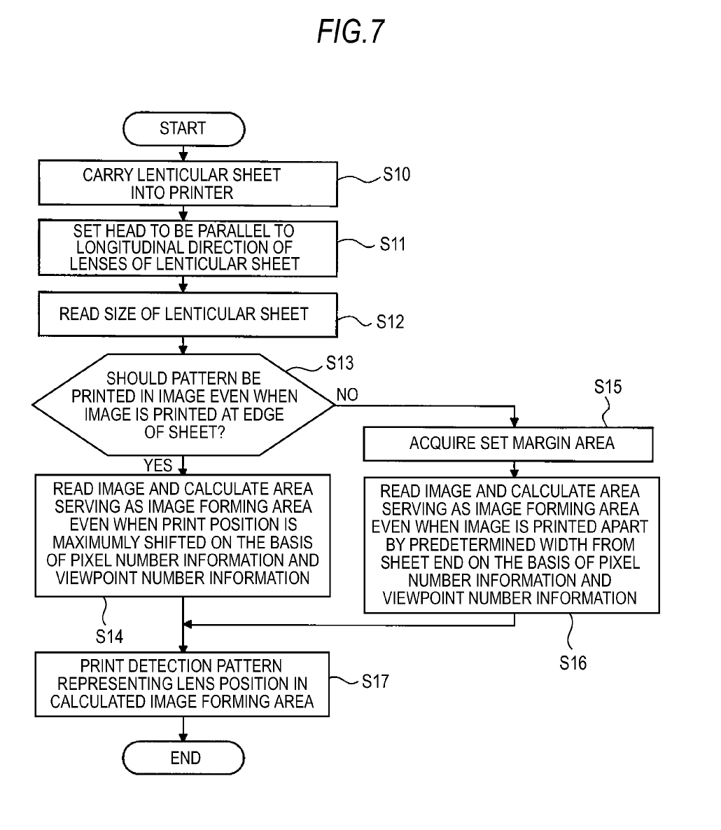

The operation of the printing apparatus 10 will be described below. In this embodiment, the detection pattern 100b is printed on the lenticular sheet 100 before performing a printing operation. FIG. 7 is a flow diagram illustrating the process flow of printing the detection pattern 100b. This printing process flow is controlled by the system controller 50. A program for causing the system controller 50 to perform the process flow is stored in the program storage part 51.

The system controller 50 conveys the lenticular sheet 100 introduced from the sheet feeding part 10a into the printing apparatus 10 through the use of the sheet conveying mechanism 431 (step S10). In this step, the leading edge of the lenticular sheet 100 is clamped by the clamper 30 and the lenticular sheet 100 is roughly positioned.

The system controller 50 adjusts the angle of the lenticular sheet 100 through the use of the sheet conveying mechanism 431 so that the conveying direction of the lenticular sheet 100 is perpendicular to the longitudinal direction of the lenses 100a, that is, so that the arrangement direction of the thermal head 14 is parallel to the longitudinal direction of the lenses 100a (step S11).

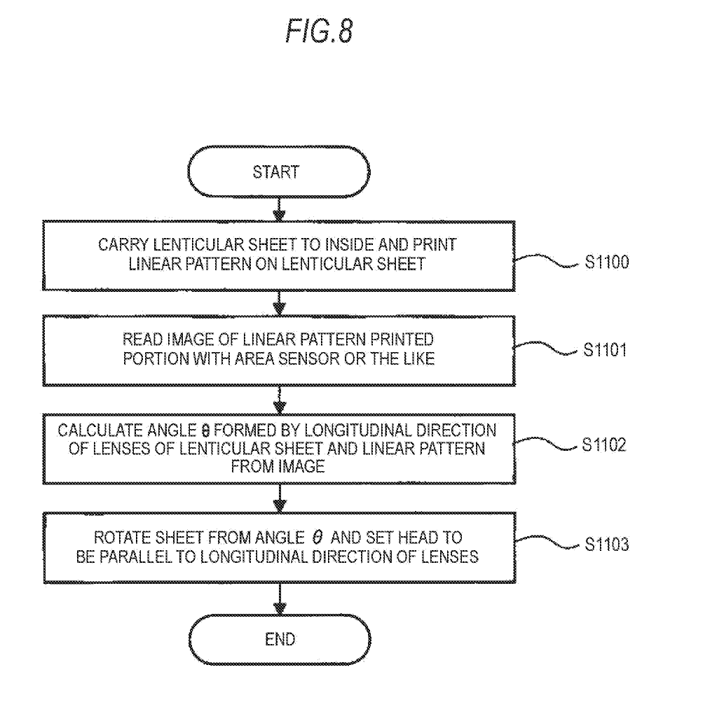

FIG. 8 is a flow diagram illustrating the process flow adjusting the angle of the lenticular sheet 100 so that the arrangement direction of the thermal head 14 is parallel to the longitudinal direction of the lenses 100a (step S11).

A straight line pattern is printed at an arbitrary position of the lenticular sheet 100 (step S1100). The straight line pattern is different from the detection pattern 100b and is printed in the vicinity of an edge of the lenticular sheet 100. The straight line pattern is preferably printed in a thinnest straight line which can be detected by the photo interrupters 40 and 42.

The lenticular sheet 100 is carried up to a position where an area having the straight line pattern printed therein can be detected by the photo interrupters 40 and 42 and a detection signal is acquired by the photo interrupters 40 and 42 (step S1101).

The inclination of the lenses 100a about the straight line pattern is calculated based on the detection signal acquired in step S22 (step S1102). The inclination is calculated by calculating the angle formed by the straight line representing a low-brightness portion, that is, valley portions of the lenses 100a, and the straight line representing the straight line pattern.

The system controller 50 independently drives a pair of right and left driving pulleys 34 through the use of the sheet conveying control part 421 and inclines the clamper 30 by the angle calculated in step S24 (step S1103). Accordingly, the inclination calculated in step S24 becomes 0. that is, the arrangement direction of the thermal head 14 becomes parallel to the longitudinal direction of the lenses 100a.

In this way, the arrangement direction of the thermal head 14 becomes parallel to the longitudinal direction of the lenses 100a (step S11). In this embodiment, the straight line pattern is printed and the inclination of the straight line pattern and the lens 100a, that is, the inclination of the lenticular sheet 100, is calculated, but the method of detecting the inclination of the lenticular sheet 100 is not limited to this method. The inclination of the lenticular sheet 100 may be detected without printing the straight line pattern. However, the printing of the straight line pattern facilitates the detection of the inclination and thus it is preferable that the straight line pattern is printed to detect the inclination.

A lenticular sheet size is acquired based on the detection result of the sensor part 53 (step S12). The lenticular sheet size is information including the width in the lateral direction of the lenticular sheet 100, the length in the longitudinal direction (direction perpendicular to the longitudinal direction of the lenses 100a) of the lenticular sheet 100, and the pitch of the lenses 100a.

In step S12, the width of the lenticular sheet 100 can be acquired by detecting the lenticular sheet 100 while moving the photo interrupters 40 and 42 in the lateral direction. The length of the lenticular sheet 100 can be acquired by detecting the lenticular sheet 100 while moving the clamper 30. When the size of the sheet set into the sheet feeding part 10a is input and stored in the buffer memory 52, the width and the length of the lenticular sheet 100 can be acquired by acquiring the information without using the detection result of the sensor part 53.

The pitch of the lenses 100a can be acquired by detecting straight lines representing the valley portions of the lenses 100a through the use of the photo interrupters 40 and 42 and calculating the width of the straight lines while moving the clamper 30 in a state where the arrangement direction of the thermal head 14 is parallel to the longitudinal direction of the lenses 100a.

When an image is printed at an edge of the lenticular sheet 100, it is determined whether the detection pattern 100b should be printed in the image (step S13). This is a step of determining whether a margin area should be intentionally formed at the edge of the lenticular sheet 100. It is set in advance whether a margin area should be intentionally formed at the edge of the lenticular sheet 100, and the set information is stored in the buffer memory 52. The determination of step S13 is performed based on the stored information.

When it is determined that a margin area should not be intentionally formed at the edge of the lenticular sheet 100 (YES in step S13), the system controller 50 sets an area necessarily serving as an image forming area in spite of the misalignment in print position of a multi-viewpoint image based on the print data stored in the buffer memory 52 and the lenticular sheet size acquired in step S12 (step S14). The image forming area is an area in which a multi-viewpoint is printed on the lenticular sheet 100. When the print start position varies, the image forming area also varies. Accordingly, in step S14, the area necessarily serving as an image forming area is calculated even when the print position of a multi-viewpoint image is misaligned from the lenticular sheet 100 (for example, when an image is printed at the right end of a sheet and when an image is printed at the left end of a sheet).

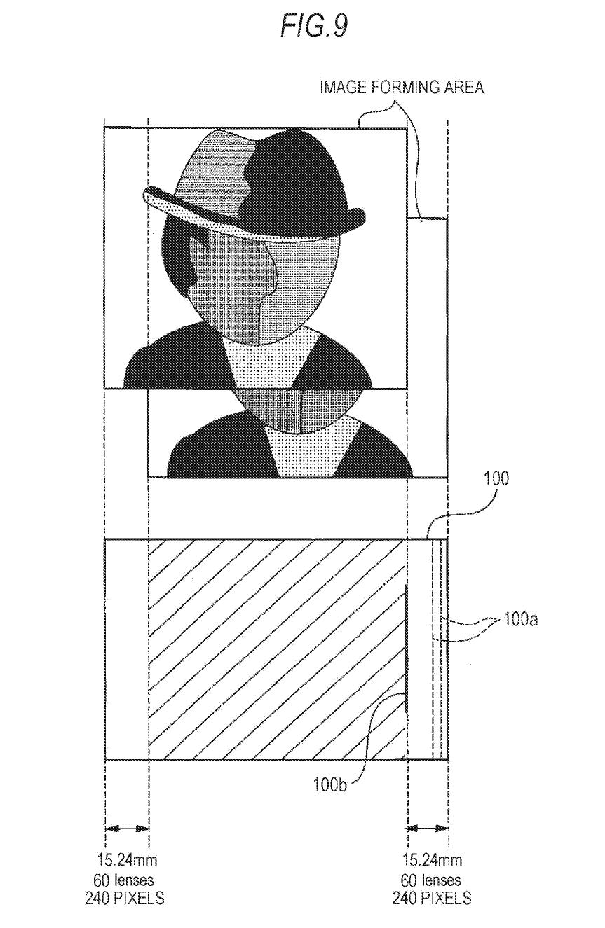

The process of step S14 will be specifically described with reference to FIG. 9. In FIG. 9, a four-viewpoint image is printed. The number of viewpoints is information representing the number of positions where a multi-viewpoint image is formed. For example, when a multi-viewpoint image is formed at two predetermined positions, the multi-viewpoint image is a two-viewpoint image. The number of viewpoints means the number of drawings constituting a multi-viewpoint image. For example, a four-viewpoint image includes four images, that is, two sets of a right-eye image and a left-eye image.

First, the number of pixels in the lateral direction of the multi-viewpoint image is calculated by the use of Expression 1 and the maximum margin (mm), the number of maximum-margin lenses, and the number of maximum-margin pixels (pixels) are calculated by the use of Expression 2.

Number of Pixels (pixels) in Lateral Direction of Multi-viewpoint Image=Number of Viewpoints×Number of Used Lenses 100a Expression 1

Maximum Margin (mm)=Length (mm) of Lenticular Sheet 100−Number of Used Lenses 100a×Pitch of Lenses 100a A (mm) Expression 2

Number of Maximum-margin Lenses=Maximum Margin (mm)/Pitch of Lenses 100a A (mm)

Number of Maximum-margin Pixels (pixels)=Number of Maximum-margin Lenses×Number of Viewpoints

Since the number viewpoints is four, the number of pixels in the lateral direction of an image is calculated as 1280 pixels when 320 lenses 100a are used. When the length of the lenticular sheet 100 is 96.52 mm, the maximum margin is 15.24 mm, the number of maximum-margin lenses is 60, and the number of maximum-margin pixels is 240.

Accordingly, in the hatched area (an area close to the image center by 15.24 mm or more from both ends of the lenticular sheet 100, an area close to the image center by 60 lenses 100a or more from both ends of the lenticular sheet 100, or an area close to the image center by 240 or more pixels from both ends of the lenticular sheet 100) in FIG. 9, it can be seen that a multi-viewpoint image is necessarily printed even when the print position of the multi-viewpoint image is misaligned. This area is set to an area necessarily serving as an image forming area.

When it is determined that a margin area is intentionally formed at an edge of the lenticular sheet 100 (NO in step S13), the system controller 50 acquires a set value of the margin area from the buffer memory 52 (step S15), and calculates an area necessarily serving as an image forming area in spite of the misalignment in print position out of the image forming area based on the print data and the set value of the margin area stored in the buffer memory 52 and the lenticular sheet size acquired in step S12 (step S16).

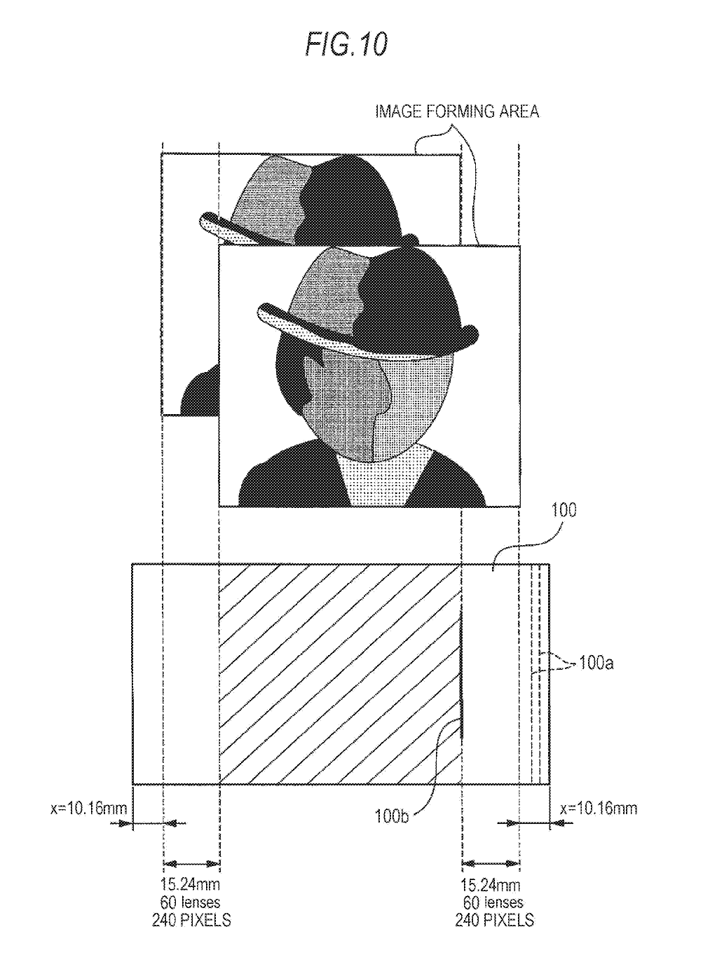

The process of step S16 will be specifically described with reference to FIG. 10. In FIG. 10, a four-viewpoint image (including two sets of a right-eye image and a left-eye image) is printed similarly to FIG. 9. The set value of the margin area is assumed as x (mm).

First, the number of pixels in the lateral direction of an image is calculated by the use of Expression 1 and the maximum margin (mm), the number of maximum-margin lenses (pieces), and the number of maximum-margin pixels (pixels) are calculated by the use of Expression 3

Maximum Margin (mm)=(Length (mm) of Lenticular Sheet 100−Set value of Margin Area (mm)×2)−Number of Used Lenses 100a×Pitch of Lenses 100a A (mm) Expression 3

Number of Maximum-margin Lenses=Maximum Margin (mm)/Pitch of Lenses 100a A (mm)

Number of Maximum-margin Pixels (pixels)=Number of Maximum-margin Lenses×Number of Viewpoints

The number of lenses (pieces) and the number of maximum-margin pixels (pixels) in the margin area are calculated by the use of Expression 4.

Number of Lenses (pieces) in Margin Area=x/Pitch of Lenses 100a A (hereinafter, referred to as “x/A”) Expression 4

Number of Maximum-margin Pixels (pixels)=x/A×Number of Viewpoints

When x is 10.16 mm and pitch A is 0.254 mm, the number of lenses in the margin area is calculated as 40 pieces and the number of maximum-margin pixels is calculated as 160 pixels.

Similarly to FIG. 9, it is assumed that the maximum margin is calculated as 15.24 mm, the number of maximum-margin lenses is calculated as 60 pieces, and the number of maximum-margin pixels is calculated as 240 pixels. Then, in the hatched area (an area close to the image center by the maximum margin+the margin area from the edge of the lenticular sheet 100, that is, an area close to the image center by 25.4 mm or more from both ends of the lenticular sheet 100, an area close to the image center by 100 lenses 100a or more from both ends of the lenticular sheet 100, or an area close to the image center by 400 or more pixels from both ends of the lenticular sheet 100) in FIG. 10, it can be seen that a multi-viewpoint image is necessarily printed even when the print position of the multi-viewpoint image is misaligned. This area is set to an area necessarily serving as an image forming area.

The system controller 50 sets the print position of the detection pattern 100b parallel to the longitudinal direction of the lenses 100a to an edge portion of the area (the hatched area in FIGS. 9 and 10) necessarily serving as an image forming area determined in step S14 and 16. The clamper 30 is driven through the use of the sheet conveying control part 421 to convey the lenticular sheet 110 so that the set print position is located just below the thermal head 14. As shown in FIGS. 9 and 10, the system controller 50 rotates the ribbon cage 12 to move the ink ribbon of K to the position of the thermal head 14, and electrifies the thermal head 14 to emit heat while winding the ink ribbon on the winding reel 16 through the use of the ink ribbon driving mechanism 433 at a speed slightly higher than the moving speed of the lenticular sheet 100. Accordingly, the detection pattern 100b is printed at the edge portion of the area necessarily serving as an image forming area, that is, the print position of the detection pattern 100b (step S17).

In step S17, it is necessary to detect the edge of the lenticular sheet 100 and to move the lenticular sheet 100 up to the edge portion of the area necessarily serving as an image forming area from the edge of the lenticular sheet 100. In steps S14 and 16, the distance from the edge of the lenticular sheet to the edge portion of the area (the hatched areas in FIGS. 9 and 10) necessarily serving as an image forming area is calculated using three types of length (mm), the number of lenses, and the number of pixels (pixels). Therefore, when the print position of the detection pattern 100b is calculated based on the edge of the lenticular sheet 100, the print position of the detection pattern 100b is calculated using the length and the number of lenses (for example, a position close to the inside from the edge of the lenticular sheet 100 by 15.24 mm or a position close to the inside from the edge of the lenticular sheet 100 by 60 lenses 100a). When plural multi-viewpoint images are printed on a single lenticular sheet 100, the print position of the detection pattern 100b is calculated based on the end of a printed image. In this case, the print position of the detection pattern 100b is calculated using the number of pixels in addition to the length and the number of lenses (for example, a position close to the inside from the end of the printed image by 240 pixels).

At the same time as printing the detection pattern 100b, information on the image forming area (for example, information on the maximum margin area determined in step S14 and information on the maximum margin area and the margin area determined in step S16) or information on the print position of the detection pattern 100b (an edge portion of the area necessarily serving as an image forming area in this embodiment) is stored in the buffer memory 52.

Accordingly, the detection pattern 100b is printed in the area necessarily serving as an image forming area. Since the arrangement direction of the thermal head 14 is set to be parallel to the longitudinal direction of the lenses 100a in step S11, the detection pattern 100b is printed to be parallel to the longitudinal direction of the lenses 100a. Thereafter, an operation of printing an image is performed.

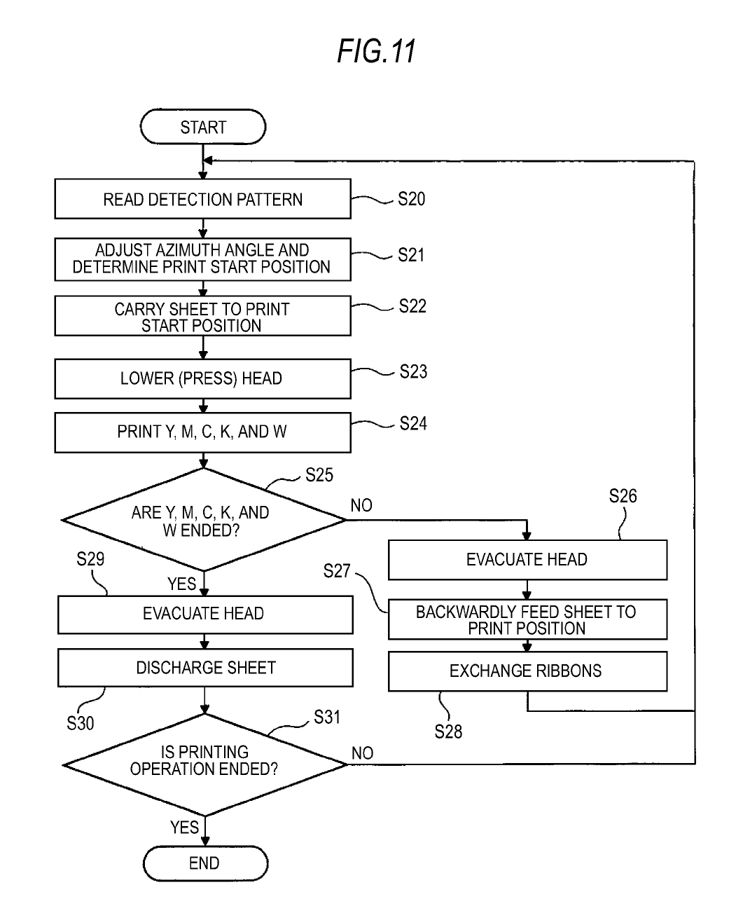

FIG. 11 is a flow diagram illustrating the flow of printing processes in the printing apparatus 10. Hereinafter, the description will be made with reference to this flow diagram. The flow of printing processes is controlled by the system controller 50. The program causing the system controller 50 to perform the flow of printing processes is stored in the program storage part 51.

The lenticular sheet 100 is carried, the detection pattern 100b is read by the photo interrupters 40 and 42, and a detection signal is acquired by the photo interrupter 42 (step S20). When the photo interrupters 40 and 42 are moved in the lateral direction of FIG. 4 to end the reading of a predetermined straight line, the clamper 30 is moved by one straight line (the width which can be read by the photo interrupters 40 and 42) and the photo interrupters 40 and 42 are moved in the lateral direction of FIG. 4 to read a predetermined straight line. By repeating this operation, a predetermined area including the detection pattern 100b is read.

The azimuth is adjusted and the print start position is determined based on the detection signal (step S21). As shown in FIG. 5, by calculating the angle θ formed by the longitudinal direction of the lenses 100a and the detection pattern 100b, the inclination (azimuth angle) of the lenticular sheet 100 is detected. When the angle θ is not 0, the system controller 50 rotates the lenticular sheet 100 by the degree of inclination θ through the sheet conveying mechanism 431.

At the time of printing the detection pattern 100b, the information on the image forming area or the information on the position in which the detection pattern 100b is printed is stored in the buffer memory 52. The system controller 50 determines that the position which is separated by a predetermined amount from the detection pattern 100b to the edge of the lenticular sheet 100 is the print start position based on the detection result of the detection pattern 100b and the information stored in the buffer memory 52. The predetermined amount may be set as the distance of lenses or as the number of lenses 100a. The distance of lenses that move can be calculated from the moving distance of the clamper 30 and the number of lenses 100a that move can be calculated by counting the number of valleys of the lenses 100a.

As in this embodiment, when the detection pattern 100b is printed in the area necessarily serving as an image forming area in spite of the misalignment in print position of a multi-viewpoint (which corresponds to the first embodiment and the second embodiment (to be described in detail later) of the present invention), the process of step S21 is not necessary. This is because a multi-viewpoint image is necessarily printed at the position where the detection pattern 100b is printed even when the printing operation is started from any position.

The lenticular sheet 100 is backwardly carried so that the print start position calculated in step S21 is located just below the thermal head 14 (step S22). In steps S14 and 16, the distance from the edge of the lenticular sheet to the edge portion of the area (the hatched areas in FIGS. 9 and 10) necessarily serving as an image forming area is calculated using three types of length (mm), the number of lenses, and the number of pixels (pixels). Therefore, the print start position may be calculated using the movement distance from the detection pattern 100b, may be calculated using the number of lenses that move therefrom, or may be calculated using the number of pixels that move therefrom.

The head moving mechanism 432 is controlled by the head moving control part 422 so as to press the thermal head 14 to the platen roller 20 with a desired ink ribbon of Y, M, C, K, or W and the lenticular sheet 100 interposed therebetween (step S23).

The system controller 50 controls the sheet conveying control part 421 to rotate the driving motor 44 so as to drive the clamper 30 and to convey the lenticular sheet 100 in the forward direction (see the arrow F in FIGS. 1 to 3). In synchronization therewith, the system controller 50 electrifies the thermal head 14 to emit heat while causing the ink ribbon driving mechanism 433 to wind the ink ribbon on the winding reel 16 at a speed slightly higher than the moving speed of the lenticular sheet 100. Accordingly, a heated color material is transferred from the desired color ink ribbon of Y, M, C, K, and W to the printing face of the lenticular sheet 100 to form an image (step S24).

The system controller 50 determines whether the heated color material is transferred to the printing face of the lenticular sheet 100 to form an image for all the color ink ribbons of Y, M, C, K, and W (step S25).

When it is determined that the printing operation is not performed for all the color ink ribbons of Y, M, C, K, and W (NO in step S25), the system controller 50 controls the head moving mechanism 423 through the use of the head moving control part 422 so as to move the thermal head 14 to a position not interfering with the ink ribbon (step S26). Thereafter, the system controller 50 controls the sheet conveying mechanism 431 through the use of the sheet conveying control part 421 so as to backwardly convey the lenticular sheet 100 until reaching the print start position (cue position) (step S27), and controls the ink ribbon driving mechanism 433 through the use of the ink ribbon control part 423 so as to rotate the ribbon cage 12 up to the position of a color ink ribbon to be set in the next time (step S28).

After the sheet cue (step S27) and the exchange of ink ribbons (step S28), the process (step S20) of reading the detection pattern 100b and the process (step S21) of adjusting the azimuth angle or determining the print start position are performed again in step S20. In order to improve the printing accuracy, it is necessary to adjust the azimuth angle or to determine the print start position as well as to exchange the ink ribbons. It is easy to adjust the azimuth angle or to determine the print start position by using the detection pattern 100b.

In this case, the print start position can be also determined using any one of the movement distance, the number of lenses that move, and the number of pixels that move from the detection pattern 100b. However, since only one printing operation has been performed, it may be difficult to detect the valleys of the lenses 100a. Accordingly, it is preferable that the print start position is calculated using the movement distance or the number of pixels that move from the detection pattern 100b.

When it is determined that the printing operation is performed for all the color ink ribbons of Y, M, C, K, and W (YES in step S25), the system controller 50 controls the head moving mechanism 432 through the use of the head moving control part 422 so as to move the thermal head 14 to a position not interfering with the ink ribbons (step S29). Thereafter, the system controller 50 controls a cutter (not shown) to cut a certain area of the leading and trailing edges of the lenticular sheet 100 after printing all the colors and controls a discharge mechanism (not shown) to discharge the lenticular sheet 100 (step S30).

The system controller 50 determines whether the printing operation is performed for all the sheets (step S31). When it is determined that the printing operation is performed for all the sheets (YES in step S31), the process flow is ended. When it is determined that the printing operation is not performed for all the sheets (NO in step S31), the process returns to step S20, the feeding of a next sheet is started in step S20.

The peripheral edge of the discharged (step S30) lenticular sheet 100 other than the image forming area is cut off. Accordingly, an image print is completed.

As described above, according to this embodiment, it is possible to print an image so as to overlap with the detection pattern. Therefore, it is not necessary to provide a margin area for recording the detection pattern and it is possible to effectively use the printing sheet.

According to this embodiment, since the detection pattern is used at the time of printing, it is possible to adjust the azimuth angle for a short time. Therefore, it is possible to print a three-dimensional image with high accuracy.

According to this embodiment, it is not necessary to provide an expensive apparatus such as a scanner and it is possible to print the detection pattern with a simple and cheap structure similarly to the known printers.

Although it has been described in this embodiment that an edge portion of the area (the hatched area in FIGS. 9 and 10) necessarily serving as an image forming area is set as the print position of the detection pattern 100b and the detection pattern 100b is printed at the print position, the print position of the detection pattern 100b is not limited to such a position. For example, in the vicinity of an edge portion of the area (the hatched area in FIGS. 9 and 10) necessarily serving as an image forming area, a position corresponding to the ridges of the lenses 100a or the valleys of the lenses 100a may be set as the print position of the detection pattern 100b. The substantial center of the area necessarily serving as an image forming area may be set as the print position of the detection pattern 100b.

Although it has been described in this embodiment that the detection pattern 100b is detected (step S40) by repeatedly performing the operation of moving the clamper 30 by one straight line, moving the photo interrupters 40 and 42 in the lateral direction in FIG. 4, and reading a predetermined straight line, the method of detecting the detection pattern 100b is not limited to this method. For example, plural sets of photo interrupters may be arranged to be parallel to the platen roller 20 and the detection signal may be acquired by the photo interrupters while moving the clamper 30 at a constant speed. In this case, when the detection pattern 100b is simultaneously detected by the plural photo interrupters, it can be determined that the conveying direction of the lenticular sheet 100 is substantially perpendicular to the longitudinal direction of the lenses 100a. In this case, since it is not necessary to detect the valleys of the lenses 100a or the like, it is easier to detect the detection pattern.

In this embodiment, the area necessarily serving as an image forming area in spite of the misalignment in print position of a multi-viewpoint is set and the print position of the detection pattern 100b is determined in the area necessarily serving as an image forming area. However, when the print start position of an image is not misaligned, for example, when the image is necessarily printed from the edge of the lenticular sheet 100, an image forming area may be determined based on the print start position of an image and the print position of the detection pattern 100b may be determined in the image forming area. By using this method, the present invention is not limited to a sheet-like lenticular sheet having a predetermined size, but may be applied to a lenticular sheet wound in a roll shape.

Although it has been described in this embodiment that the detection pattern is printed using the ink ribbon of K, that is, black, the print color of the detection pattern is not limited to black and the detection pattern may be printed using other ink ribbons such as Y, M, and C.

### Second Embodiment

Although it has been described in the first embodiment of the present invention that the area (the hatched area in FIGS. 9 and 10) necessarily serving as an image forming area is determined based on the maximum margin area and the detection pattern is then printed, the method of determining the area necessarily serving as an image forming area is not limited to this method.

In a second embodiment of the present invention, the area necessarily serving as an image forming area can be more easily determined when a lenticular sheet having a regular size is used. A printing apparatus 10B according to the second embodiment of the present invention will be described below. The configuration, the control system, and the printing process in the operation of the printing apparatus 10B are the same as those of the printing apparatus 10 and thus are not described. The process of printing the detection pattern 100b will be described. The same elements as the first embodiment are referenced by the same reference numerals and signs and are not described.

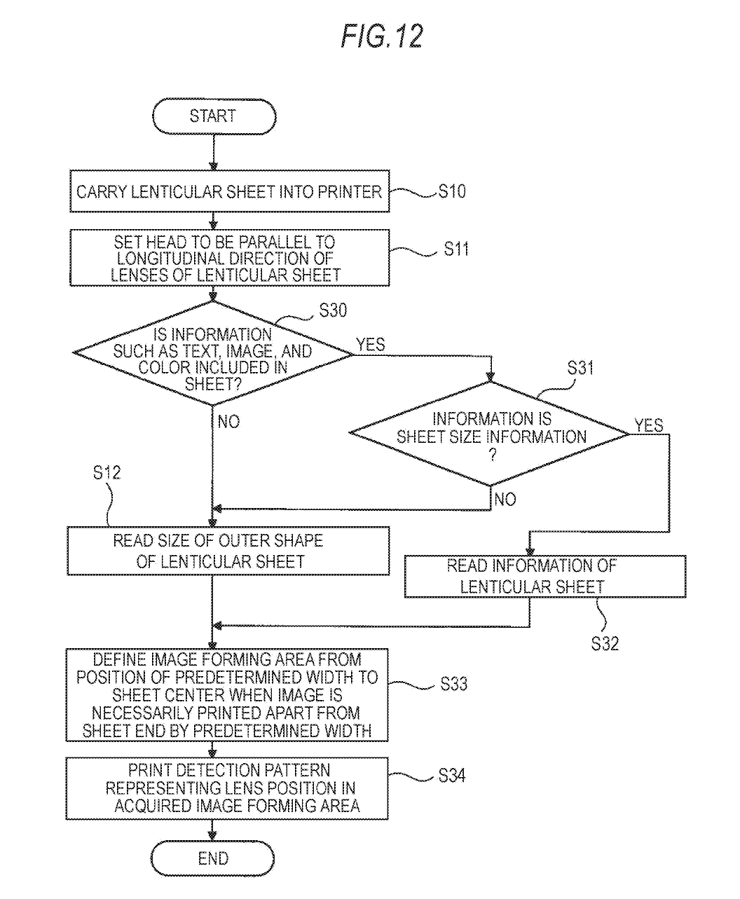

FIG. 12 is a flow diagram illustrating the process flow of printing the detection pattern 100b. This printing process is controlled by the system controller 50. The program causing the system controller 50 to perform the printing process is stored in the program storage part 51.

The system controller 50 conveys the lenticular sheet 100 introduced from the sheet feeding part 10a into the printing apparatus 10 through the use of the sheet conveying mechanism 431 (step S10). In this step, the leading edge of the lenticular sheet 100 is clamped by the clamper 30 and the lenticular sheet 100 is roughly positioned.

The system controller 50 adjusts the angle of the lenticular sheet 100 through the use of the sheet conveying mechanism 431 so that the conveying direction of the lenticular sheet 100 is perpendicular to the longitudinal direction of the lenses 100a, that is, so that the arrangement direction of the thermal head 14 is parallel to the longitudinal direction of the lenses 100a (step S11).

The system controller 50 acquires the detection signal by the use of the photo interrupters 40 and 42 while forwardly or backwardly feeding the lenticular sheet 100 through the use of the sheet conveying control part 421 and determines whether information such as a text, an image, a color, and an outer shape is included in the lenticular sheet 100 (step S30). When it is determined that the information such as a text, an image, a color, and an outer shape is included in the lenticular sheet 100 (YES in step S30), the system controller 50 determines whether the information is information on the sheet size (step S31). The information on the sheet size means text information such as A4, A5, and 210×297.

When it is determined that the information such as a text, an image, a color, and an outer shape included in the lenticular sheet 100 is the information on the sheet size (YES in step S31), the system controller reads out the information and acquires the sheet size (step S32). When a text such as A4 and A5 is read, the system controller acquires the sheet size with reference to a sheet size list stored in the program storage part 51. For example, when the text of A4 is read, a size of a width of 210 mm and a length of 297 mm is acquired. When the text of 210×297 is read, for example, a size of a width of 210 mm and a length of 297 mm is directly acquired.

When it is determined that the information such as a text, an image, a color, and an outer shape is not included in the lenticular sheet 100 (NO in step S30) and when the information such as a text, an image, a color, and an outer shape included in the lenticular sheet 100 is not the information on the sheet size (NO in step S31), the system controller acquires the lenticular sheet size based on the detection result of the sensor part 53 (step S12).

In this embodiment, since a margin area is formed in an edge of a sheet, the system controller 50 acquires the set value of the margin area from the buffer memory 52 and determines the image forming area based on the print data and the set value of the margin area recorded in the buffer memory 52 and the lenticular sheet size acquired in steps S12 and S32 (step S33).

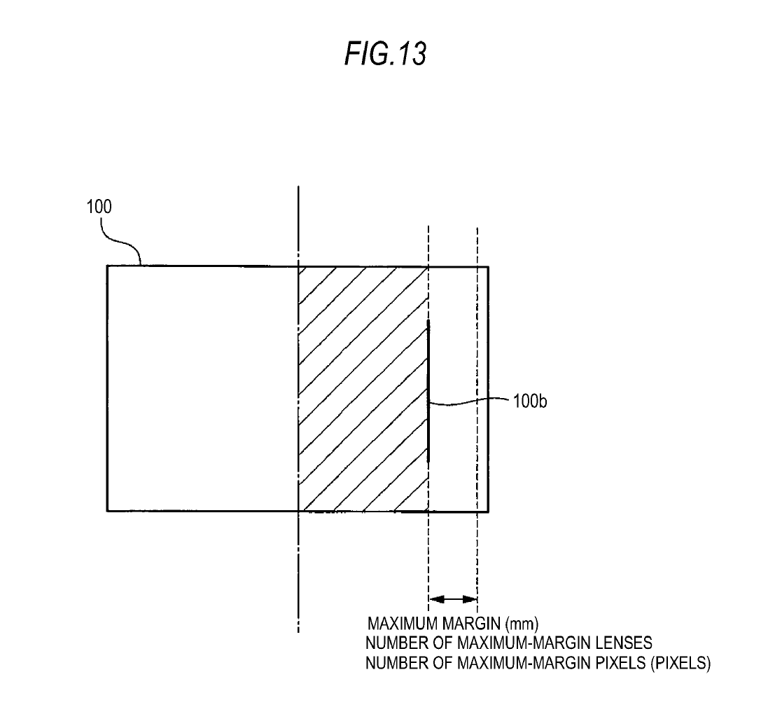

The process of step S23 will be specifically described with reference to FIG. 13. The number of pixels in the lateral direction of an image is calculated by the use of Expression 1 and the maximum margin (mm), the number of maximum-margin lenses, and the number of maximum-margin pixels (pixels) are calculated by the use of Expression 2. As indicated by the hatched portion in FIG. 13, the area from an edge portion of the margin area to the sheet center is determined as the image forming area.

Similarly to the example shown in FIG. 9, it is assumed that the maximum margin is calculated as 15.24 mm, the number of maximum-margin lenses is calculated as 60 pieces, and the number of maximum-margin pixels is calculated as 240 pixels. When the length of the lenticular sheet 100 is 96.52 mm, the area from the position apart by 15.24 mm from the edge of the lenticular sheet 100 to the position apart by 40.64 therefrom is determined as the image forming area.

The system controller 50 prints the detection pattern 100b at an edge portion of the image forming area determined in step S33 (step S34). Since the arrangement direction of the thermal head 14 is set to be parallel to the longitudinal direction of the lenses 100a in step S11, the detection pattern 100b is printed to be parallel to the longitudinal direction of the lenses 100a. Thereafter, an image is printed.

In this embodiment, since the detection pattern is printed in the image forming area, it is not necessary to form a margin and it is possible to improve the sheet-use efficiency. Particularly, when a lenticular sheet with a regular size is used, it is not necessary to detect the sheet size using the sensors, thereby more easily determining the image forming area.

Although it has been described in this embodiment that the detection pattern is printed using the ink ribbon of K, that is, black, the print color of the detection pattern is not limited to black but the detection pattern may be printed using other ink ribbons such as Y, M, and C.

### Third Embodiment

Although it has been described in the first embodiment of the present invention that the detection pattern is printed at an edge portion of the area necessarily serving as an image forming area in spite of the misalignment in print position, the print position of the detection pattern is not limited to this position.

In a third embodiment of the present invention, the detection pattern is printed in an area where the number of viewpoints is reduced due to parallax correction and distortion correction of a stereoscopic image. A printing apparatus 10C according to the third embodiment of the present invention will be described below. The configuration, the control system, and the printing process in the operation of the printing apparatus 10C are the same as those of the printing apparatus 10 and thus are not described. The process of printing the detection pattern 100b will be described. The same elements as the first embodiment are referenced by the same reference numerals and signs and are not described.

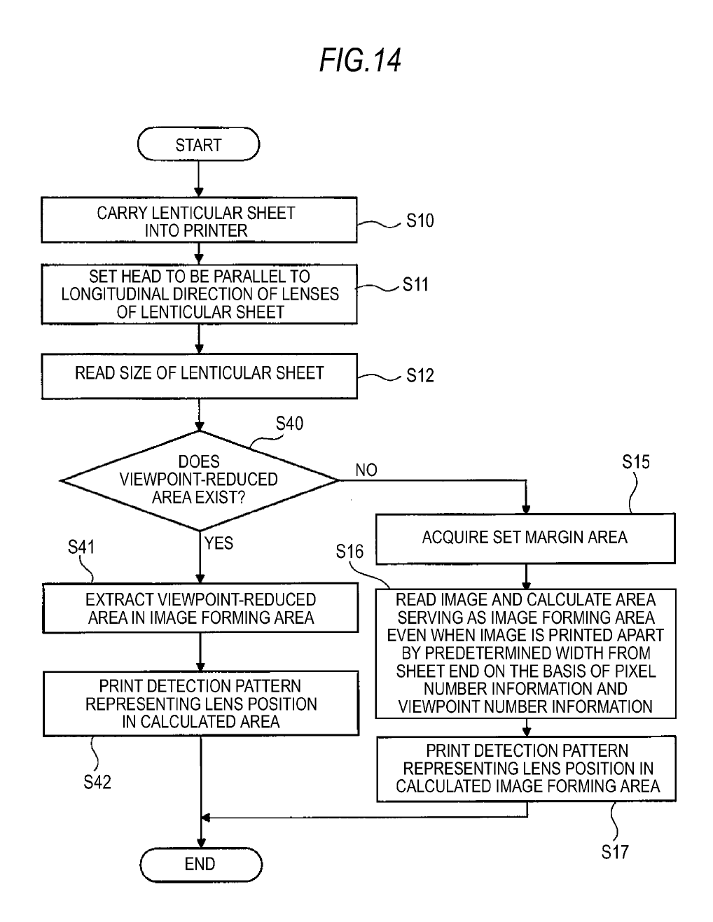

FIG. 14 is a flow diagram illustrating the process flow of printing the detection pattern 100b. This printing process is controlled by the system controller 50. The program causing the system controller 50 to perform the printing process is stored in the program storage part 51.

The system controller 50 conveys the lenticular sheet 100 introduced from the sheet feeding part 10a into the printing apparatus 10 through the use of the sheet conveying mechanism 431 (step S10). In this step, the leading edge of the lenticular sheet 100 is clamped by the clamper 30 and the lenticular sheet 100 is roughly positioned.

The system controller 50 adjusts the angle of the lenticular sheet 100 through the use of the sheet conveying mechanism 431 so that the conveying direction of the lenticular sheet 100 is perpendicular to the longitudinal direction of the lenses 100a, that is, so that the arrangement direction of the thermal head 14 is parallel to the longitudinal direction of the lenses 100a (step S11) and acquires the lenticular sheet size based on the detection result of the sensor part 53 (step S12).

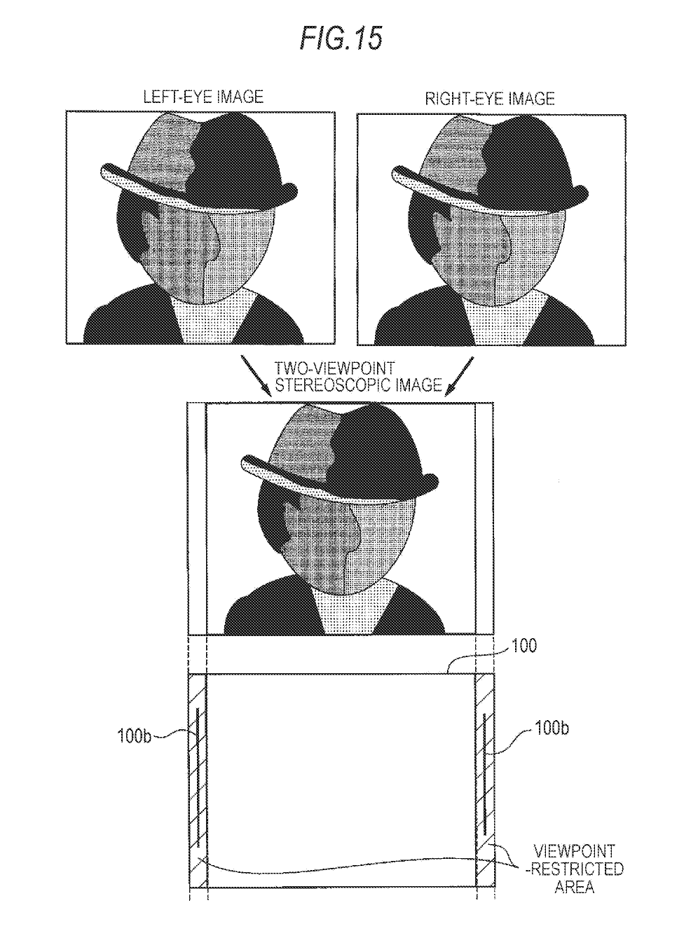

The YMC dividing and image processing part 56 performs the parallax correction, the distortion correction, and the like on the print data as needed and stores the corrected print data in the buffer memory 52. The system controller 50 acquires the corrected print data from the buffer memory 52 and determines whether a viewpoint-reduced area exists in the print data (step S40). As shown in FIG. 15, when a stereoscopic viewing image is generated from a right-eye image and a left-eye image, the parallax correction is performed to display the right-eye image on the right side and to display the left-eye image on the left side. As a result, the right-eye image and the left-eye image are printed in the central region of the stereoscopic viewing image but an area in which only the right-eye image is printed and an area in which only the left-eye image is printed are formed in the marginal regions of the stereoscopic viewing image. These areas in both marginal regions in which only one of the right-eye image and the left-eye image is printed are the viewpoint-reduced area.

When it is determined that the viewpoint-reduced area exists (YES in step S40), the system controller 50 sets an area in which the viewpoint-reduced area is printed in the area serving as an image forming area if a predetermined position is set as the print start position based on the acquired print data (step S41).

The system controller sets the print position of the detection pattern 100b to an arbitrary position (for example, substantially the center) in the area in which the viewpoint-reduced area is printed and which is acquired in step S41. The clamper 30 is driven through the use of the sheet conveying control part 421 to convey the lenticular sheet 110 so that the acquired print position is located just below the thermal head 14. The system controller 50 rotates the ribbon cage 12 to move the ink ribbon of K to the position of the thermal head 14, and electrifies the thermal head 14 to emit heat while winding the ink ribbon on the winding reel 16 through the use of the ink ribbon driving mechanism 433 at a speed slightly higher than the moving speed of the lenticular sheet 100 (step S42). Accordingly, the detection pattern 100b is printed in the area in which the viewpoint-reduced area is printed in the image forming area. In general, since the stereoscopic viewing quality of the viewpoint-reduced area is not good in a stereoscopic viewing print, the viewpoint-reduced area is cut off. Accordingly, even when the detection pattern 100b is printed in the viewpoint-reduced area, the viewpoint-reduced area is cut off finally and the detection pattern 100b does not appear in a complete printed product.

In step S42, the detection pattern 100b is printed in two areas in which the viewpoint-reduced area is printed in the image forming area, but the detection pattern can be printed in at least one area, not necessarily printed in two areas.

When it is determined that the viewpoint-reduced area does not exist (NO in step S40), the system controller 50 acquires a set value of the margin area from the buffer memory 52 (step S15), and determines an area necessarily serving as an image forming area in spite of the misalignment in print position out of the image forming area based on the print data and the set value of the margin area stored in the buffer memory 52 and the lenticular sheet size acquired in step S12 (step S16).

The system controller 50 sets an edge portion of the area necessarily serving as an image forming area determined in step S16 as the print position of the detection pattern 100b. The clamper 30 is driven through the use of the sheet conveying control part 421 to convey the lenticular sheet 100 so that the set print position is located just below the thermal head 14. The system controller 50 rotates the ribbon cage 12 to move the ink ribbon of K to the position of the thermal head 14, and electrifies the thermal head 14 to emit heat while winding the ink ribbon on the winding reel 16 through the use of the ink ribbon driving mechanism 433 at a speed slightly higher than the moving speed of the lenticular sheet 100 (step S17). Accordingly, the detection pattern 100b is printed at an edge portion of the area necessarily serving as an image forming area.

Since the arrangement direction of the thermal head 14 is set to be parallel to the longitudinal direction of the lenses 100a in step S11, the detection pattern 100b is printed to be parallel to the longitudinal direction of the lenses 100a. The information on the print position of the detection pattern 100b printed in steps S42 and S17 is stored in the buffer memory 52.

In this embodiment, by printing the detection pattern in the viewpoint-reduced area which is finally cut off, it is possible to improve the sheet-use efficiency of the lenticular sheet without displaying any detection pattern in a complete printed product of the lenticular sheet.

Although it has been described in this embodiment that the detection pattern is printed using the ink ribbon of K, that is, black, the print color of the detection pattern is not limited to black and the detection pattern may be printed using other ink ribbons such as Y, M, and C. However, since the black detection pattern can be most easily detected and the viewpoint-reduced area is finally cut off, it is preferable that the detection pattern is printed in black.

This embodiment is not limited to the sheet-like lenticular sheet having a predetermined size, but may be applied to a lenticular sheet wound in a roll shape.

### Fourth Embodiment

Although it has been described in the first embodiment of the present invention that the detection pattern is printed at an edge portion of the area necessarily serving as an image forming area, the print position of the detection pattern is not limited to this position.

In a fourth embodiment of the present invention, the detection pattern is printed in an area to be cut off by no-margin print (print type in which there is no margin in a print) or trimming print (print type in which a part of an image is cut), that is, a trimming area. A printing apparatus 10D according to the fourth embodiment of the present invention will be described below. The configuration, the control system, and the printing process in the operation of the printing apparatus 10D are the same as those of the printing apparatus 10 and thus are not described. The process of printing the detection pattern 100b will be described. The same elements as the first embodiment are referenced by the same reference numerals and signs and are not described.

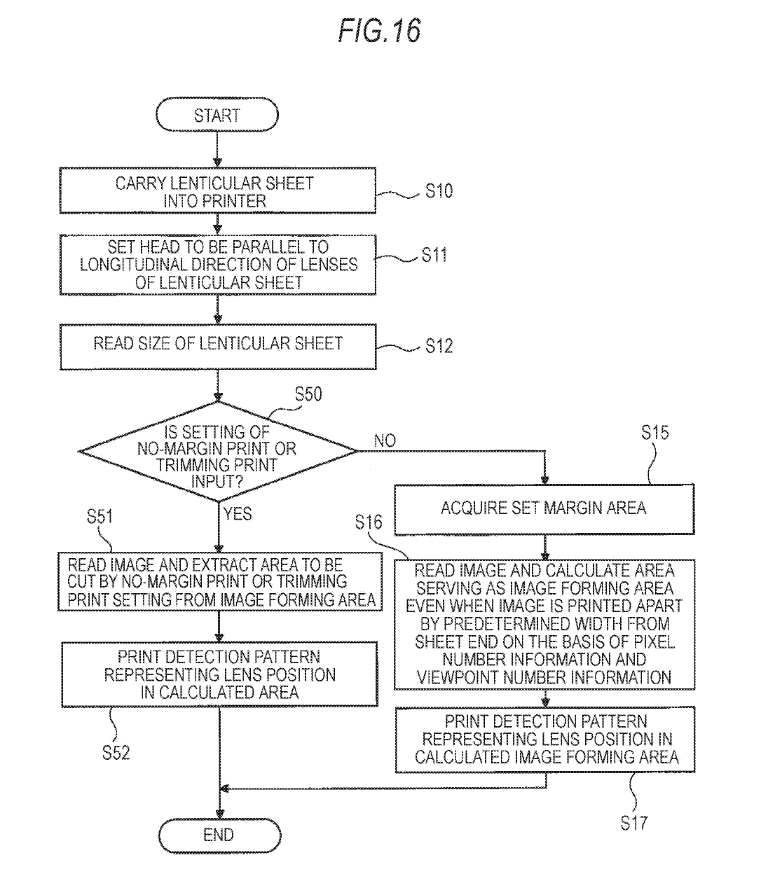

FIG. 16 is a flow diagram illustrating the process flow of printing the detection pattern 100b. This printing process is controlled by the system controller 50. The program causing the system controller 50 to perform the printing process is stored in the program storage part 51.

The system controller 50 conveys the lenticular sheet 100 introduced from the sheet feeding part 10a into the printing apparatus 10 through the use of the sheet conveying mechanism 431 (step S10). In this step, the leading edge of the lenticular sheet 100 is clamped by the clamper 30 and the lenticular sheet 100 is roughly positioned.

The system controller 50 adjusts the angle of the lenticular sheet 100 through the use of the sheet conveying mechanism 431 so that the conveying direction of the lenticular sheet 100 is perpendicular to the longitudinal direction of the lenses 100a, that is, so that the arrangement direction of the thermal head 14 is parallel to the longitudinal direction of the lenses 100a (step S11) and acquires the lenticular sheet size based on the detection result of the sensor part 53 (step S12).

The system controller 50 acquires the print information from the buffer memory 52 and determines whether the print information includes information representing that a printing operation is carried out by no-margin print or trimming print (step S50).

When it is determined that the print information includes the information representing that a printing operation is carried out by no-margin print or trimming print (YES in step S50), the system controller sets an image forming area when a predetermined position is set as the print start position on the lenticular sheet 100 based on the print information, the print data or the like acquired from the buffer memory 52, and sets an area to be trimmed by no-margin print or trimming print, that is, a trimming area, in the image forming area (step S51).

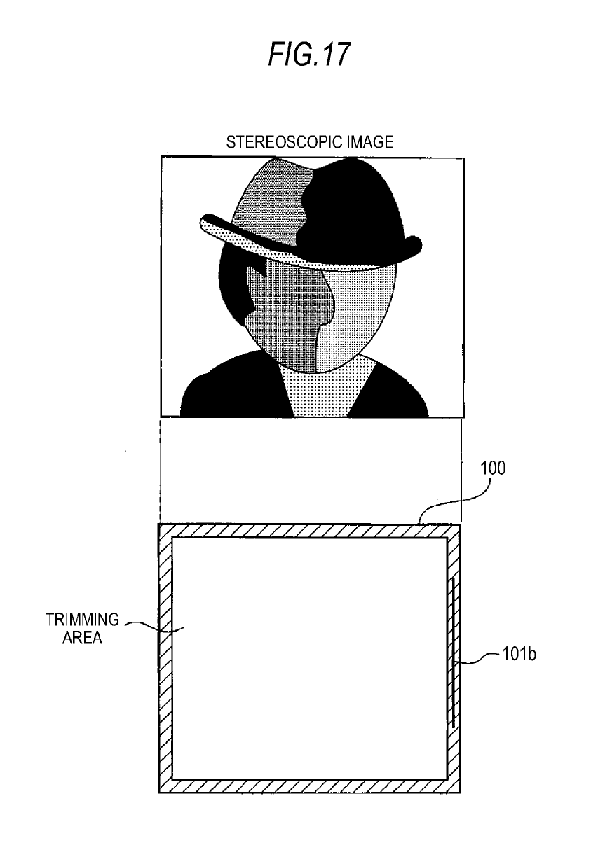

FIG. 17 is a diagram schematically illustrating an example where no-margin print is set in the buffer memory 52. In case of no-margin print, it is recorded that an area with a predetermined length and a predetermined width from the center of a printed image is the trimming area. An area (hatched region in FIG. 17) other than the area with a predetermined length and a predetermined width from the center of the printed image in the image forming area is determined as an area other than the trimming area in the image forming area.

The system controller sets an arbitrary position in the set area to be trimmed by no-margin print or trimming print as the print position of the detection pattern 100b. The clamper 30 is driven through the use of the sheet conveying control part 421 to convey the lenticular sheet 100 so that the set print position is located just below the thermal head 14. The system controller 50 rotates the ribbon cage 12 to move the ink ribbon of K to the position of the thermal head 14, and electrifies the thermal head 14 to emit heat while winding the ink ribbon on the winding reel 16 through the use of the ink ribbon driving mechanism 433 at a speed slightly higher than the moving speed of the lenticular sheet 100 (step S52). Accordingly, the detection pattern 100b is printed in the trimming area. In addition, the information on the print position of the detection pattern 100b is stored in the buffer memory 52.

When it is determined that the print information does not include the information representing that a printing operation is carried out by no-margin print or trimming print (NO in step S50), the system controller 50 acquires a set value of the margin area from the buffer memory 52 (step S15), and determines an area necessarily serving as an image forming area in spite of the misalignment in print position out of the image forming area based on the print data and the set value of the margin area stored in the buffer memory 52 and the lenticular sheet size acquired in step S12 (step S16).

The system controller 50 sets an edge portion of the area necessarily serving as an image forming area as the print position of the detection pattern 100b. The clamper 30 is driven through the use of the sheet conveying control part 421 to convey the lenticular sheet 100 so that the set print position is located just below the thermal head 14. The system controller 50 rotates the ribbon cage 12 to move the ink ribbon of K to the position of the thermal head 14, and electrifies the thermal head 14 to emit heat while winding the ink ribbon on the winding reel 16 through the use of the ink ribbon driving mechanism 433 at a speed slightly higher than the moving speed of the lenticular sheet 100 (step S17). Accordingly, the detection pattern 100b is printed at the edge portion of the area necessarily serving as an image forming area. In addition, the information on the print position of the detection pattern 100b is stored in the buffer memory 52.

Accordingly, the detection pattern 100b is printed and then an image is printed. When the printing of the image is ended and the sheet is discharged (step S30), the trimming area of the discharged lenticular sheet 100 is cut off. The cutoff of the trimming area may be performed by a cutting part (not shown) disposed in the printing apparatus 10D before the discharging of the sheet. A plate-like cutter or the like disposed in parallel to the thermal head 14 can be used as the cutting part. As a result, an image print will complete.

According to this embodiment, when a printing operation is carried out by no-margin print or trimming print, it is necessary to cut off a part of the image forming area. However, by printing the detection pattern in the area to be cut off, the detection pattern can be made not to appear in the complete printed product of a stereoscopic viewing image. Here, it is possible to improve the sheet-use efficiency while still printing the detection pattern in the image forming area.

Although it has been described in this embodiment that the trimming area is an area that is cut off when the printing operation is carried out by no-margin print or trimming print, the trimming area may be painted with black without being cut off to perform a margin printing operation. In this case, the detection pattern can be made not to appear in the complete printed product.

Although it has been described in this embodiment that the detection pattern is printed using the ink ribbon of K, that is, black, the print color of the detection pattern is not limited to black and the detection pattern may be printed using other ink ribbons such as Y, M, and C. However, since the black detection pattern can be most easily detected and the viewpoint-reduced area is finally cut off, it is preferable that the detection pattern is printed in a dark color such as black.

This embodiment is not limited to the sheet-like lenticular sheet having a predetermined size, but may be applied to a lenticular sheet wound in a roll shape.

### Fifth Embodiment

Although it has been described in the first embodiment of the present invention that the detection pattern is printed at an edge portion of the area necessarily serving as an image forming area, the print position of the detection pattern is not limited to this position.

In a fifth embodiment of the present invention, the detection pattern is printed in an area in which a frame such as a photo frame is printed by frame-added print. A printing apparatus 10E according to the fifth embodiment of the present invention will be described below. The configuration, the control system, and the printing process in the operation of the printing apparatus 10E are the same as those of the printing apparatus 10 and thus are not described. The process of printing the detection pattern 100b will be described. The same elements as the first embodiment are referenced by the same reference numerals and signs and are not described.

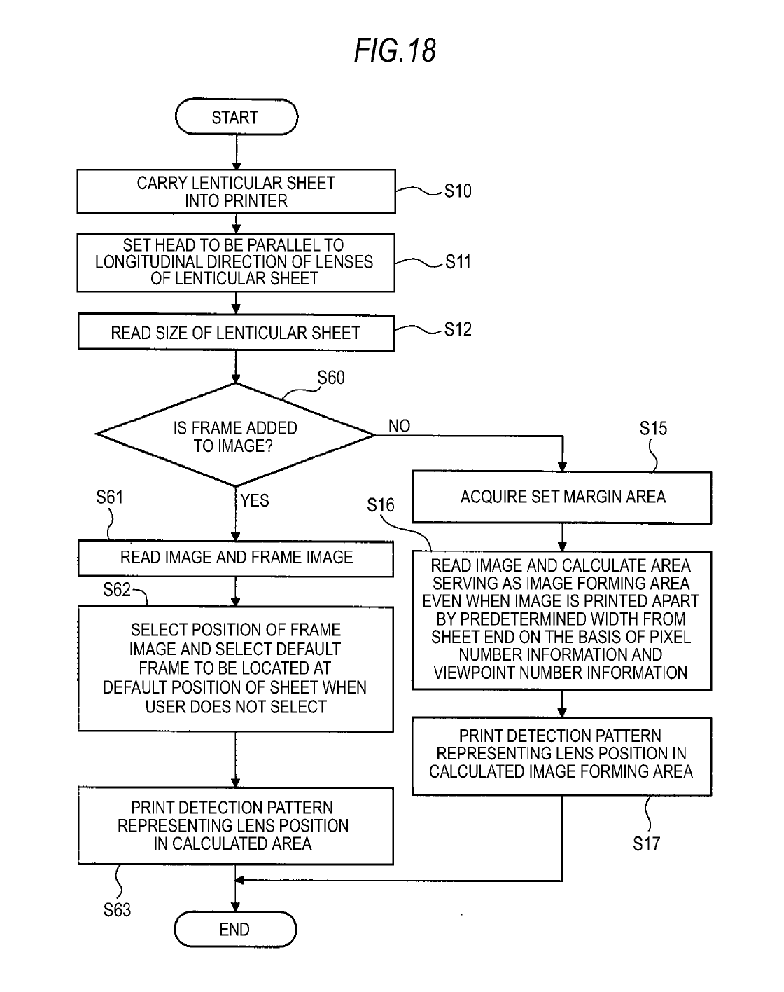

FIG. 18 is a flow diagram illustrating the process flow of printing the detection pattern 100b. This printing process is controlled by the system controller 50. The program causing the system controller 50 to perform the printing process is stored in the program storage part 51.

The system controller 50 conveys the lenticular sheet 100 introduced from the sheet feeding part 10a into the printing apparatus 10 through the use of the sheet conveying mechanism 431 (step S10). In this step, the leading edge of the lenticular sheet 100 is clamped by the clamper 30 and the lenticular sheet 100 is roughly positioned.

The system controller 50 adjusts the angle of the lenticular sheet 100 through the use of the sheet conveying mechanism 431 so that the conveying direction of the lenticular sheet 100 is perpendicular to the longitudinal direction of the lenses 100a, that is, so that the arrangement direction of the thermal head 14 is parallel to the longitudinal direction of the lenses 100a (step S11) and acquires the lenticular sheet size based on the detection result of the sensor part 53 (step S12).

The system controller 50 acquires the print information from the buffer memory 52 and determines whether the print information includes information representing that a printing operation is carried out by frame-added print (step S60).

When it is determined that the print information includes the information representing that a printing operation is carried out by frame-added print (YES in step S60), the YMC dividing and image processing part 56 acquires print data and a frame image from the buffer memory 52 (step S61) and adds the print data to image data to generate new print data (step S62).

The frame image is stored in the buffer memory 52 along with the print data when the frame-added print is set. When plural frame images are stored and it is not clear what frame image to use, a predetermined frame image (for example, first-stored frame image) is automatically designated.

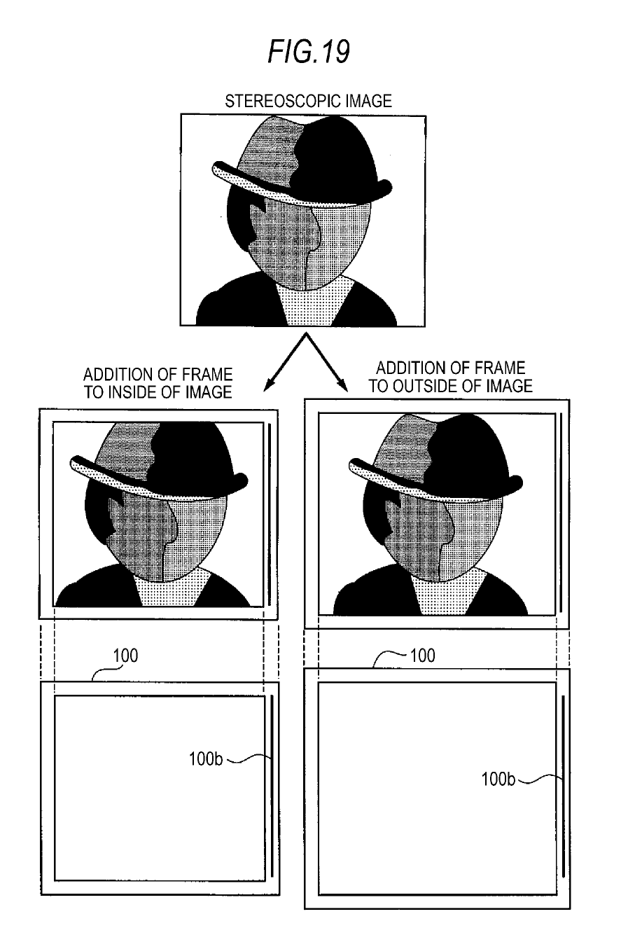

FIG. 19 is a diagram schematically illustrating an example where frame-added print data is generated. The print information acquired from the buffer memory 52 includes information designating whether a frame should be added to the outside of an image or inside of the image. The YMC dividing and image processing part 56 generates the frame-added print data based on the information. The generated print data is stored in the buffer memory 52.

When the print information does not include the information designating whether a frame should be added to the outside of an image or the inside of the image, the frame-added print data is generated in accordance with the initial setting (for example, a frame should be added to the inside).

The frame image may be a two-dimensional image or a stereoscopic viewing image. When the frame is a two-dimensional image, the frame image can be added to the print data previously generated. When the frame is a three-dimensional image, the frame is added to each of a right-eye image and a left-eye image and the degree of parallax is interpolated to generate a stereoscopic viewing image.

The system controller 50 sets an image forming area on the lenticular sheet 100 based on the print data generated in step S62. In the image forming area, a predetermined position such as an edge of the lenticular sheet 100 is determined as the print start position. The system controller 50 sets an area in which a frame is printed in the image forming area and sets substantially the center of the area in which a frame is printed as the print position of the detection pattern 100b. The clamper 30 is driven through the use of the sheet conveying control part 421 to convey the lenticular sheet 100 so that the set print position is located just below the thermal head 14. The system controller 50 rotates the ribbon cage 12 to move the ink ribbon of K to the position of the thermal head 14, and electrifies the thermal head 14 to emit heat while winding the ink ribbon on the winding reel 16 through the use of the ink ribbon driving mechanism 433 at a speed slightly higher than the moving speed of the lenticular sheet 100 (step S63). Accordingly, the detection pattern 100b is printed at an edge portion of the area necessarily serving as an image forming area. In addition, the information on the print position is stored in the buffer memory 52.

When it is determined that the print information does not include the information representing that a printing operation is carried out by frame-added print (NO in step S60), the system controller 50 acquires a set value of the margin area from the buffer memory 52 (step S15), and determines an area necessarily serving as an image forming area in spite of the misalignment in print position out of the image forming area based on the print data and the set value of the margin area stored in the buffer memory 52 and the lenticular sheet size acquired in step S12 (step S16).

The system controller 50 sets an edge portion of the area necessarily serving as an image forming area as the print position of the detection pattern 100b. The clamper 30 is driven through the use of the sheet conveying control part 421 to convey the lenticular sheet 100 so that the set print position is located just below the thermal head 14. The system controller 50 rotates the ribbon cage 12 to move the ink ribbon of K to the position of the thermal head 14, and electrifies the thermal head 14 to emit heat while winding the ink ribbon on the winding reel 16 through the use of the ink ribbon driving mechanism 433 at a speed slightly higher than the moving speed of the lenticular sheet 100 (step S17). Accordingly, the detection pattern 100b is printed at the edge portion of the area necessarily serving as an image forming area so as to be parallel to the longitudinal direction of the lenses 100a. Thereafter, the printing of an image is performed.

According to this embodiment, by adding a frame to an image and printing the detection pattern in the area in which the frame is printed, the detection pattern can be made not to appear in the complete printed product of a stereoscopic viewing image. Here, since the detection pattern is printed in the image forming area, it is possible to improve the sheet-use efficiency.

Although it has been described in this embodiment that the detection pattern is printed using the ink ribbon of K, that is, black, the print color of the detection pattern is not limited to black. For example, the detection pattern may be printed in the same color as the frame.

This embodiment is not limited to the sheet-like lenticular sheet having a predetermined size, but may be applied to a lenticular sheet wound in a roll shape.

### Sixth Embodiment

Although it has been described in the first embodiment of the present invention that the detection pattern is printed at an edge portion of the area necessarily serving as an image forming area, the print position of the detection pattern is not limited to this position.

In a sixth embodiment of the present invention, the detection pattern is printed in black in a black area of an image. A printing apparatus 10F according to the sixth embodiment of the present invention will be described below. The configuration, the control system, and the printing process in the operation of the printing apparatus 10F are the same as those of the printing apparatus 10 and thus are not described. The process of printing the detection pattern 100b will be described. The same elements as the first embodiment are referenced by the same reference numerals and signs and are not described.

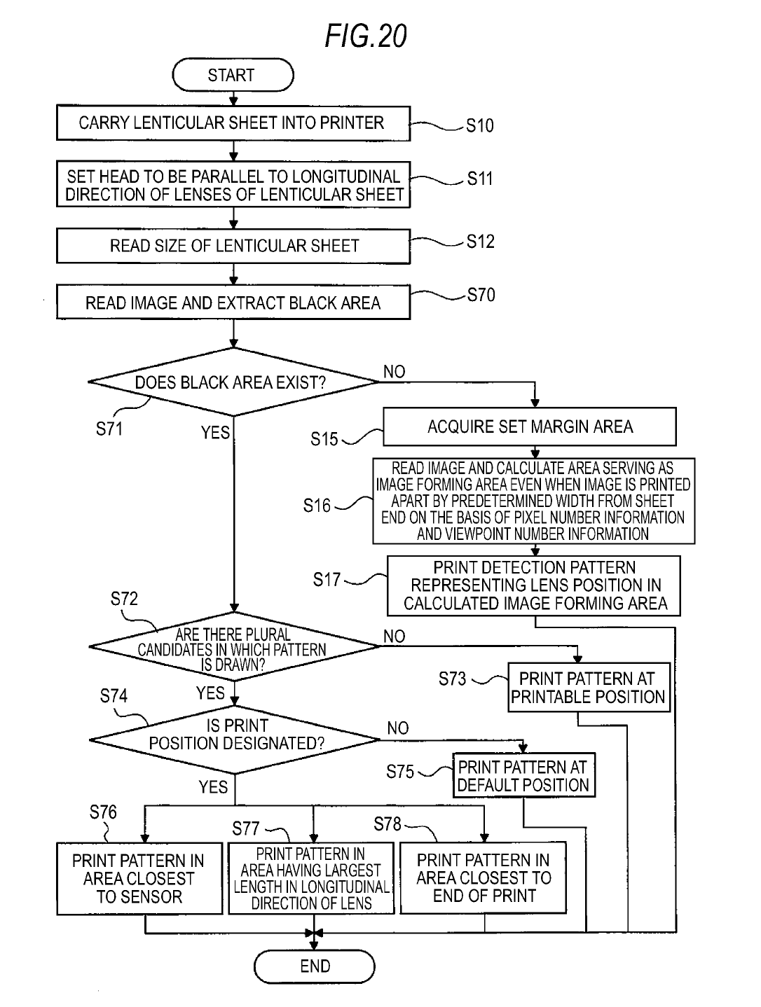

FIG. 20 is a flow diagram illustrating the process flow of printing the detection pattern 100b. This printing process is controlled by the system controller 50. The program causing the system controller 50 to perform the printing process is stored in the program storage part 51.

The system controller 50 conveys the lenticular sheet 100 introduced from the sheet feeding part 10a into the printing apparatus 10 through the use of the sheet conveying mechanism 431 (step S10). In this step, the leading edge of the lenticular sheet 100 is clamped by the clamper 30 and the lenticular sheet 100 is roughly positioned.

The system controller 50 adjusts the angle of the lenticular sheet 100 through the use of the sheet conveying mechanism 431 so that the conveying direction of the lenticular sheet 100 is perpendicular to the longitudinal direction of the lenses 100a, that is, so that the arrangement direction of the thermal head 14 is parallel to the longitudinal direction of the lenses 100a (step S11) and acquires the lenticular sheet size based on the detection result of the sensor part 53 (step S12).

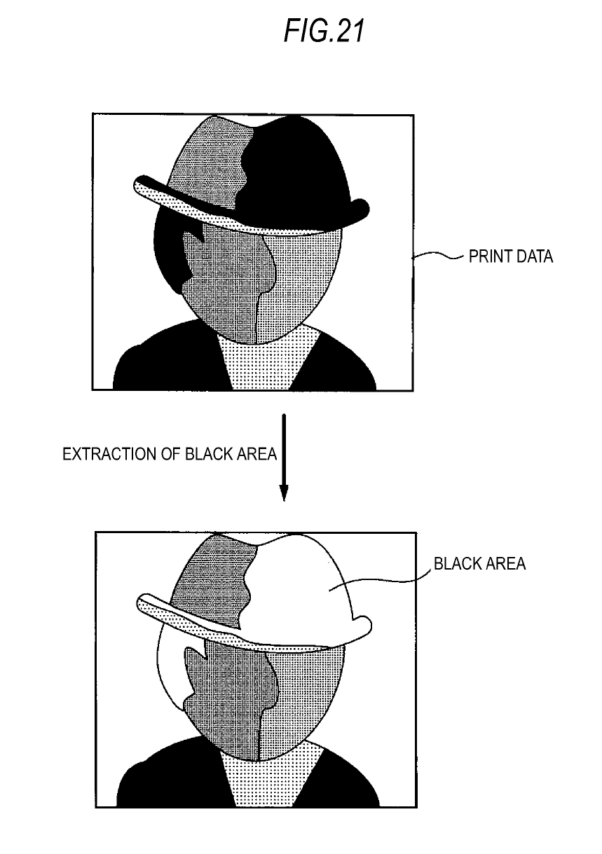

The system controller 50 acquires print data from the buffer memory 52 and extracts a black area from the print data (step S70). The black area can be extracted using various known methods. The black area is extracted as white in FIG. 21.

The system controller 50 determines whether a black area is extracted (step S71). When it is determined that a black area is extracted (YES in step S71), the system controller 50 sets an image forming area when a predetermined position is set as the print start position on the lenticular sheet 100 and sets an area where the black area is printed in the image forming area. The system controller 50 determines whether plural patterns which can draw the detection pattern 100b exist in the area where the black area is printed, that is, whether the print position of the detection pattern 100b is uniquely determined in the area where the black area is printed (step S72).

When it is determined that only one pattern which can draw the detection pattern 100b exists (NO in step S72), the system controller 50 sets the position which can draw the detection pattern 100b as the print position of the detection pattern 100b and prints the detection pattern 100b at the print position (step S73).

When it is determined that plural patterns which can draw the detection pattern 100b exist (YES in step S72), the system controller 50 acquires print information from the buffer memory 52 and determines whether the print information includes information designating the print position (step S74). In this embodiment, the information designating the print position includes one of a position closest to the photo interrupters 40 and 42, a position longest in the lateral direction (the longitudinal direction of the lenses 100a) of the lenticular sheet 100, and a position closest to an edge of the lenticular sheet 100.

When it is determined that the print information does not include the information designating the print position (NO in step S74), the system controller 50 sets the area where the black area is printed in the image forming area and prints the detection pattern 100b at an initially-set print position in the area where the black area is printed (step S75). The initially-set print position is, for example, substantially the center of the black area. The image forming area can be determined by the same process as step S73.

When it is determined that the print information includes the information designating the print position (YES in step S74), the system controller 50 sets the area where a black area is printed in the image forming area, sets the designated position in the area where the black area is printed as the print position of the detection pattern 100b, and prints the detection pattern 100b at the print position (steps S76 to S78). The designated position may be information stored in the buffer memory 52. The image forming area can be determined by the same process as step S73.

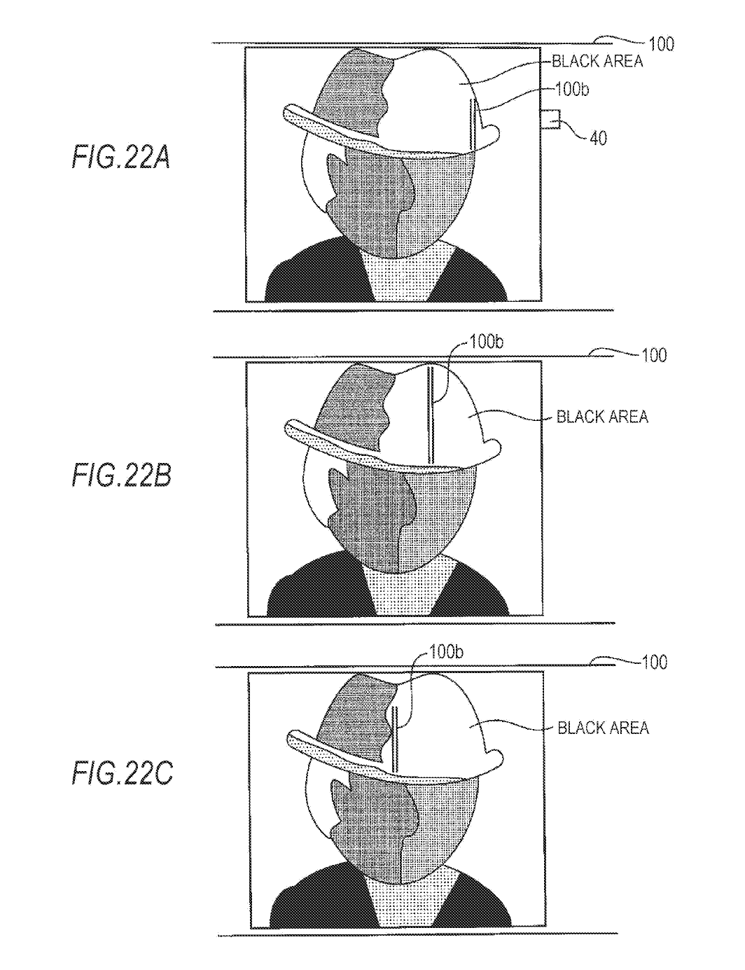

When the position closest to the photo interrupters 40 and 42 is designated, as shown in FIG. 22A, the position closest to the photo interrupters 40 and 42 in the black area is set as the print position of the detection pattern 100b. In this case, since the detection pattern is detected by the use of the photo interrupters 40 and 42 at the time of printing a multi-viewpoint image, it is possible to shorten the time of moving the lenticular sheet.

When the position longest in the lateral direction of the lenticular sheet 100 is designated, as shown in FIG. 22B, the position longest in the lateral direction of the lenticular sheet 100 in the black area is set as the print position of the detection pattern 100b. In this case, since the movement of the photo interrupters 40 and 42 in the lateral direction (which is parallel to the longitudinal direction of the lenses 100a) can be reduced at the time of printing a multi-viewpoint image, it is possible to reduce the time of detecting the detection pattern.

When the position closest to an edge of the lenticular sheet 100 is designated, as shown in FIG. 22C, the position closest to an edge of the lenticular sheet 100 in the black area is set as the print position of the detection pattern 100b. At the same time, the information on the print position of the detection pattern 100b is stored in the buffer memory 52. In this case, it is possible to print the detection pattern 100b at the most invisible position.

In steps S73 and S75 to S78, the system controller 50 drives the clamper 30 through the use of the sheet conveying control part 421 to convey the lenticular sheet 100 so that the print position of the detection pattern 100b is located just below the thermal head 14. The system controller 50 rotates the ribbon cage 12 to move the ink ribbon of K to the position of the thermal head 14, and electrifies the thermal head 14 to emit heat while winding the ink ribbon on the winding reel 16 through the use of the ink ribbon driving mechanism 433 at a speed slightly higher than the moving speed of the lenticular sheet 100. Accordingly, the detection pattern 100b is printed at a predetermined position of the black area.

When it is determined that the black area is not extracted (NO in step S71), the system controller 50 acquires a set value of the margin area from the buffer memory 52 (step S15), and determines an area necessarily serving as an image forming area in spite of the misalignment in print position out of the image forming area based on the print data and the set value of the margin area stored in the buffer memory 52 and the lenticular sheet size acquired in step S12 (step S16).

The system controller 50 sets an edge portion of the area necessarily serving as an image forming area as the print position of the detection pattern 100b and prints the detection pattern 100b at the print position in black (step S17).

The processes of steps S17 and S73 to S78 will be described. The clamper 30 is driven through the use of the sheet conveying control part 421 to convey the lenticular sheet 100 so that the set print position is located just below the thermal head 14. The system controller 50 rotates the ribbon cage 12 to move the ink ribbon of K to the position of the thermal head 14, and electrifies the thermal head 14 to emit heat while winding the ink ribbon on the winding reel 16 through the use of the ink ribbon driving mechanism 433 at a speed slightly higher than the moving speed of the lenticular sheet 100.

As a result, the detection pattern 100b is printed on the lenticular sheet 100 so as to be parallel to the longitudinal direction of the lenses 100a and then the printing of an image is performed.

According to this embodiment, since the detection pattern is printed in the black area in an image to be printed in black, the detection pattern can be made not to appear in the complete printed product of a stereoscopic viewing image. Here, since the detection pattern is printed in the image forming area, it is possible to improve the sheet-use efficiency.

### Seventh Embodiment

Although it has been described in the sixth embodiment of the present invention that the detection pattern is printed in a black area in black, the print position of the detection pattern is not limited to this configuration.

In a seventh embodiment of the present invention, the detection pattern is printed in a low-brightness area. A printing apparatus 10G according to the seventh embodiment of the present invention will be described below. The configuration, the control system, and the printing process in the operation of the printing apparatus 10G are the same as those of the printing apparatus 10 and thus are not described. The process of printing the detection pattern 100b will be described. The same elements as the first embodiment are referenced by the same reference numerals and signs and are not described.

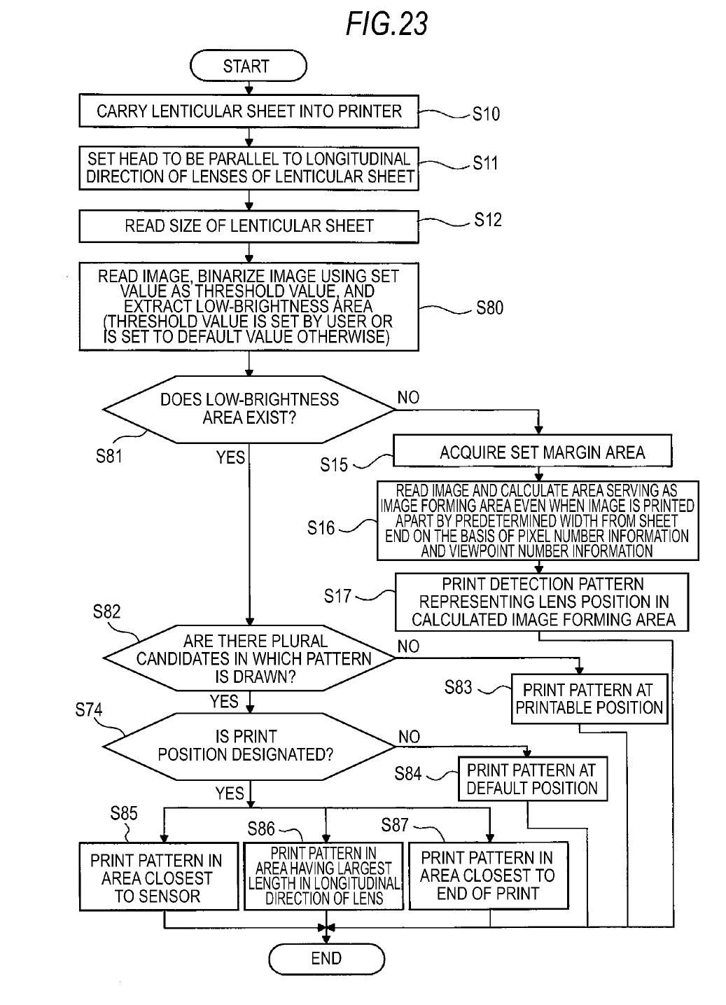

FIG. 23 is a flow diagram illustrating the process flow of printing the detection pattern 100b. This printing process is controlled by the system controller 50. The program causing the system controller 50 to perform the printing process is stored in the program storage part 51.

The system controller 50 conveys the lenticular sheet 100 introduced from the sheet feeding part 10a into the printing apparatus 10 through the use of the sheet conveying mechanism 431 (step S10). In this step, the leading edge of the lenticular sheet 100 is clamped by the clamper 30 and the lenticular sheet 100 is roughly positioned.

The system controller 50 adjusts the angle of the lenticular sheet 100 through the use of the sheet conveying mechanism 431 so that the conveying direction of the lenticular sheet 100 is perpendicular to the longitudinal direction of the lenses 100a, that is, so that the arrangement direction of the thermal head 14 is parallel to the longitudinal direction of the lenses 100a (step S11) and acquires the lenticular sheet size based on the detection result of the sensor part 53 (step S12).

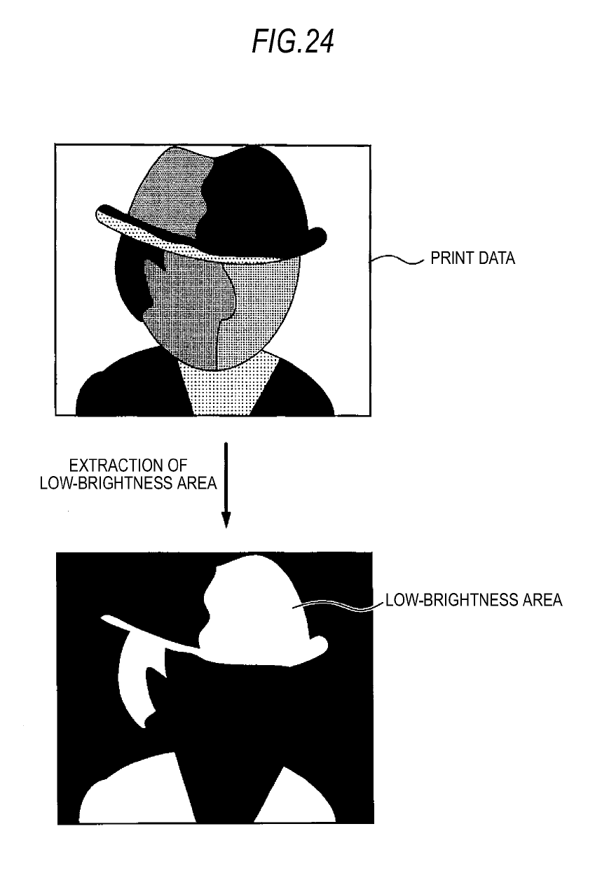

The system controller 50 acquires print data from the buffer memory 52 and extracts a low-brightness region from the print data (step S80). FIG. 24 is a diagram schematically illustrating the extracting of the low-brightness area. By setting a predetermined brightness (for example, brightness of 50) for the print data and performing a threshold process using the predetermined brightness as a reference threshold value, a binarized image including a low-brightness area and an area other than the low-brightness area is generated as shown in FIG. 24. In FIG. 24, the low-brightness area is displayed in white. Here, the “predetermined brightness” is not limited to the above-mentioned example, but may have various other values. For example, by performing a threshold process using an average brightness of an image as the predetermined brightness (threshold value), a binarized image may be generated. Alternatively, the binarized image may be generated by calculating the maximum brightness of the image and performing the threshold process using a numerical value, which is obtained by multiplying the maximum brightness by a predetermined ratio, as the predetermined brightness (threshold value).

The system controller 50 determines whether a low-brightness area is extracted (step S81). When it is determined that a low-brightness area is extracted (YES in step S81), the system controller 50 sets an image forming area when a predetermined position is set as the print start position on the lenticular sheet 100 and sets an area where the low-brightness area is printed in the image forming area. The system controller 50 determines whether plural patterns which can draw the detection pattern 100b exist in the area where the low-brightness area is printed, that is, whether the print position of the detection pattern 100b is uniquely determined in the area where the low-brightness area is printed (step S82).

When it is determined that only one pattern which can draw the detection pattern 100b exists (NO in step S82), the system controller 50 sets the position which can draw the detection pattern 100b in an image forming area as the print position of the detection pattern 100b and prints the detection pattern 100b at the print position (step S83). The image forming area may be determined by the same process as step S14 or a predetermined position such as an edge of the lenticular sheet 100 may be determined as the print start position.

When it is determined that plural patterns which can draw the detection pattern 100b exist (YES in step S82), the system controller 50 acquires print information from the buffer memory 52 and determines whether the print information includes information designating the print position (step S74).

When it is determined that the print information does not include the information designating the print position (NO in step S74), the system controller 50 sets the area where the low-brightness area is printed in the image forming area and prints the detection pattern 100b at an initially-set print position (e.g. substantially the center of the low-brightness area) in the area where the low-brightness area is printed (step S84). The image forming area can be determined by the same process as step S83.

When it is determined that the print information includes the information designating the print position (YES in step S74), the system controller 50 sets the area where the low-brightness area is printed in the image forming area, sets the designated position in the area where the low-brightness area is printed as the print position of the detection pattern 100b, and prints the detection pattern 100b at the print position (steps S85 to S87). The image forming area can be determined by the same process as step S83.

When the position closest to the photo interrupters 40 and 42 is designated, the position closest to the photo interrupters 40 and 42 in the low-brightness area extracted in step S80 is set as the print position of the detection pattern 100b (step S85). When the position longest in the lateral direction of the lenticular sheet 100 is designated, the position longest in the lateral direction of the lenticular sheet 100 in the low-brightness area extracted in step S80 is set as the print position of the detection pattern 100b (step S86). When the position closest to an edge of the lenticular sheet 100 is designated, the position closest to an edge of the lenticular sheet 100 in the low-brightness area extracted in step S80 is set as the print position of the detection pattern 100b (step S87).

When it is determined that the low-brightness area is not extracted (NO in step S81), the system controller 50 acquires a set value of the margin area from the buffer memory 52 (step S15), and determines an area necessarily serving as an image forming area in spite of the misalignment in print position out of the image forming area based on the print data and the set value of the margin area stored in the buffer memory 52 and the lenticular sheet size acquired in step S12 (step S16).

The system controller 50 sets an edge portion of the area necessarily serving as an image forming area as the print position of the detection pattern 100b and prints the detection pattern 100b at the print position in black (step S17).

The processes of steps S17 and S83 to S87 will be described. The clamper 30 is driven through the use of the sheet conveying control part 421 to convey the lenticular sheet 100 so that the set print position is located just below the thermal head 14. The system controller 50 rotates the ribbon cage 12 to move the ink ribbon of K to the position of the thermal head 14, and electrifies the thermal head 14 to emit heat while winding the ink ribbon on the winding reel 16 through the use of the ink ribbon driving mechanism 433 at a speed slightly higher than the moving speed of the lenticular sheet 100.

As a result, the detection pattern 100b is printed on the lenticular sheet 100 so as to be parallel to the longitudinal direction of the lenses 100a and then the printing of an image is performed.

According to this embodiment, since the detection pattern is printed in the low-brightness area in an image to be printed in black, the detection pattern can be made not to visually appear, that is, to be invisible, in the complete printed product of a stereoscopic viewing image. Here, since the detection pattern is printed in the image forming area, it is possible to improve the sheet-use efficiency.

### Eighth Embodiment

Although it has been described in the seventh embodiment of the present invention that the detection pattern is printed in a low-brightness area in black, the print color of the detection pattern is not limited to black.

In an eighth embodiment of the present invention, the detection pattern is printed in a low-brightness area in an average color of the area. A printing apparatus 10H according to the eighth embodiment of the present invention will be described below. The configuration, the control system, and the printing process in the operation of the printing apparatus 10H are the same as those of the printing apparatus 10 and thus are not described. The process of printing the detection pattern 100b will be described. The same elements as the first embodiment are referenced by the same reference numerals and signs and are not described.

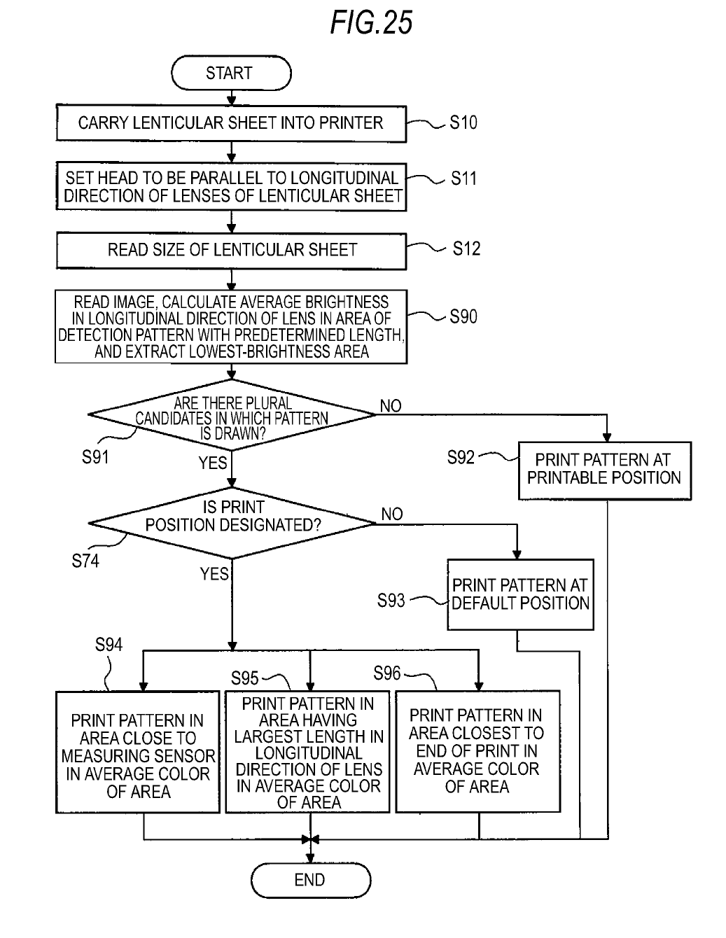

FIG. 25 is a flow diagram illustrating the process flow of printing the detection pattern 100b. This printing process is controlled by the system controller 50. The program causing the system controller 50 to perform the printing process is stored in the program storage part 51.

The system controller 50 conveys the lenticular sheet 100 introduced from the sheet feeding part 10a into the printing apparatus 10 through the use of the sheet conveying mechanism 431 (step S10). In this step, the leading edge of the lenticular sheet 100 is clamped by the clamper 30 and the lenticular sheet 100 is roughly positioned.

The system controller 50 adjusts the angle of the lenticular sheet 100 through the use of the sheet conveying mechanism 431 so that the conveying direction of the lenticular sheet 100 is perpendicular to the longitudinal direction of the lenses 100a, that is, so that the arrangement direction of the thermal head 14 is parallel to the longitudinal direction of the lenses 100a (step S11) and acquires the lenticular sheet size based on the detection result of the sensor part 53 (step S12).

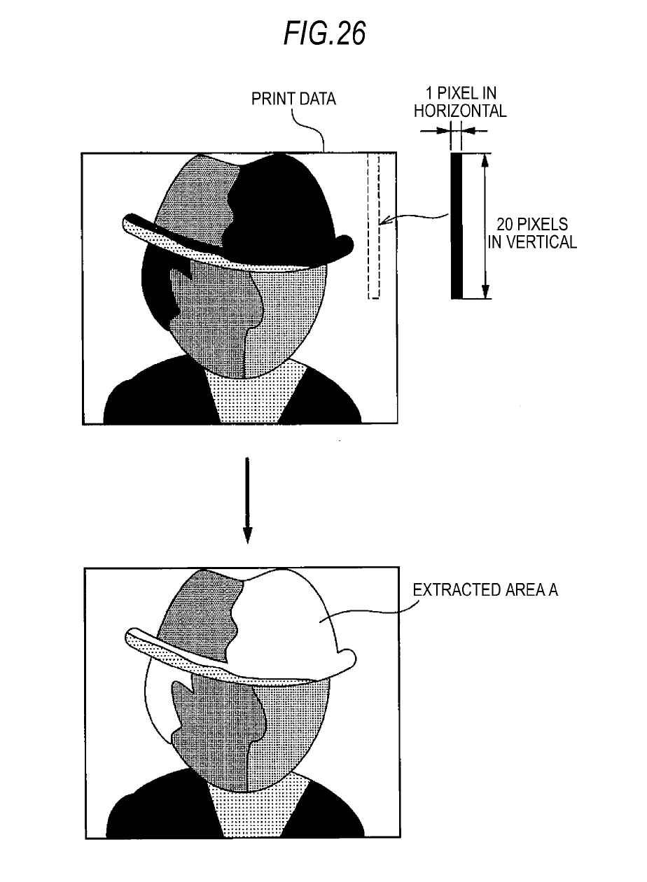

The system controller 50 extracts an area having the lowest average brightness from an area with a predetermined width and a predetermined length in an image (step S90). FIG. 26 is a diagram schematically illustrating the extracting of the area having the lowest average brightness.

An area having the same width and length as the detection pattern 100b is set as the area with a predetermined width and a predetermined length in the image. In this embodiment, the area has a width of 1 pixel and a length of 20 pixels. The area having a width of 1 pixel and a length of 20 pixels is selected from the image in the longitudinal direction of the lenses 100a and the average brightness thereof is calculated. The reason of selecting the area in the longitudinal direction of the lenses 100a is because it is matched with the printing direction of the detection pattern 100b. By repeatedly performing this process on the entire image, an area having the lowest average brightness is extracted. Extraction area A is extracted as the area having the lowest average brightness in FIG. 26.

The system controller 50 sets an image forming area when a predetermined position is set as the print start position on the lenticular sheet 100 and sets an area where the area having the lowest average brightness is printed in the image forming area. The system controller 50 determines whether plural patterns which can draw the detection pattern 100b exist in the area where the area having the lowest average brightness is printed, that is, whether the print position of the detection pattern 100b is uniquely determined in the area where the area having the lowest average brightness is printed (step S91).

When it is determined that only one pattern which can draw the detection pattern 100b exists (NO in step S91), the system controller 50 prints the detection pattern 100b in average color of the area extracted in step S90 at the position in which the detection pattern 100b can be drawn (step S92). The image forming area may be determined by the same process as step S14 or a predetermined position such as an edge of the lenticular sheet 100 may be determined as the print start position.

When it is determined that plural patterns which can draw the detection pattern 100b exist (YES in step S91), the system controller 50 acquires print information from the buffer memory 52 and determines whether the print information includes information designating the print position (step S74).

When it is determined that the print information does not include the information designating the print position (NO in step S74), the system controller 50 prints the detection pattern 100b in the average color of the area extracted in step S90 at an initially-set print position (e.g. substantially the center of the area extracted in step S90) in the area where the area having the lowest average brightness is printed (step S93). The image forming area can be determined by the same process as step S83.

When it is determined that the print information includes the information designating the print position (YES in step S74), the system controller 50 sets the designated position in the area where the area having the lowest average brightness is printed as the print position of the detection pattern 100b and prints the detection pattern 100b in the average color of the area extracted in step S90 at the print position (steps S94 to S96). The image forming area can be determined by the same process as step S83.

When the position closest to the photo interrupters 40 and 42 is designated, the position closest to the photo interrupters 40 and 42 in the area extracted in step S90 is set as the print position of the detection pattern 100b (step S94). When the position longest in the lateral direction of the lenticular sheet 100 is designated, the position longest in the lateral direction of the lenticular sheet 100 in the area extracted in step S90 is set as the print position of the detection pattern 100b (step S95). When the position closest to an edge of the lenticular sheet 100 is designated, the position closest to an edge of the lenticular sheet 100 in the area extracted in step S90 is set as the print position of the detection pattern 100b (step S96).

The process of steps S92 to S96 will be described below. The system controller 50 sets an edge portion of the area necessarily serving as an image forming area as the print position of the detection pattern 100b. The clamper 30 is driven through the use of the sheet conveying control part 421 to convey the lenticular sheet 100 so that the set print position is located just below the thermal head 14. The system controller 50 rotates the ribbon cage 12 to move a desired ink ribbon of Y, M, or C to the position of the thermal head 14, and electrifies the thermal head 14 to emit heat while winding the ink ribbon on the winding reel 16 through the use of the ink ribbon driving mechanism 433 at a speed slightly higher than the moving speed of the lenticular sheet 100. The same process is repeatedly performed on the ink ribbons of Y, M, and C so as to be the average color of the area extracted in step S90. Accordingly, the detection pattern 100b is printed in the average color of the area extracted in step S90 so as to be parallel to the longitudinal direction of the lenses 100a. Thereafter, an image is printed.

According to this embodiment, by printing the detection pattern in the area having the lowest average brightness in the area having a predetermined width and a predetermined length in the average color of the area, the detection pattern can be made to be invisible in the complete printed product of a stereoscopic viewing image. Since the detection pattern is printed in the image forming area, it is possible to improve the sheet-use efficiency.

Although it has been described in this embodiment that the detection pattern 100b is printed and then a multi-viewpoint image is printed to overlap with the detection pattern 100b, the multi-viewpoint image may be printed not to overlap with the area in which the detection pattern 100b is printed. When the detection pattern 100b is printed, the position in which the detection pattern 100b is printed is stored in the buffer memory 52, it is possible to print the multi-viewpoint image so as not to overlap with the position. Accordingly, it is possible to prevent a color from being darkened due to the double printing on the area in which the detection pattern is printed.

### Ninth Embodiment

Although it has been described in the first embodiment of the present invention that the detection pattern is printed in black in the area necessarily serving as an image forming area, the print position and the print color of the detection pattern are not limited to the position and color.

In a ninth embodiment of the present invention, an area in which an image is printed in one of the colors of the ink ribbons (for example, Y, M, C, and B) included in the printing apparatus and the detection pattern is printed in the same color as the print color of the image. A printing apparatus 10I according to the ninth embodiment of the present invention will be described below. The configuration, the control system, and the printing process of in the operation the printing apparatus 10I are the same as those of the printing apparatus 10 and thus are not described. The process of printing the detection pattern 100b will be described. The same elements as the first embodiment are referenced by the same reference numerals and signs and are not described.

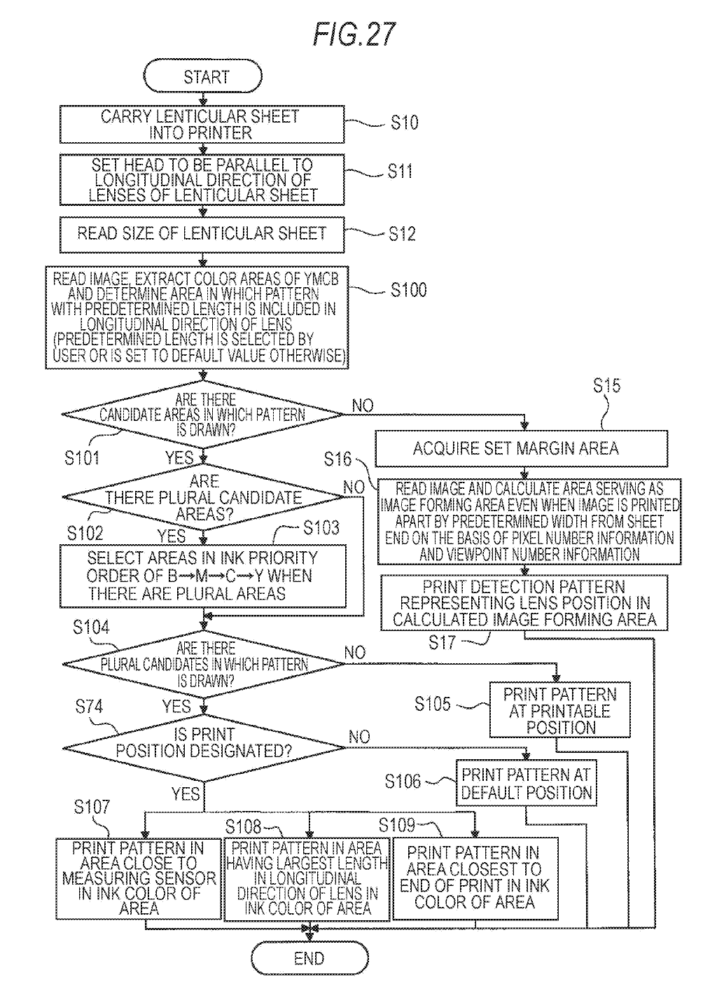

FIG. 27 is a flow diagram illustrating the process flow of printing the detection pattern 100b. This printing process is controlled by the system controller 50. The program causing the system controller 50 to perform the printing process is stored in the program storage part 51.

The system controller 50 conveys the lenticular sheet 100 introduced from the sheet feeding part 10a into the printing apparatus 10 through the use of the sheet conveying mechanism 431 (step S10). In this step, the leading edge of the lenticular sheet 100 is clamped by the clamper 30 and the lenticular sheet 100 is roughly positioned.

The system controller 50 adjusts the angle of the lenticular sheet 100 through the use of the sheet conveying mechanism 431 so that the conveying direction of the lenticular sheet 100 is perpendicular to the longitudinal direction of the lenses 100a, that is, so that the arrangement direction of the thermal head 14 is parallel to the longitudinal direction of the lenses 100a (step S11) and acquires the lenticular sheet size based on the detection result of the sensor part 53 (step S12).

The system controller 50 acquires print data from the buffer memory 52, extracts color areas of Y, M, C, and B from the print data, and determines an area in which the detection pattern 100b can be printed out of the color areas (step S100). In this embodiment, since the detection pattern 100b is printed with a width of 1 pixel and a length of 30 pixels, areas having such a size are determined in the color areas.

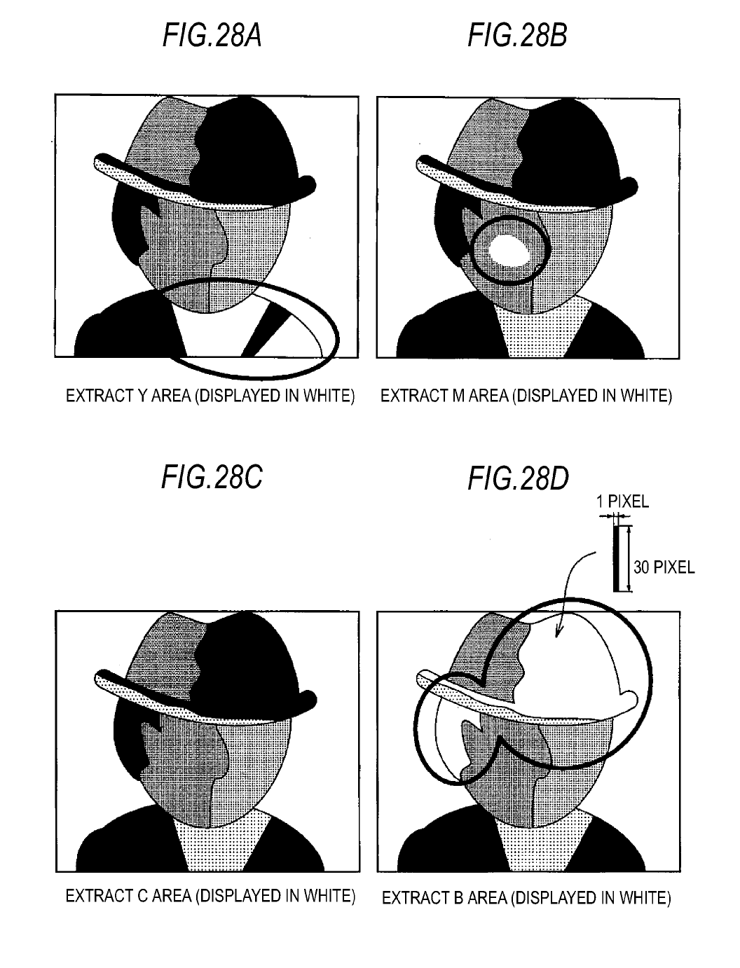

FIGS. 28A to 28D are diagrams schematically illustrating an example of the extraction results of the color areas. FIG. 28A shows the extraction result of a Y color area (hereinafter, referred to as “Y area”) from the image data. It can be seen that an area with a width of 1 pixel and a length of 30 pixels cannot be set in the Y area. FIG. 28B shows the extraction result of an M color area (hereinafter, referred to as “M area”) from the image data. It can be seen that an area with a width of 1 pixel and a length of 30 pixels cannot be set in the M area. FIG. 28C shows the extraction result of a C color area (hereinafter, referred to as “C area”) from the image data. It can be seen that the C area is not extracted from the print data. FIG. 28D shows the extraction result of a B color area (hereinafter, referred to as “B area”) from the image data. It can be seen that an area with a width of 1 pixel and a length of 30 pixels can be set in the B area. Accordingly, the system controller 50 determines that the B area is an area in which the detection pattern 100b can be printed.

The system controller 50 determines whether the area in which the detection pattern 100b can be printed is determined (step S101). When it is determined that the area in which the detection pattern 100b can be printed is determined (YES in step S101), the system controller 50 determines whether plural color areas in which the detection pattern 100b can be printed are determined (step S102).

When it is determined that plural color areas in which the detection pattern 100b can be printed are determined (YES in step S102), the priority order of colors is set to the order of B, M, C, and Y and the color area in which the detection pattern 100b is printed is determined based on this priority order (step S103). When the detection pattern 100b is drawn in black and when the detection pattern 100b is read by the use of the photo interrupter 40 and 42, the contrast between the lenses 100a and the detection pattern 100b is the greatest. Therefore, the priority level of black is set to the highest. The priority order of the other colors is set to the order of M, C, and Y which is the order in which the contrast between the lenses 100a and the detection pattern 100b increases at the time of detecting the colors.

When it is determined that only one color area in which the detection pattern 100b can be printed is determined (NO in step S102) and when the color area is determined in step S103, the system controller 50 determines whether plural patterns which can draw the detection pattern 100b exist in the color area determined as the area in which the detection pattern 100b can be printed (step S104).

When it is determined that only one pattern which can draw the detection pattern 100b exists (NO in step S104), the system controller 50 sets the position in which the detection pattern 100b can be drawn in an image forming area as the print position of the detection pattern 100b and prints the detection pattern 100b in the same color as the print color at the print position (step S105). The image forming area may be determined by the same process as step S14 or a predetermined position such as an edge of the lenticular sheet 100 may be determined as the print start position.

When it is determined that plural patterns which can draw the detection pattern 100b exist (YES in step S104), the system controller 50 acquires print information from the buffer memory 52 and determines whether the print information includes information designating the print position (step S74).

When it is determined that the print information does not include the information designating the print position (NO in step S74), the system controller 50 sets an area in which the color area determined in step S100 or the color area selected in step S103 is printed in the image forming area and prints the detection pattern 100b in the same color as the print color at an initially-set print position (for example, substantially the center of the color area) in the area in which the color area is printed (step S106). The image forming area can be determined by the same process as step S83.

When it is determined that the print information includes the information designating the print position (YES in step S74), the system controller 50 sets the area in which the color area determined in step S100 or the color area selected in step S103 is printed in the image forming area, sets the designated position in the area in which the color area is printed as the print position of the detection pattern 100b, and prints the detection pattern 100b in the same color as the print color at the print position (steps S107 to S109). The image forming area can be determined by the same process as step S83.

When the position closest to the photo interrupters 40 and 42 is designated, the position closest to the photo interrupters 40 and 42 in the color area determined in step S100 or the color area selected in step S103 in the image forming area is set as the print position of the detection pattern 100b (step S107). When the position longest in the lateral direction of the lenticular sheet 100 is designated, the position longest in the lateral direction of the lenticular sheet 100 in the color area determined in step S100 or the color area selected in step S103 in the image forming area is set as the print position of the detection pattern 100b (step S108). When the position closest to an edge of the lenticular sheet 100 is designated, the position closest to an edge of the lenticular sheet 100 in the color area determined in step S100 or the color area selected in step S103 in the image forming area is set as the print position of the detection pattern 100b (step S109).

The process of steps S105 to S109 will be described below. The clamper 30 is driven through the use of the sheet conveying control part 421 to convey the lenticular sheet 100 so that the set print position is located just below the thermal head 14. The system controller 50 rotates the ribbon cage 12 to move an ink ribbon of the same color (one of Y, M, and C) as the print color to the position of the thermal head 14, and electrifies the thermal head 14 to emit heat while winding the ink ribbon on the winding reel 16 through the use of the ink ribbon driving mechanism 433 at a speed slightly higher than the moving speed of the lenticular sheet 100. Accordingly, the detection pattern 100b is printed.

When it is determined that the color area in which the detection pattern 100b can be printed is not determined (NO in step S100), the system controller 50 acquires a set value of the margin area from the buffer memory 52 (step S15), and determines an area necessarily serving as an image forming area in spite of the misalignment in print position out of the image forming area based on the print data and the set value of the margin area stored in the buffer memory 52 and the lenticular sheet size acquired in step S12 (step S16).

The system controller 50 sets an edge portion of the area necessarily serving as an image forming area as the print position of the detection pattern 100b and prints the detection pattern 100b at the print position in black (step S17).

As a result, the detection pattern 100b is printed on the lenticular sheet 100 so as to be parallel to the longitudinal direction of the lenses 100a and then the printing of an image is performed.

According to this embodiment, since the detection pattern is printed in the same color as the color of the image to be printed, the detection pattern can be made to be invisible after printing the image. Since the detection pattern is printed in one color using the ink used to print the image, it is possible to reduce the time and the cost. Since the detection pattern is printed in the image forming area, it is possible to improve the sheet-use efficiency.

According to this embodiment, since the priority levels in the order of more easily detecting the detection pattern are given to the colors and the color area in which the detection pattern is printed is determined from the plural color areas in the priority order, it is possible to reduce the time necessary for determining the print position of the detection pattern.

Although it has been described in this embodiment that the detection pattern 100b is printed and then a multi-viewpoint image is printed to overlap with the detection pattern 100b, the multi-viewpoint image may be printed not to overlap with the area in which the detection pattern 100b is printed. When the detection pattern 100b is printed, the print position in which the detection pattern 100b is printed is stored in the buffer memory 52, it is possible to print the multi-viewpoint image so as not to overlap with the position. Accordingly, it is possible to prevent a color from being darkened due to the double printing on the area in which the detection pattern is printed. Therefore, it is possible to cause the detection pattern to form a body along with the multi-viewpoint image in the printed product in which the multi-viewpoint has been printed. As a result, it is possible to cause the detection pattern to be invisible after printing the multi-viewpoint image, thereby improving the print quality.

In this embodiment, the color areas of Y, M, C, and B are extracted from the print data, the area in which the detection pattern 100b can be printed is determined out of the extracted color areas, and the color area in which the detection pattern 100b should be printed is determined in the priority order (in the order of B, M, C, and Y) when plural color areas in which the detection pattern 100b can be printed are determined (steps S101 to S103). However, the color area to be printed may be first determined and then the detection pattern may be printed in the determined color area so as to have a printable size.

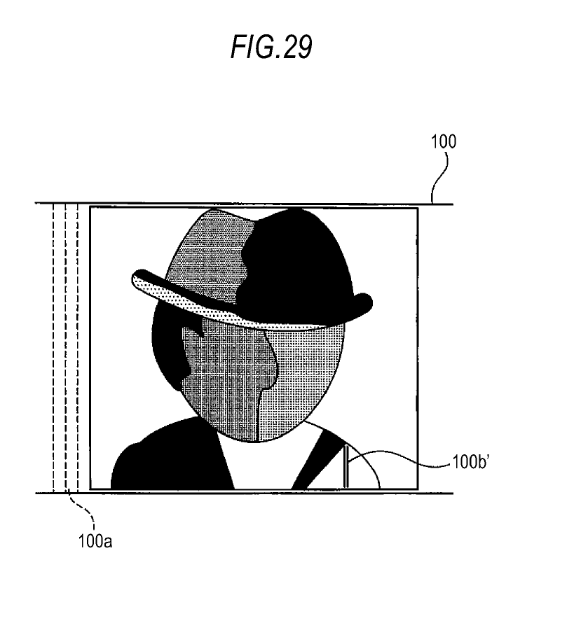

FIG. 29 is a diagram schematically illustrating an example where it is determined that the detection pattern should be printed in the Y area (see FIG. 28A). Since the length of the Y area in the longitudinal direction of the lenses 100a is small, the detection pattern 100b with a width of 1 pixel and a length of 30 pixels cannot be printed in the Y area. Accordingly, a detection pattern 100b′ with the maximum printable size for the extracted Y area is printed in the Y area. When the length of the detection pattern with the maximum printable size is not sufficient for detecting the inclination of the lenticular sheet 100, for example, the detection pattern 100b′ can include plural straight lines.

### Tenth Embodiment

Although it has been described in the ninth embodiment of the present invention that the detection pattern is printed in the same color in the area to be printed in the colors of the ink ribbons (for example, Y, M, C, and B), it cannot necessarily be said that areas to be printed in the colors of the ink ribbons exist in the print data.

In a tenth embodiment of the present invention, the detection pattern is printed in an area to be printed in the colors of the ink ribbons (for example, Y, M, C, and B) and similar colors thereof. A printing apparatus 10J according to the tenth embodiment of the present invention will be described below. The configuration, the control system, and the printing process in the operation of the printing apparatus 10J are the same as those of the printing apparatus 10 and thus are not described. The process of printing the detection pattern 100b will be described. The same elements as the first embodiment are referenced by the same reference numerals and signs and are not described.

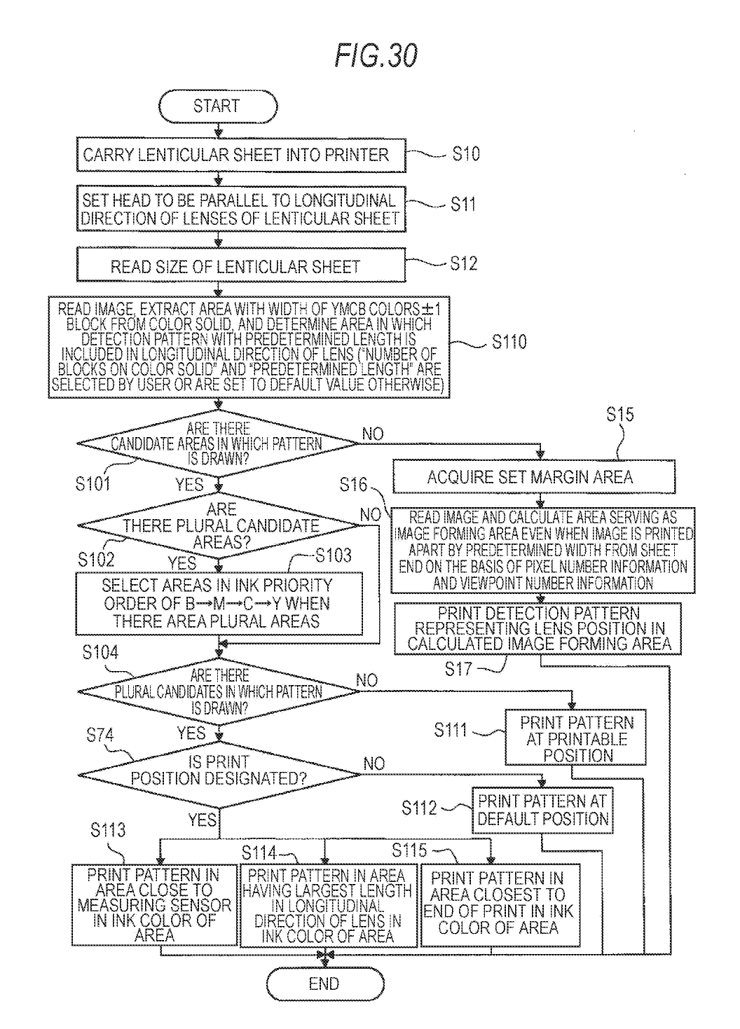

FIG. 30 is a flow diagram illustrating the process flow of printing the detection pattern 100b. This printing process is controlled by the system controller 50. The program causing the system controller 50 to perform the printing process is stored in the program storage part 51.

The system controller 50 conveys the lenticular sheet 100 introduced from the sheet feeding part 10a into the printing apparatus 10 through the use of the sheet conveying mechanism 431 (step S10). In this step, the leading edge of the lenticular sheet 100 is clamped by the clamper 30 and the lenticular sheet 100 is roughly positioned.

The system controller 50 adjusts the angle of the lenticular sheet 100 through the use of the sheet conveying mechanism 431 so that the conveying direction of the lenticular sheet 100 is perpendicular to the longitudinal direction of the lenses 100a, that is, so that the arrangement direction of the thermal head 14 is parallel to the longitudinal direction of the lenses 100a (step S11) and acquires the lenticular sheet size based on the detection result of the sensor part 53 (step S12).

The system controller 50 acquires print data from the buffer memory 52, extracts color areas of the Y color and the similar colors thereof, the M color and the similar colors thereof, the C color and the similar colors thereof, and the B color and the similar colors thereof from the print data, and determines an area in which the detection pattern 100b can be printed out of the color areas (step S110). In this embodiment, since the detection pattern 100b is printed with a width of 1 pixel and a length of 30 pixels, areas having such a size are determined in the color areas.

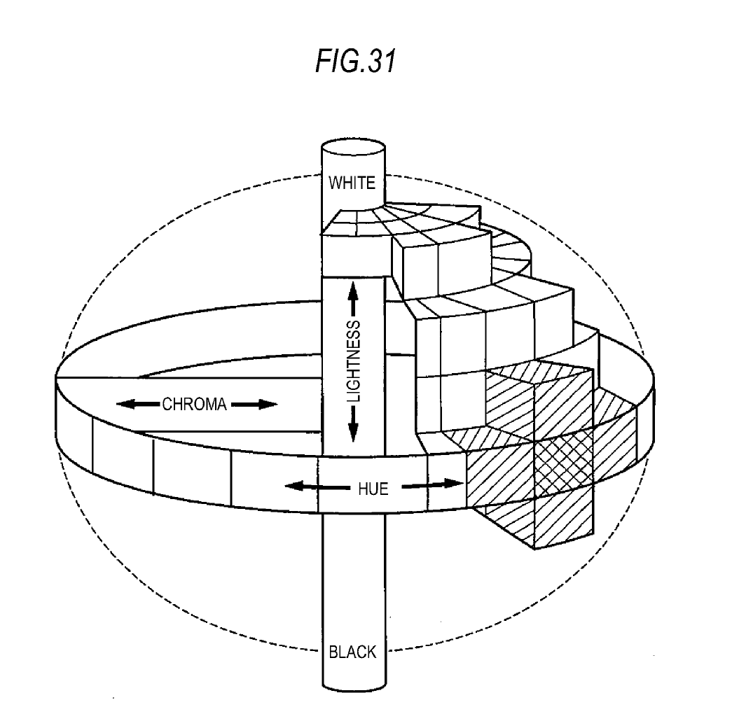

Here, the similar colors will be described. A similar color is a color close to a designated color (one of the colors of the ink ribbons included in the printing apparatus 10J, such as Y, M, C, and B) in a color solid. The color solid is a solid in which all physical colors based on hue, lightness, and chroma which are three attributes of color are regularly arranged in a three-dimensional space. FIG. 31 shows an example of the color solid. In the color solid shown in FIG. 31, hue cycles (Y, M, and C) are arranged horizontally, an achromatic color is located at the center in each hue circle, colors are sequentially arranged from the center to the colors in the order of increasing the chroma, and colors with the same chroma are vertically arranged depending on the degree of lightness. This color solid is divided into blocks with a predetermined size and the similar color is determined using the blocks. The size of each block is not particularly limited and the range of similar colors can be changed by changing the size of the blocks or a designated block range.

For example, when a color separated from a designated color by a designated block range in a color solid is determined as the similar colors and the designated block range is set to one block, the similar colors of Y are colors included in the range separated by one block (the hatched blocks in FIG. 31) around the block (the meshed block in FIG. 31) representing the Y color. The similar colors of M, the similar colors of C, and the similar colors of B can be determined in the same way.

When the similar colors are determined in this way, color areas to be printed in a designated color and the similar colors thereof such as the Y color and the similar colors thereof, the M color and the similar colors thereof, the C color and the similar colors thereof, and the B color and the similar colors thereof are extracted from the print data. The method of determining the area in which the detection pattern 100b can be printed out of the extracted color areas is the same as step S100 and thus is not described.

The system controller 50 determines whether the area in which the detection pattern 100b can be printed is determined (step S101). When it is determined that the area in which the detection pattern 100b can be printed is determined (YES in step S101), the system controller 50 determines whether plural color areas in which the detection pattern 100b can be printed are determined (step S102).

When it is determined that plural color areas in which the detection pattern 100b can be printed are determined (YES in step S102), the priority order of colors is set to the order of B, M, C, and Y and the color area in which the detection pattern 100b is printed is determined based on this priority order (step S103).

When it is determined that only one color area in which the detection pattern 100b can be printed is determined (NO in step S102) and when the color area is determined in step S103, the system controller 50 determines whether plural patterns which can draw the detection pattern 100b exist in the color area determined as the area in which the detection pattern 100b can be printed (step S104).

When it is determined that only one pattern which can draw the detection pattern 100b exists (NO in step S104), the system controller 50 sets the position in which the detection pattern 100b can be drawn in an image forming area as the print position of the detection pattern 100b and prints the detection pattern 100b in the designated color of the color area including the print position at the print position (step S111).

When it is determined that plural patterns which can draw the detection pattern 100b exist (YES in step S104), the system controller 50 acquires print information from the buffer memory 52 and determines whether the print information includes information designating the print position (step S74).

When it is determined that the print information does not include the information designating the print position (NO in step S74), the system controller 50 sets an area in which the color area determined in step S100 or the color area selected in step S103 is printed in the image forming area and prints the detection pattern 100b in the designated color of the color area including the print position at an initially-set print position (for example, substantially the center of the color area) in the area in which the color area is printed (step S112).

When it is determined that the print information includes the information designating the print position (YES in step S74), the system controller 50 sets the area in which the color area determined in step S100 or the color area selected in step S103 is printed in the image forming area, sets the designated position in the area in which the color area is printed as the print position of the detection pattern 100b, and prints the detection pattern 100b in the designated color of the color area including the print position at the print position (steps S113 to S115).

The process of steps S111 to S115 will be described below. The clamper 30 is driven through the use of the sheet conveying control part 421 to convey the lenticular sheet 100 so that the set print position is located just below the thermal head 14. The system controller 50 rotates the ribbon cage 12 to move an ink ribbon of the designated color (one of Y, M, and C) of the color area including the print position to the position of the thermal head 14, and electrifies the thermal head 14 to emit heat while winding the ink ribbon on the winding reel 16 through the use of the ink ribbon driving mechanism 433 at a speed slightly higher than the moving speed of the lenticular sheet 100.

As a result, the detection pattern 100b is printed on the lenticular sheet 100 so as to be parallel to the longitudinal direction of the lenses 100a and then the printing of an image is performed.

When it is determined that the color area in which the detection pattern 100b can be printed is not determined (NO in step S100), the system controller 50 acquires a set value of the margin area from the buffer memory 52 (step S15), and determines an area necessarily serving as an image forming area in spite of the misalignment in print position out of the image forming area based on the print data and the set value of the margin area stored in the buffer memory 52 and the lenticular sheet size acquired in step S12 (step S16).

The system controller 50 sets an edge portion of the area necessarily serving as an image forming area as the print position of the detection pattern 100b and prints the detection pattern 100b at the print position in black (step S17).

According to this embodiment, the color areas in which the detection pattern can be printed are extracted in the range of the colors included in the printing apparatus and the similar colors thereof. Accordingly, when colors included in the print data are not strictly the colors of Y, M, C, and B, it is possible to extract the color areas in which the detection pattern can be printed.

According to this embodiment, since the detection pattern is printed in the designated color of the color area including the similar colors, the detection pattern can be made to be invisible. Since the detection pattern is printed in one color using the ink used to print the image, it is possible to reduce the time and the cost. Since the detection pattern is printed in the image forming area, it is possible to improve the sheet-use efficiency.

In this embodiment, similarly to the ninth embodiment, an image may be printed so as not to overlap with the area in which the detection pattern 100b is printed at the time of printing the image after printing the detection pattern 100b.

### Eleventh Embodiment

Although it has been described in the first embodiment of the present invention that the detection pattern is printed at an edge portion of the area necessarily serving as an image forming area, the print position of the detection pattern is not limited to this position.

In an eleventh embodiment of the present invention, the detection pattern is printed at a position in which the detection pattern is not visible to the front side but the detection pattern is visible to the sides other than the front side. A printing apparatus 10K according to the eleventh embodiment of the present invention will be described below. The configuration, the control system, and the printing process in the operation of the printing apparatus 10K are the same as those of the printing apparatus 10 and thus are not described. The process of printing the detection pattern 100b will be described. The same elements as the first embodiment are referenced by the same reference numerals and signs and are not described.

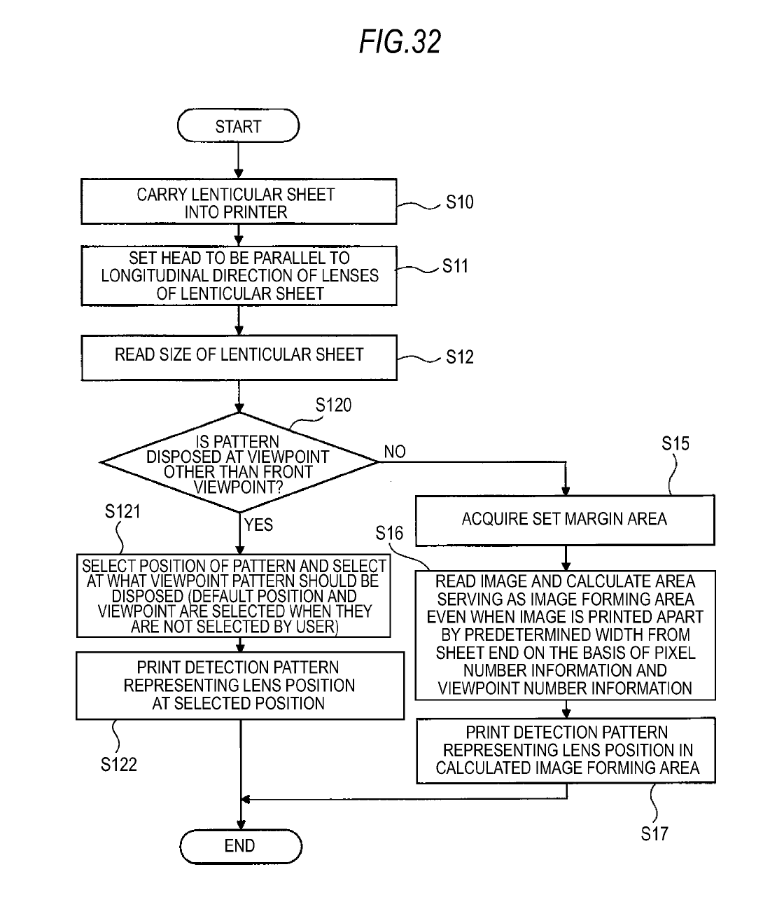

FIG. 32 is a flow diagram illustrating the process flow of printing the detection pattern 100b. This printing process is controlled by the system controller 50. The program causing the system controller 50 to perform the printing process is stored in the program storage part 51.

The system controller 50 conveys the lenticular sheet 100 introduced from the sheet feeding part 10a into the printing apparatus 10 through the use of the sheet conveying mechanism 431 (step S10). In this step, the leading edge of the lenticular sheet 100 is clamped by the clamper 30 and the lenticular sheet 100 is roughly positioned.

The system controller 50 adjusts the angle of the lenticular sheet 100 through the use of the sheet conveying mechanism 431 so that the conveying direction of the lenticular sheet 100 is perpendicular to the longitudinal direction of the lenses 100a, that is, so that the arrangement direction of the thermal head 14 is parallel to the longitudinal direction of the lenses 100a (step S11) and acquires the lenticular sheet size based on the detection result of the sensor part 53 (step S12).

The system controller 50 acquires print data from the buffer memory 52 and determines whether the detection pattern 100b should be printed at a position which is not visible to the front side (step S120). For example, the determination can be carried out depending on whether information representing that the detection pattern 100b should be printed at the position not visible to the front side is included in the print setting stored in the program storage part 51 or the buffer memory 52. The determination may be carried out depending on the number of viewpoints of the print data. In this case, when the number of viewpoints of the print data is two or less, the viewpoint is only the front side and thus it is determined that the detection pattern 100b should not be printed at the position not visible to the front side. When the number of viewpoints of the print data is three or more, it may be determined that the detection pattern 100b should be printed at the position not visible to the front side.

When it is determined that the detection pattern 100b should be printed at the position not visible to the front side (YES in step S120), the system controller selects at what position of what viewpoint to print the detection pattern 100b (step S121). The viewpoint and the position where the detection pattern 100b is printed can be determined using the information stored in the buffer memory 52. The system controller 50 may output a selection instruction to a display part or the like not shown and may use an input result in response thereto.

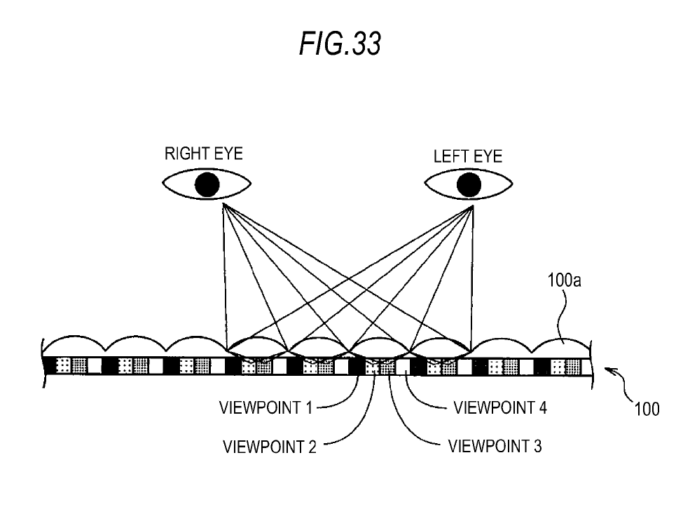

FIG. 33 is a diagram schematically illustrating the relationship between a print position of a multi-viewpoint image and the lenses 100a when the multi-viewpoint image includes four images (hereinafter, referred to as “four-viewpoint image”). In FIG. 33, a multi-viewpoint image including four images of viewpoint 1 to viewpoint 4 is acquired as the print data and the images of viewpoint 1 to viewpoint 4 are divided into thin and long striped units. Each unit has such a width that the units of all the viewpoints can be located on the back surface of a single lens 100a.

The units can be arranged so as to allow the units formed from the same image not to neighbor each other, that is, to be separated from each other. The arrangement direction is perpendicular to the longitudinal direction of the lenses 100a. In FIG. 33, a unit of viewpoint 1, a unit of viewpoint 2, a unit of viewpoint 3, a unit of viewpoint 4, a unit of viewpoint 1, . . . are sequentially arranged in this order.

The units formed from the same image and printed on the back surfaces of the plural lenses 100a are focused at the same positions by the lenses 100a. Accordingly, a predetermined image is visible at a predetermined position. In FIG. 33, the image of viewpoint 2 is visible to the left eye of a front viewer and the image of viewpoint 3 is visible to the right eye of the front viewer. The images of viewpoints 1 and 4 are visible to the right eye and the left eye of a viewer located on a side other than the front side.

Accordingly, in the example shown in FIG. 33, when the detection pattern 100b is printed at a position not visible to the front side, it is selected that the detection pattern 100b should be printed in the images of viewpoints 1 and 4. Initially, in consideration of a case where images of five or more viewpoints are printed, the image to be printed at both ends of the lens 100a is selected. The image to be printed may be one or two or more.

The system controller 50 sets an image forming area when a predetermined position is set to the print start position on the lenticular sheet 100, and sets an area in which the image of the determined viewpoint (image not visible to the front side) is printed in the image forming area. The system controller sets a predetermined position in the area in which the image not visible to the front side is printed as the print position of the detection pattern. An example of the position at which the detection pattern 100b should be printed includes an edge portion of the image forming area and substantially the center thereof, for example. Initially, the edge portion of the image forming area is set so as not to be visible.

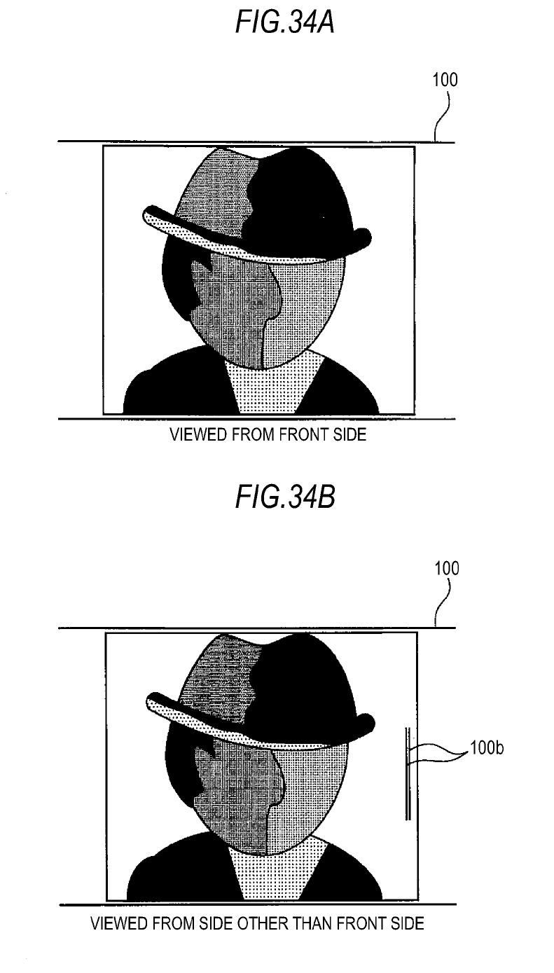

The system controller 50 prints the detection pattern 100b in black at the print position of the detection pattern set in the area in which the image not visible to the front side is printed (step S122). FIGS. 34A and 34B are diagrams schematically illustrating the print position of the detection pattern 100b. A position not visible to the front side as shown in FIG. 34A and visible to a position other than the front side as shown in FIG. 34B is set as the print position of the detection pattern 100b. In this embodiment, since the detection pattern 100b is printed in viewpoints 1 and 4, two detection patterns 100b are printed in parallel. FIGS. 34A and 34B show two images, but these two images are actually printed to overlap with each other.

In step S122, the clamper 30 is driven through the use of the sheet conveying control part 421 to convey the lenticular sheet 100 so that the set print position is located just below the thermal head 14. The system controller 50 rotates the ribbon cage 12 to move the ink ribbon of black (K) to the position of the thermal head 14, and electrifies the thermal head 14 to emit heat while winding the ink ribbon on the winding reel 16 through the use of the ink ribbon driving mechanism 433 at a speed slightly higher than the moving speed of the lenticular sheet 100. Accordingly, the detection pattern 100b is printed. The detection pattern 100b needs to be printed with a width smaller than the width of the unit.

When it is determined that the detection pattern 100b is not printed at the position not visible to the front side, for example, when the number of viewpoints of the print data is two or less (NO in step S120), the system controller 50 acquires a set value of the margin area from the buffer memory 52 (step S15), and determines an area necessarily serving as an image forming area in spite of the misalignment in print position out of the image forming area based on the print data and the set value of the margin area stored in the buffer memory 52 and the lenticular sheet size acquired in step S12 (step S16).

The system controller 50 sets an edge portion of the area necessarily serving as an image forming area as the print position of the detection pattern 100b and prints the detection pattern 100b at the print position in black (step S17).

As a result, the detection pattern 100b is printed on the lenticular sheet 100 so as to be parallel to the longitudinal direction of the lenses 100a and then the printing of an image is performed.

According to this embodiment, since the detection pattern is printed at the position not visible to the front side, a viewer can be made not to view the detection pattern at the time of the stereoscopic viewing. Therefore, it is possible to make the detection pattern invisible while printing the detection pattern in black which can be easily detected. Since the detection pattern is printed in the image forming area, it is possible to improve the sheet-use efficiency.

### Twelfth Embodiment

Although it has been described in the eleventh embodiment of the present invention that the detection pattern is printed at the print position not visible to the front side, the print position of the detection pattern is not limited to this position.

In a twelfth embodiment of the present invention, the detection pattern is printed in one of two images visible to the front side. A printing apparatus 10L according to the twelfth embodiment of the present invention will be described below. The configuration, the control system, and the printing process in the operation of the printing apparatus 10L are the same as those of the printing apparatus 10 and thus are not described. The process of printing the detection pattern 100b will be described. The same elements as the first embodiment are referenced by the same reference numerals and signs and are not described.

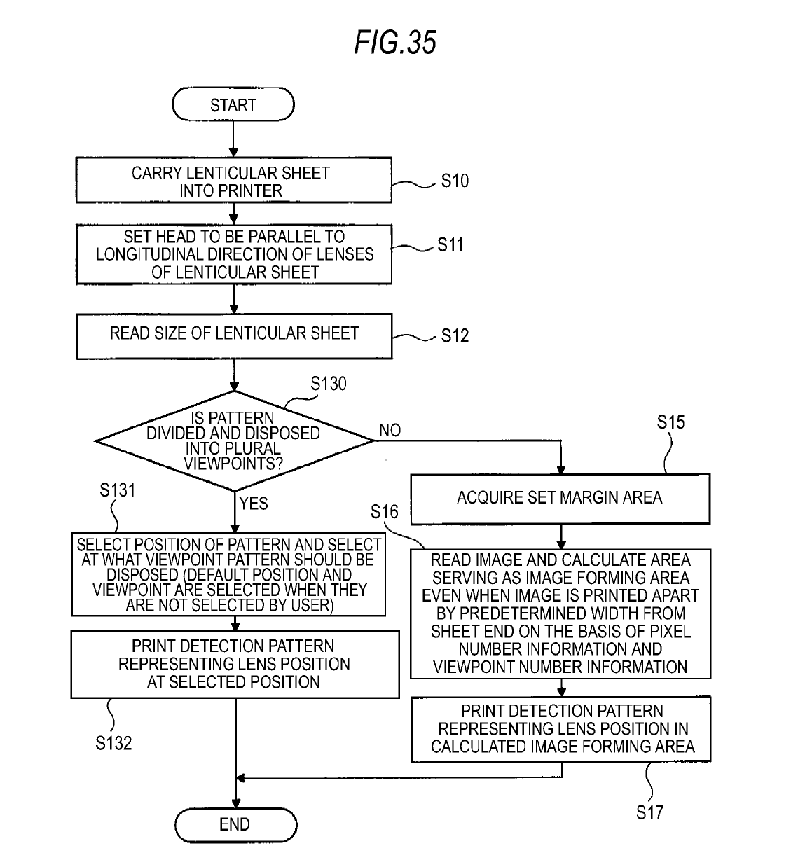

FIG. 35 is a flow diagram illustrating the process flow of printing the detection pattern 100b. This printing process is controlled by the system controller 50. The program causing the system controller 50 to perform the printing process is stored in the program storage part 51.

The system controller 50 conveys the lenticular sheet 100 introduced from the sheet feeding part 10a into the printing apparatus 10 through the use of the sheet conveying mechanism 431 (step S10). In this step, the leading edge of the lenticular sheet 100 is clamped by the clamper 30 and the lenticular sheet 100 is roughly positioned.

The system controller 50 adjusts the angle of the lenticular sheet 100 through the use of the sheet conveying mechanism 431 so that the conveying direction of the lenticular sheet 100 is perpendicular to the longitudinal direction of the lenses 100a, that is, so that the arrangement direction of the thermal head 14 is parallel to the longitudinal direction of the lenses 100a (step S11) and acquires the lenticular sheet size based on the detection result of the sensor part 53 (step S12).

The system controller 50 acquires print data from the buffer memory 52 and determines whether the detection pattern 100b should be printed into plural viewpoints (images constituting the print data) (step S130). For example, the determination can be carried out depending on whether information representing that the detection pattern 100b should be printed into plural viewpoints is included in the print setting information stored in the program storage part 51 or the buffer memory 52. The determination may be carried out depending on the number of viewpoints of the print data. In this case, when the number of viewpoints of the print data is two or less, the viewpoint is only the front side and thus it is determined that the detection pattern 100b should not be printed at the position not visible to the front side. When the number of viewpoints of the print data is three or more, it may be determined that the detection pattern 100b should be printed at the position not visible to the front side.

When it is determined that the detection pattern 100b should be printed into plural viewpoints (YES in step S130), the system controller selects at what position of what viewpoint image to print the detection pattern 100b (step S131). The viewpoint and the position where the detection pattern 100b is printed can be determined using the information stored in the buffer memory 52. The system controller 50 may output a selection instruction to a display part or the like not shown and may use an input result in response thereto.

As shown in FIG. 33, when viewpoints 2 and 3 are visible to the front side and viewpoints 1 and 4 are visible to a position other than the front side, two images of one image (viewpoint 2 or viewpoint 3) visible to the front side and one image (viewpoint 1 or viewpoint 4) visible to a position other than the front side are selected as the image in which the detection pattern 100b should be printed. Initially, in consideration of the case where images of five or more viewpoints are printed, one image to be printed substantially at the center of the lens 100a and one image to be printed at an end thereof are selected.

The system controller 50 sets an image forming area when a predetermined position is set to the print start position on the lenticular sheet 100, and sets an area in which the thus determined images of plural viewpoints are printed in the image forming area. The system controller sets a predetermined position in the area in which the images of plural viewpoints are printed as the print position of the detection pattern. An example of the position at which the detection pattern 100b should be printed includes an edge portion of the image forming area and substantially the center thereof. Initially, the edge portion of the image forming area is set so as not to be visible.

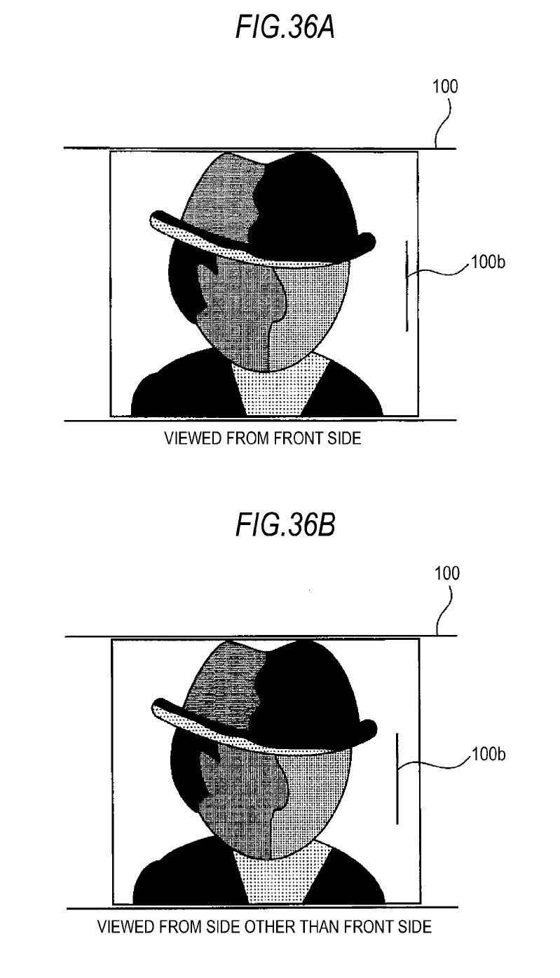

The system controller 50 prints the detection patterns 100b in black at the print position of the detection pattern set in the area in which the images of plural viewpoints are printed (step S132). FIGS. 36A and 36B are diagrams schematically illustrating the print position of the detection pattern 100b. A position where one detection pattern 100b is visible to the front side as shown in FIG. 36A and one detection pattern 100b is visible to a position other than the front side as shown in FIG. 36B is set as the print position of the detection pattern 100b. FIGS. 34A and 34B show two images individually, but since these two images are actually printed to overlap with each other, two detection patterns 100b are printed in parallel. The detection patterns 100b need to be printed with a width smaller than the width of the unit.

In step S132, the clamper 30 is driven through the use of the sheet conveying control part 421 to convey the lenticular sheet 100 so that the set print position is located just below the thermal head 14. The system controller 50 rotates the ribbon cage 12 to move the ink ribbon of black (K) to the position of the thermal head 14, and electrifies the thermal head 14 to emit heat while winding the ink ribbon on the winding reel 16 through the use of the ink ribbon driving mechanism 433 at a speed slightly higher than the moving speed of the lenticular sheet 100.

Accordingly, the detection patterns 100b are printed so that the detection patterns 100b are visible to the front side and another position, respectively. Accordingly, all the detection patterns 100b are not visible to any position of the front side and a position other than the front side, but the detection patterns 100b are visible to only one of the right eye and the left eye.

When it is determined that the detection pattern 100b is not printed at the position not visible to the front side, for example, when the number of viewpoints of the print data is two or less (NO in step S120), the system controller 50 acquires a set value of the margin area from the buffer memory 52 (step S15), and determines an area necessarily serving as an image forming area in spite of the misalignment in print position out of the image forming area based on the print data and the set value of the margin area stored in the buffer memory 52 and the lenticular sheet size acquired in step S12 (step S16).

The system controller 50 sets an edge portion of the area necessarily serving as an image forming area as the print position of the detection pattern 100b and prints the detection pattern 100b at the print position in black (step S17).

As a result, the detection pattern 100b is printed on the lenticular sheet 100 so as to be parallel to the longitudinal direction of the lenses 100a and then the printing of an image is performed.

According to this embodiment, it is possible to print the detection patterns so that all the detection patterns are not visible to any position of the front side and a position other than the front side, but the detection patterns are visible to only one of the right eye and the left eye. When an image is visible to only one of the right eye and the left eye, it is generally known that it means that the color is lightened. Therefore, as described in this embodiment, by allowing the detection patterns to be visible to only one of the right eye and the left eye, it is possible to make the detection pattern invisible while printing the detection pattern in black which can be easily detected. Since the detection pattern is printed in the image forming area, it is possible to improve the sheet-use efficiency.

### Thirteenth Embodiment

Although it has been described in the first embodiment of the present invention that the detection pattern including a single straight line is printed at an edge portion of the area necessarily serving as an image forming area, the shape of the detection pattern is not limited to this configuration.

In a thirteenth embodiment of the present invention, a detection pattern giving information representing the print position of the detection pattern is printed. A printing apparatus 10M according to the thirteenth embodiment of the present invention will be described below. The configuration, the control system, and the printing process in the operation of the printing apparatus 10M are the same as those of the printing apparatus 10 and thus are not described. The process of printing the detection pattern 100b will be described. The same elements as the first embodiment are referenced by the same reference numerals and signs and are not described.

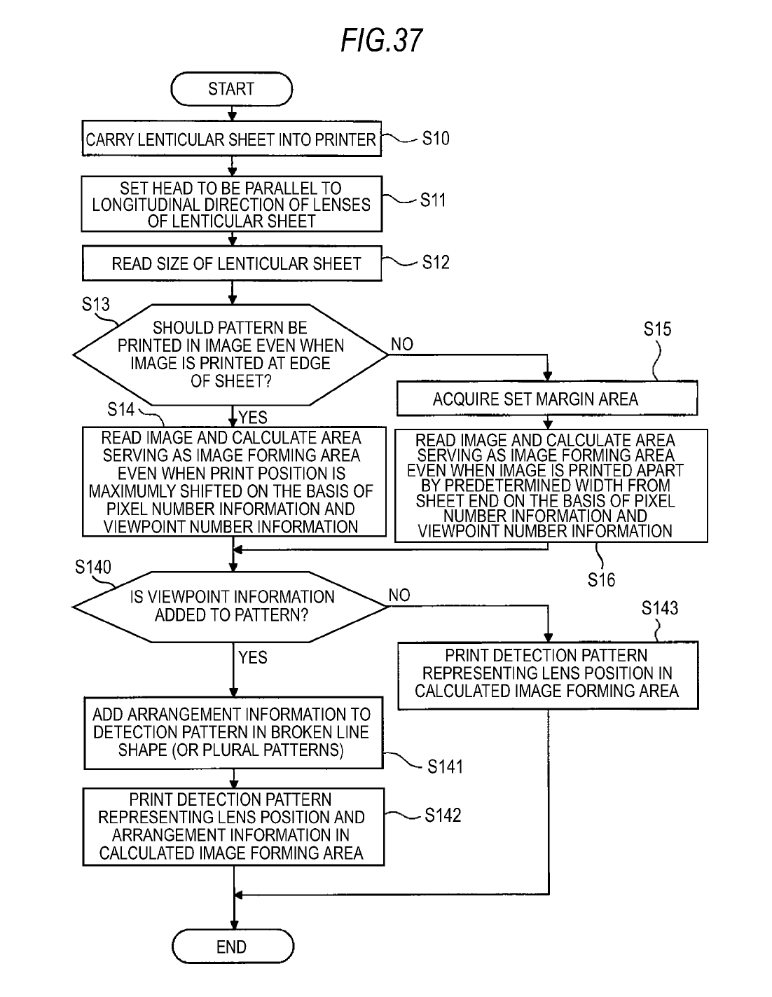

FIG. 37 is a flow diagram illustrating the process flow of printing detection patterns 100b and 100c. This printing process is controlled by the system controller 50. The program causing the system controller 50 to perform the printing process is stored in the program storage part 51.

The system controller 50 conveys the lenticular sheet 100 introduced from the sheet feeding part 10a into the printing apparatus 10 through the use of the sheet conveying mechanism 431 (step S10). In this step, the leading edge of the lenticular sheet 100 is clamped by the clamper 30 and the lenticular sheet 100 is roughly positioned.

The system controller 50 adjusts the angle of the lenticular sheet 100 through the use of the sheet conveying mechanism 431 so that the conveying direction of the lenticular sheet 100 is perpendicular to the longitudinal direction of the lenses 100a, that is, so that the arrangement direction of the thermal head 14 is parallel to the longitudinal direction of the lenses 100a (step S11) and acquires the lenticular sheet size based on the detection result of the sensor part 53 (step S12).

When an image is printed at an edge of the lenticular sheet 100, it is determined whether the detection pattern 100b should be printed in the image (step S13).

When it is determined that a margin area should not be intentionally formed at the edge of the lenticular sheet 100 (YES in step S13), the system controller 50 sets an area necessarily serving as an image forming area in spite of the misalignment in print position of a multi-viewpoint image based on the print data stored in the buffer memory 52 and the lenticular sheet size acquired in step S12 (step S14).

When it is determined that a margin area is intentionally formed at an edge of the lenticular sheet 100 (NO in step S13), the system controller 50 acquires a set value of the margin area from the buffer memory 52 (step S15), and acquires an area necessarily serving as an image forming area in spite of the misalignment in print position out of the image forming area based on the print data and the set value of the margin area stored in the buffer memory 52 and the lenticular sheet size acquired in step S12 (step S16).

The system controller 50 sets the print position of the detection pattern 100b to an edge portion of the area (the hatched area in FIGS. 9 and 10) necessarily serving as an image forming area determined in step S14 and 16. The system controller 50 determines whether the detection pattern 100c having the information representing the print position of the detection pattern 100b should be printed based on the print position of the detection pattern 100b (step S140). This determination can be carried out based on the print setting stored in the program storage part 51 or the buffer memory 52. For example, the determination may be carried out based on the number of viewpoints of the print data, such as adding information at what position to print the detection pattern when the number of viewpoints of the print data is three or more.

When it is determined that the detection pattern 100c having the information representing the print position of the detection pattern 100b should be printed (YES in step S140), it is detected what printing area of what viewpoint includes the printing area of the detection pattern 100c determined in steps S14 and S16 and the detection pattern 100c having the information representing the print position of the detection pattern 100b is generated based on the detected information (step S141). The information representing the print position of the detection pattern 100b is information (hereinafter, referred to as “viewpoint information”) representing the viewpoint (image) in which the detection pattern 100c is printed, and the viewpoint information includes one or more straight lines.

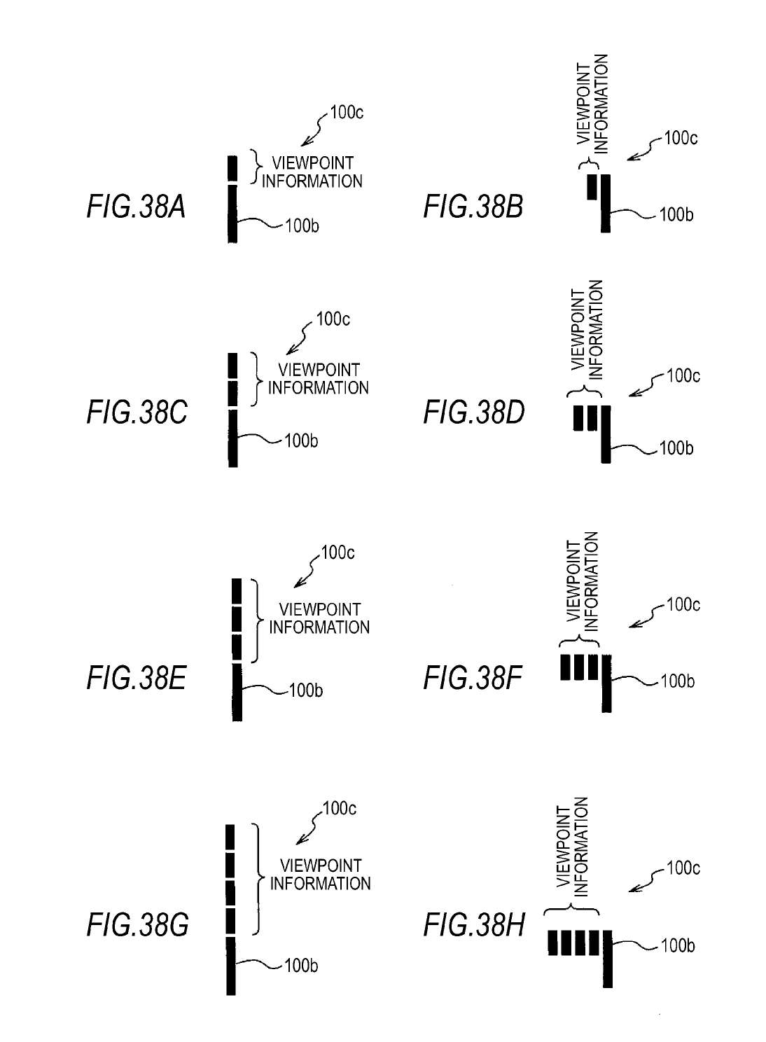

It is exemplified that the detection pattern 100c in which the information representing the print position of the detection pattern 100b is added to the print data including four viewpoints (four images) of viewpoints 1 to 4 is printed, as shown in FIG. 33. FIGS. 38A to 38H show examples of the detection pattern 100c when the detection patterns 100c of viewpoints 1 to 4 are printed.

FIGS. 38A and 38B show examples of the detection pattern 100c to which the viewpoint information representing that the detection pattern 100b is printed in the image of viewpoint 1. The viewpoint information representing that the detection pattern 100c is printed in the image of viewpoint 1 includes a short straight line.

FIGS. 38C and 38D show examples of the detection pattern 100c to which the viewpoint information representing that the detection pattern 100b is printed in the image of viewpoint 2 is added. The viewpoint information representing that the detection pattern 100c is printed in the image of viewpoint 2 includes two short straight lines. The viewpoint information shown in FIG. 38C is obtained when the two short straight lines are arranged vertically (in a straight line shape) and the viewpoint information shown in FIG. 38D is obtained when the two short straight lines are arranged horizontally.

FIGS. 38E and 38F show examples of the detection pattern 100c to which the viewpoint information representing that the detection pattern 100b is printed in the image of viewpoint 3 is added. The viewpoint information representing that the detection pattern 100c is printed in the image of viewpoint 3 includes three short straight lines. The viewpoint information shown in FIG. 38E is obtained when the three short straight lines are arranged vertically (in a straight line shape) and the viewpoint information shown in FIG. 38F is obtained when the three short straight lines are arranged horizontally.

FIGS. 38G and 38H show examples of the detection pattern 100c to which the viewpoint information representing that the detection pattern 100b is printed in the image of viewpoint 4 is added. The viewpoint information representing that the detection pattern 100c is printed in the image of viewpoint 4 includes four short straight lines. The viewpoint information shown in FIG. 38G is obtained when the four short straight lines are arranged vertically (in a straight line shape) and the viewpoint information shown in FIG. 38H is obtained when the four short straight lines are arranged horizontally.

The viewpoint information may be arranged vertically or horizontally with respect to the detection pattern 100b used to detect the inclination of the lenticular sheet 100 or the like. In FIGS. 38A, 38C, 38E, and 38G, the vertically-arranged viewpoint information and the detection pattern 100b are arranged vertically (in a straight line shape). Since the detection pattern 100b is parallel to the longitudinal direction of the lenses 100a, the viewpoint information and the detection pattern 100b can be arranged to be parallel to the longitudinal direction of the lenses 100a.

In FIGS. 38B, 38D, 38F, and 38H, the horizontally-arranged viewpoint information and the detection pattern 100b are arranged horizontally. Since the detection pattern 100b is parallel to the longitudinal direction of the lenses 100a, the straight lines of the viewpoint information and the detection pattern 100b can be arranged in parallel in the direction perpendicular to the longitudinal direction of the lenses 100a. In FIGS. 38B, 38D, 38F, and 38H, the horizontally-arranged viewpoint information and the detection pattern 100b are arranged horizontally, but the vertically-arranged viewpoint information and the detection pattern 100b may be arranged horizontally.

The positions of the image and the lenses 100a are uniquely determined based on the print data. Accordingly, by printing the detection pattern 100c, it is possible to clearly display at what lens 100a the detection pattern 100b is located.

The system controller 50 prints the detection pattern 100c (step S142) so that the detection pattern 100b included in the detection pattern 100c generated in step S142 is located at the print position (an edge portion of the area necessarily serving as an image forming area determined in steps S14 and 16 in this embodiment) of the detection pattern 100b.

When it is determined that the detection pattern 100c having the information representing the print position of the detection pattern 100b should not be printed (NO in step S140), the system controller prints the detection pattern 100b at the print position (an edge portion of the area necessarily serving as an image forming area determined in steps S14 and 16 in this embodiment) of the detection pattern 100b (step S143).

In steps S142 and S143, the clamper 30 is driven through the use of the sheet conveying control part 421 to convey the lenticular sheet 100 so that the print position of the detection pattern 100b is located just below the thermal head 14. The system controller 50 rotates the ribbon cage 12 to move the ink ribbon of black (K) to the position of the thermal head 14, and electrifies the thermal head 14 to emit heat while winding the ink ribbon on the winding reel 16 through the use of the ink ribbon driving mechanism 433 at a speed slightly higher than the moving speed of the lenticular sheet 100.

As a result, the detection patterns 100b and 100c are printed on the lenticular sheet 100 so as to be parallel to the longitudinal direction of the lenses 100a and then the printing of an image is performed.

According to this embodiment, it is possible to clearly display the information representing the location of the detection pattern. Accordingly, since the print start position of an image is not measured and calculated at the time of printing, it is possible to raise the printing speed. Since the detection patterns are printed in the image forming area, it is possible to improve the sheet-use efficiency.

### Fourteenth Embodiment

Although it has been described in the first embodiment of the present invention that the detection pattern including a single straight line is printed at an edge portion of the area necessarily serving as an image forming area, the shape of the detection pattern is not limited to this configuration.

In a fourteenth embodiment of the present invention, a detection pattern including a text or a figure is printed. A printing apparatus 10N according to the fourteenth embodiment of the present invention will be described below. The configuration, the control system, and the printing process in the operation of the printing apparatus 10N are the same as those of the printing apparatus 10 and thus are not described. The process of printing the detection pattern 100b will be described. The same elements as the first embodiment are referenced by the same reference numerals and signs and are not described.

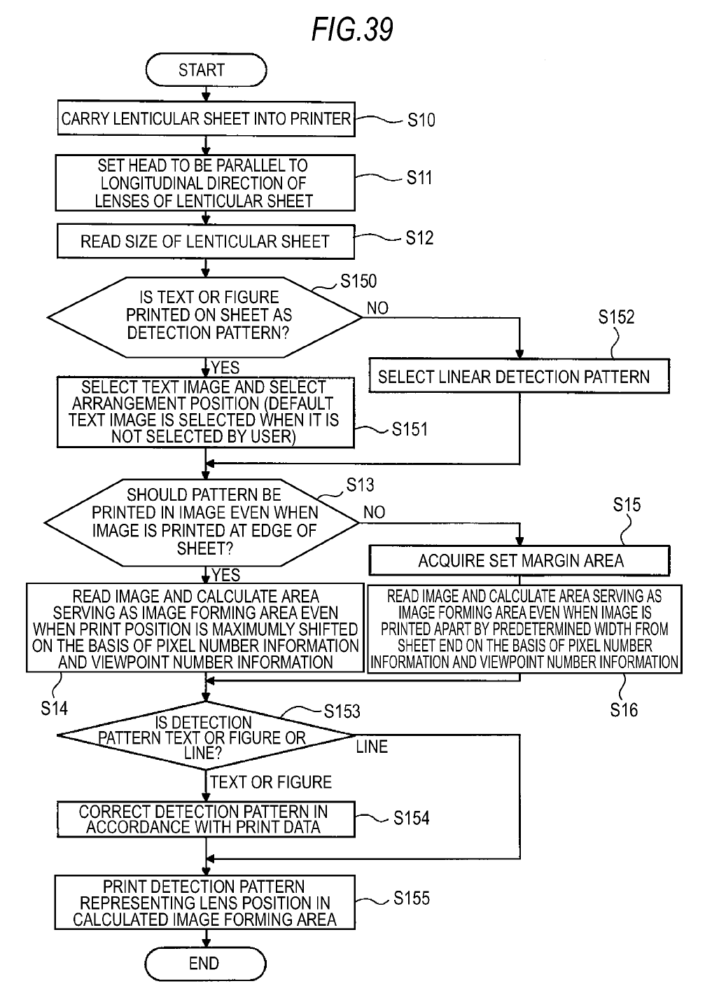

FIG. 39 is a flow diagram illustrating the process flow of printing a detection pattern 100d including a text or a figure. This printing process is controlled by the system controller 50. The program causing the system controller 50 to perform the printing process is stored in the program storage part 51.

The system controller 50 conveys the lenticular sheet 100 introduced from the sheet feeding part 10a into the printing apparatus 10 through the use of the sheet conveying mechanism 431 (step S10). In this step, the leading edge of the lenticular sheet 100 is clamped by the clamper 30 and the lenticular sheet 100 is roughly positioned.

The system controller 50 adjusts the angle of the lenticular sheet 100 through the use of the sheet conveying mechanism 431 so that the conveying direction of the lenticular sheet 100 is perpendicular to the longitudinal direction of the lenses 100a, that is, so that the arrangement direction of the thermal head 14 is parallel to the longitudinal direction of the lenses 100a (step S11) and acquires the lenticular sheet size based on the detection result of the sensor part 53 (step S12).

The system controller 50 determines whether a detection pattern 100d including a text or a figure should be printed (step S150). This determination can be carried out based on the print setting stored in the program storage part 51 or the buffer memory 52. The detection pattern 100d may be stored in advance in the program storage part 51 or may be received from a PC or a digital camera via the communication I/F 55 and stored in the buffer memory 52.

When it is determined that the detection pattern 100d including a text or a figure should be printed (YES in step S150), the system controller 50 selects the detection pattern 100d from the program storage part 51 or the buffer memory 52 (step S151). When plural candidates of the detection pattern 100d are stored, the system controller may select a desired detection pattern 100d based on the print setting stored in the program storage part 51 or the buffer memory 52 or may select an initially-set detection pattern 100d (for example, detection pattern stored at the first time).

When the detection pattern 100d is selected in step S151, the system controller 50 acquires the selected detection pattern 100d and information on the detection pattern 100d. The information on the detection pattern 100d includes which of a text, a figure, and a combination of a text and a figure the detection pattern 100d includes, a print color of the detection pattern 100d, and information (printing direction) representing what direction should be parallel to the lenses 100a. The information is stored in the program storage part 51 or the buffer memory 52 along with the detection pattern 100d. By analyzing the length or direction of the straight line portions of the detection pattern 100d, the printing direction is set in advance so that the direction in which the total length of the straight line portions is the greatest or the direction of the longest straight line portion is parallel to the longitudinal direction of the lenses 100a. It may be estimated that the straight line portion in the longitudinal direction of the detection pattern 100d is longer than the straight line portion in the direction perpendicular to the longitudinal direction of the detection pattern 100d and the printing direction may be set so that the longitudinal direction of the detection pattern 100d is parallel to the longitudinal direction of the lenses 100a.

When it is determined that the detection pattern 100d including a text or a figure should not be printed (NO in step S150), the system controller 50 selects the detection pattern 100b including a straight line (step S152).

When an image is printed at an edge of the lenticular sheet 100, it is determined whether the detection pattern 100b should be printed in the image (step S13).

When it is determined that a margin area should not be intentionally formed at the edge of the lenticular sheet 100 (YES in step S13), the system controller 50 sets an area necessarily serving as an image forming area in spite of the misalignment in print position of a multi-viewpoint image based on the print data stored in the buffer memory 52 and the lenticular sheet size acquired in step S12 (step S14).

When it is determined that a margin area is intentionally formed at an edge of the lenticular sheet 100 (NO in step S13), the system controller 50 acquires a set value of the margin area from the buffer memory 52 (step S15), and acquires an area necessarily serving as an image forming area in spite of the misalignment in print position out of the image forming area based on the print data and the set value of the margin area stored in the buffer memory 52 and the lenticular sheet size acquired in step S12 (step S16).

The system controller 50 sets the print positions of the detection patterns 100b and 100d to the edge portion of the area necessarily serving as an image forming area determined in steps S14 and 16. In this way, the detection pattern to be printed and the print position of the detection pattern are determined. The system controller 50 determines whether the detection pattern to be printed is the detection pattern 100d including a text or a figure or the detection pattern 100b including a straight line based on the processing results of steps S150 to S153 (step S153).

When it is determined that the detection pattern to be printed is the detection pattern 100d including a text or a figure (TEXT or FIGURE in step S153), the system controller 50 inputs the detection pattern 100d selected in step S151 to the YMC dividing and image processing part 56. The YMC dividing and image processing part 56 corrects the detection pattern 100d based on the print data so that the detection pattern 100d is recognized as a text or a figure at the print position of the detection pattern 100d by a viewer (step S154).

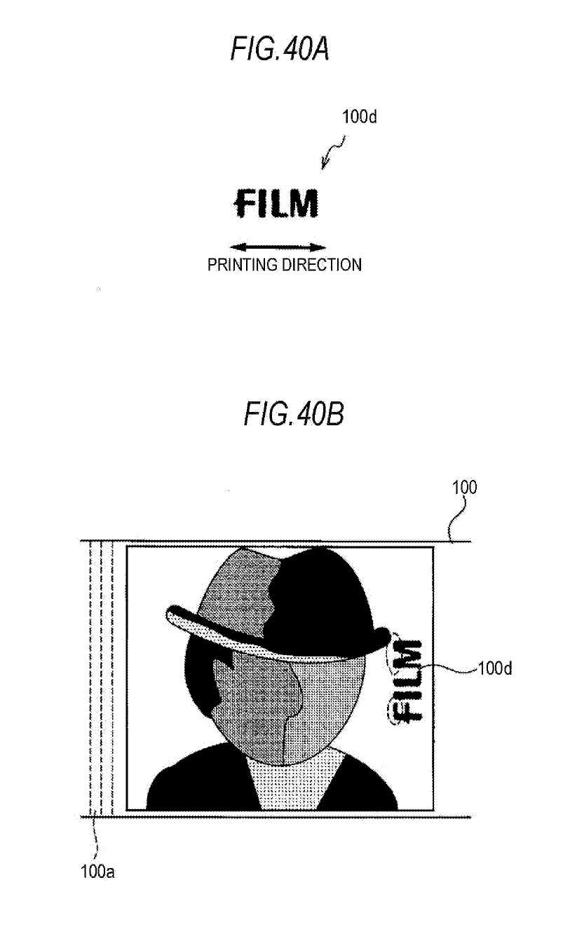

For example, when the four-viewpoint image shown in FIG. 33 is printed, it is considered that the detection pattern 100d including figures recognizable as a text of “FILM” as shown in FIG. 40A.

First, the YMC dividing and image processing part 56 divides the detection pattern 100d including figures recognizable as a text of “FILM” depending on the number of viewpoints of the print data. The dividing direction is a direction perpendicular to the printing direction. In the example shown in FIG. 33, four images of the four-viewpoint image are divided into striped units by the YMC dividing and image processing part 56. Accordingly, the detection pattern 100d including figures recognizable as a text of “FILM” is also divided with the same width as the units by the YMC dividing and image processing part 56.

The YMC dividing and image processing part 56 corrects the detection pattern 100d for printing by arranging the divided units in the direction perpendicular to the printing direction to correspond to the number of viewpoints. For example, when the detection pattern 100d including figures recognizable as a text of “FILM” is divided into units A to C, the detection pattern 100d including figures recognizable as a text of “FILM” is corrected for the four-viewpoint image by arranging four units A, arranging four units B adjacent thereto, and arranging units C adjacent thereto.

The system controller 50 prints the detection pattern 100d corrected in step S154 at the set print position when the detection pattern to be printed is the detection pattern 100d including a text of a figure (TEXT or FIGURE in step S153), and prints the detection pattern 100b at the set print position when the detection pattern to be printed is the detection pattern 100b including a straight line (STRAIGHT LINE in step S153) (step S155). That is, the system controller 50 drives the clamper 30 through the use of the sheet conveying control part 421 to convey the lenticular sheet 100 so that the set print position is located just below the thermal head 14. Then, the system controller 50 rotates the ribbon cage 12 to move the ink ribbon of a desired color to the position of the thermal head 14, and electrifies the thermal head 14 to emit heat while winding the ink ribbon on the winding reel 16 at a speed slightly higher than the moving speed of the lenticular sheet 100 through the use of the ink ribbon driving mechanism 433. The detection pattern 100d is printed in the print color acquired in step S151 or black. When the print color acquired in step S151 includes plural colors, the same process is performed for each color.

Accordingly, when the detection pattern to be printed is the detection pattern 100d including a text or a figure (TEXT or FIGURE in step S153), the detection pattern 100d is printed on the lenticular sheet 100, as shown in FIG. 40A, so that the printing direction of the detection pattern 100d including figures recognizable as a text of “FILM” is parallel to the longitudinal direction of the lenses 100a and so that the text of “FILM” can be recognizable to any viewpoint. When the detection pattern to be printed is the detection pattern 100d including a straight line (STRAIGHT LINE in step S153), the detection pattern 100b is printed on the lenticular sheet 100 so that the detection pattern 100b is parallel to the longitudinal direction of the lenses 100a.

At the same time as printing the detection patterns 100b and 100d, the information on the image forming area is stored in the buffer memory 52. Thereafter, an image is printed.

According to this embodiment, it is possible to print a detection pattern so as to recognize the text or the figure constituting the detection pattern. That is, the detection pattern can be actively displayed and used instead of hiding the detection pattern. Examples of the text constituting the detection pattern include a company name, a date, and an image file name. Examples of the figure include a logo or a mark. Since the printing of the detection pattern cannot be replaced, it is possible to easily detect the inclination of the lenticular sheet using the detection pattern. Since the detection pattern is printed in the image forming area, it is possible to improve the sheet-use efficiency.

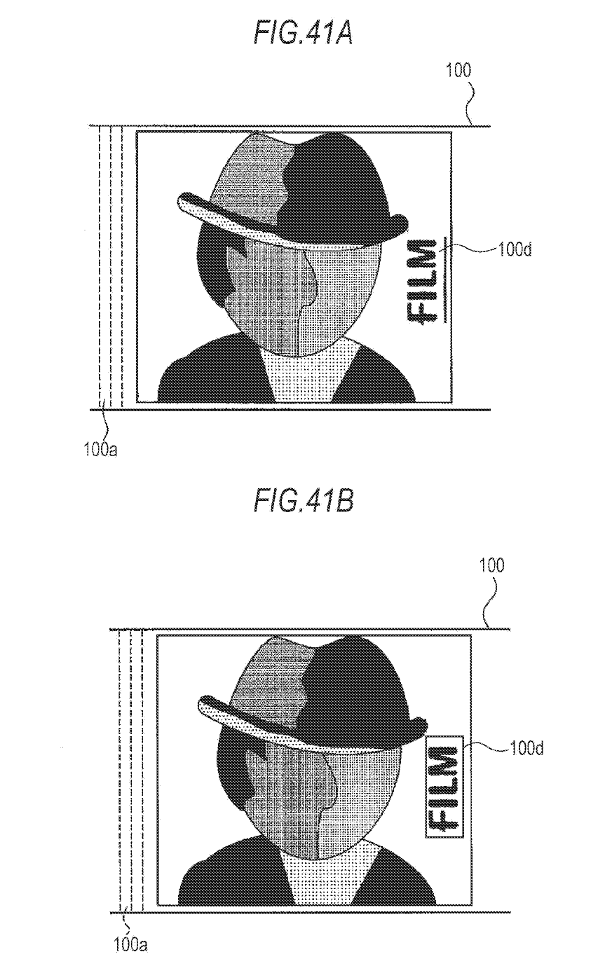

In this embodiment, the detection pattern 100d including the figures shown in FIG. 40A is printed on the lenticular sheet 100 (see FIG. 40B). However, since the straight line portions (see regions surrounded with one-dot chained straight lines in FIG. 40B) parallel to the lenses 100a are short, the detection accuracy may be lowered. Accordingly, as shown in FIG. 41A, a straight line may be printed in the vicinity of the detection pattern 100d so as to be parallel to the longitudinal direction of the detection pattern 100d, that is, the longitudinal direction of the lenses 100a. As shown in FIG. 41B, a frame surrounding the detection pattern 100d may be printed.

Although it has been described in this embodiment that the detection pattern 100d including a figure is selected in step S150, the detection pattern 100d is not limited to the figure, but may include a text. In this case, the font or printing direction is determined so that the straight line portions parallel to the lenses 100a are the longest. Accordingly, since the straight line information increases, it is possible to easily detect the inclination of the lenticular sheet 100, for example, thereby improving the ability as the detection pattern.

It is exemplified that the detection pattern including a text of “FILM” is selected in step S150. First, it is determined that the detection pattern is printed with an angular font, that is, a font (for example, Gothic type) including many straight line portions, so as to increase the number of straight line portions. The length and direction of the straight line portions when the detection pattern is printed with the font having many straight line portions are analyzed and the printing direction is determined so that the direction in which the total length of the straight line portions is the longest is parallel to the longitudinal direction of the lenses 100a. In this case, the printing direction is determined so that the text of “FILM” is arranged in the longitudinal direction of the lenses 100a. Accordingly, as shown in FIG. 41A, a detection pattern 100e of “FILM” is printed on the lenticular sheet 100 with a Gothic type so that the text of “FILM is arranged in the longitudinal direction of the lenses 100a as shown in FIG. 41A. The method of determining the printing direction is not limited to this configuration. For example, the printing direction may be determined so that the direction of the longest straight line portion is parallel to the longitudinal direction of the lenses 100a.

However, even when the detection pattern 100e is printed in the printing direction determined so that the length of the straight line portion parallel to the lenses 100a is the greatest, a case where the straight line portion parallel to the lenses 100a is short to lower the detection accuracy can be considered. Accordingly, as shown in FIG. 41B, by enlarging and printing the detection pattern 100e at a predetermined magnification in the longitudinal direction of the lenses 100a, the straight line information may be made to increase.

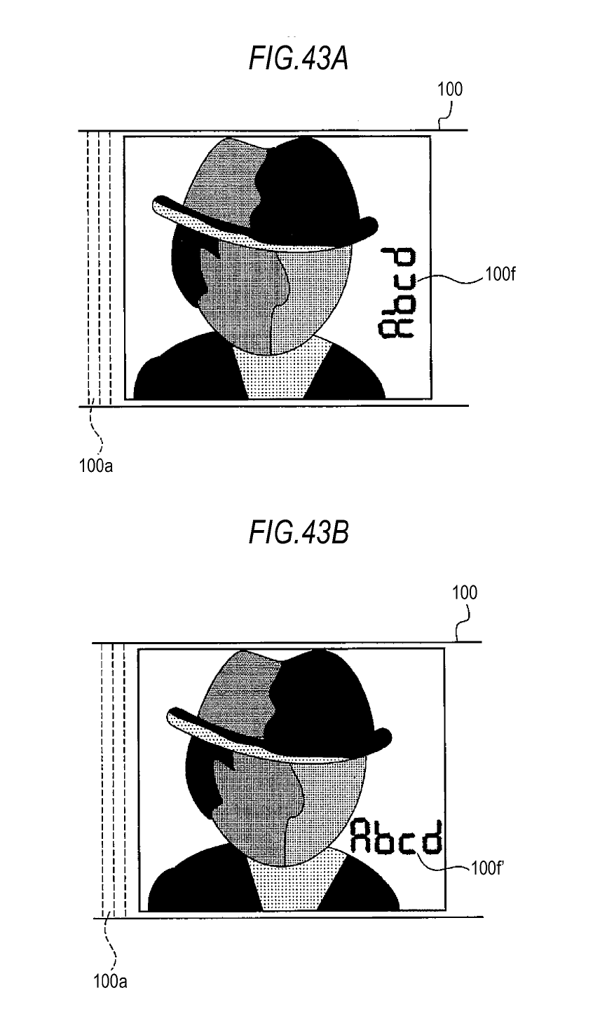

The method of increasing the straight line information is not limited to the method of considering the font. For example, a selected text may be printed in segments. FIG. 43A shows an example where a detection pattern 100f including a text of “Abcd” is printed in seven segments. Since constituent elements of the segments are straight lines, the straight line information increases and a text can be displayed readably.

When a detection pattern is displayed in segments, the number of elements may be counted in the X direction (the horizontal direction of the text) and the Y direction (the vertical direction of the text) and the detection pattern may be printed so that the direction including a larger number of elements is parallel to the longitudinal direction of the lenses 100a. When the text of “Abed” is displayed in seven segments, the number of segments in the X direction is eight and the number of segments in the Y direction is eleven. Accordingly, as shown in FIG. 43B, the detection pattern 100f′ may be printed so that the Y direction is parallel to the longitudinal direction of the lenses 100a.

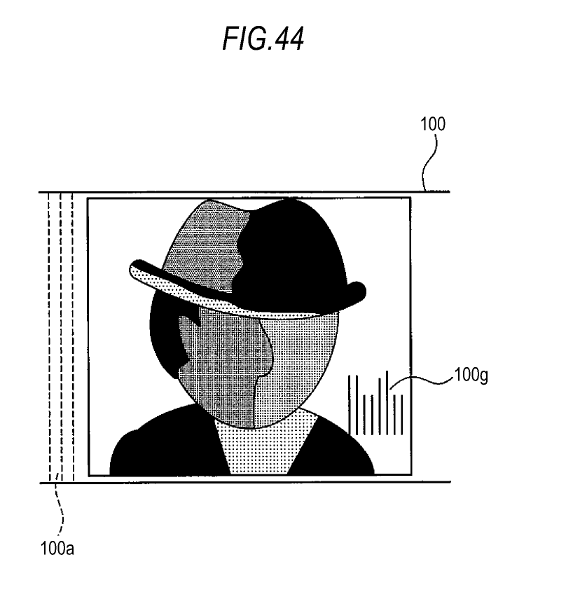

A barcode-like detection pattern (hereinafter, referred to as “barcode-type detection pattern”) may be printed as the detection pattern 100d including a figure. FIG. 44 shows an example where a barcode-type detection pattern 100g is printed. In the barcode-type detection pattern 100g, plural straight lines are arranged in parallel at a predetermined interval like a barcode and the barcode-type detection pattern is printed so that the plural straight lines are parallel to the longitudinal direction of the lenses 100a. As a result, the detection pattern 100g is printed in which the plural straight lines are arranged in the direction perpendicular to the longitudinal direction of the lenses 100a. Accordingly, it is possible to print a detection pattern having a lot of straight line information. Information representing the print position of the detection pattern may be added to the barcode-type detection pattern (see the thirteenth embodiment for the information representing the print position of the detection pattern).

A detection pattern including a combination of a text and a figure may be printed. For example, a detection pattern in which a text of “FILM” and a figure such as a straight line or a frame are combined as shown in FIG. 41A may be printed so that the straight line or the straight line portion of the frame is parallel to the longitudinal direction of the lenses 100a.

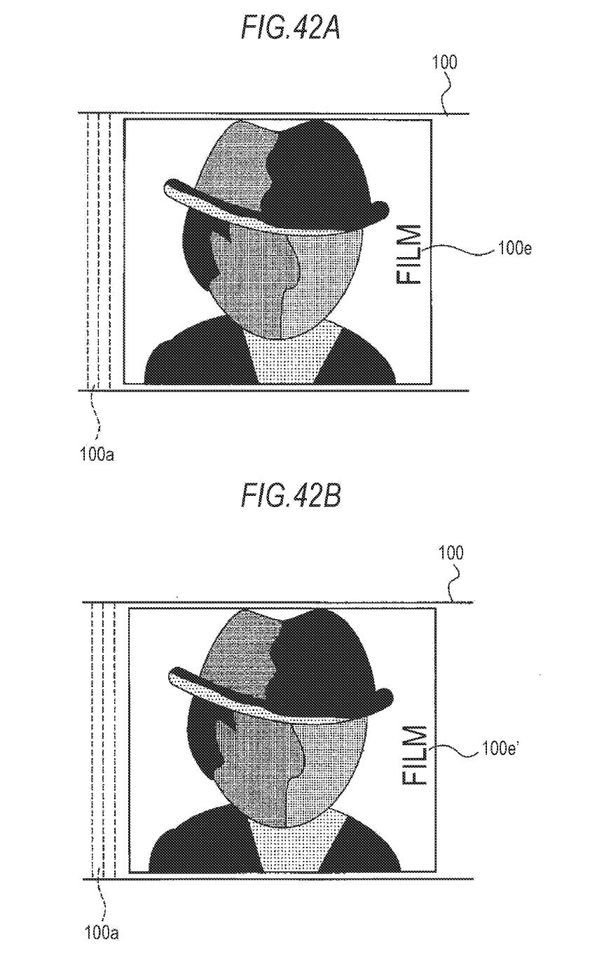

In FIGS. 22A, 22B, and 22C, FIGS. 34A and 34B, FIGS. 36A and 36B, FIG. 40B, FIGS. 41A and 41B, FIGS. 42A and 42B, FIGS. 43A and 43B, and FIG. 44 only some of the lenses 100a are shown, which is intended to inform what the longitudinal direction of the lenses 100a is. The lenses 100a are actually formed all over the lenticular sheet 100. The frame shown in FIGS. 22A, 22B, and 22C, FIGS. 34A and 34B, FIGS. 36A and 36B, FIG. 40B, FIGS. 41A and 41B, FIGS. 42A and 42B, FIGS. 43A and 43B, and FIG. 44 represents the image forming area. The image is displayed weak in the frame representing the image forming area, which is intended to inform that the image is printed in the image forming area. Actually, the frame representing the image forming area and the image are not displayed.

The embodiments of the present invention may be independently put into practice or may be put into practice by a combination of several embodiments.

The application of the present invention is not limited to the sublimation printer using an ink ribbon, and the printing medium is also not limited to the lenticular sheet having a lens face and a printing face. The present invention can be applied to a variety of types of forming an image on a printing medium while forwardly and backwardly conveying the printing medium along the carrier path (such as a thermo-autochrome (TA) printer, an ink jet printer, a fusion thermal transfer type, a silver halide (thermal development and transfer) type, and a Zero Ink (registered trademark)).

What is claimed is:

1. A printing apparatus comprising:
an image acquiring part for acquiring a multi-viewpoint image;
a conveying part for conveying a lenticular sheet having a lens face in which a plurality of strip lenses are aligned continuously and a flat printing face arranged on the opposite side of the lens face;
an image forming area setting part for setting an image forming area on the lenticular sheet to print the multi-viewpoint image based on the acquired multi-viewpoint image;
a print position setting part for setting a print position of a detection pattern including a straight line, based on the acquired multi-viewpoint image, wherein the print position setting part sets the print position of the detection pattern in the image forming area to place the straight line portion of the detection pattern in parallel to the longitudinal direction of the lenses; and
a printing part for printing the detection pattern at the print position of the detection pattern and for printing the multi-viewpoint image in the image forming area.

2. The printing apparatus according to claim 1, further comprising:
a reading part for reading the detection pattern by irradiating light to the lenticular sheet and detecting the light reflected from or transmitted through the lenticular sheet; and
a first inclination detection part for detecting an inclination of the lenticular sheet based on the read result of the detection pattern,
wherein the conveying part has a mechanism for correcting the detected inclination of the lenticular sheet.

3. The printing apparatus according to claim 1, further comprising a sheet size acquiring part for acquiring information representing the size of the lenticular sheet,
wherein the image forming area setting part sets the image forming area based on the acquired information representing the size of the lenticular sheet.

4. The printing apparatus according to claim 3, wherein a sheet size information representing the size of the lenticular sheet is indicated on the lenticular sheet, and
the sheet size acquiring part acquires the sheet size information.

5. The printing apparatus according to claim 1, wherein the image forming area setting part determines whether a viewpoint-reduced area where the number of viewpoints to be printed is reduced exists in the image forming area, and
the print position setting part sets the print position of the detection pattern in the viewpoint-reduced area when the viewpoint-reduced area is determined to exist.

6. The printing apparatus according to claim 1, further comprising a trimming area setting part for setting a trimming area in the image forming area,
wherein the print position setting part sets the print position of the detection pattern in the area other than the trimming area.

7. The printing apparatus according to claim 6, further comprising a cutting part for cutting the trimming area of the lenticular sheet on which the multi-viewpoint image is printed by the printing part.

8. The printing apparatus according to claim 1, wherein the image acquiring part acquires a multi-viewpoint image with a flame added,
the image forming area setting part sets an area in which the frame is printed, out of the area in which the multi-viewpoint image with the flame added is printed, on the lenticular sheet, and
the print position setting part sets the print position of the detection pattern in the area in which the frame is printed.

9. The printing apparatus according to claim 1, wherein the image forming area setting part sets an area to be printed in black in the image forming area based on the acquired multi-viewpoint image, and
the print position setting part sets the print position of the detection pattern in the set area to be printed in black.

10. The printing apparatus according to claim 1, wherein the image forming area setting part sets an area to be printed equal to or less than the predetermined brightness in the image forming area based on the acquired multi-viewpoint image, and
the print position setting part sets the print position of the detection pattern in the area to be printed equal to or less than the predetermined brightness.

11. The printing apparatus according to claim 1, wherein the printing part prints the detection pattern in black.

12. The printing apparatus according to claim, further comprising an average brightness calculating part for calculating an average brightness of the area by extracting an area having the same size as the detection pattern from the image forming area,
wherein the print position setting part sets the print position of the detection pattern in an area of which the calculated average brightness is the lowest, and
the printing part prints the detection pattern in an average color of the area where the calculated average brightness is the lowest.

13. The printing apparatus according to claim, wherein the image forming area setting part sets an area to be printed in a predetermined color of three colors of Y, M, and C in the image forming area based on the acquired multi-viewpoint image,
the print position setting part sets the print position of the detection pattern in the area to be printed in the predetermined color, and
the printing part prints the detection pattern in the predetermined color.

14. The printing apparatus according to claim 1, wherein the image forming area setting part sets an area to be printed in a predetermined color and a color similar to the predetermined color in the image forming area based on the acquired multi-viewpoint image,
the print position setting part sets the print position of the detection pattern in the area to be printed in the predetermined color and the color similar to the predetermined color, and
the printing part prints the detection pattern in the predetermined color.

15. The printing apparatus according to claim 12, wherein the printing part does not print any image in the portion in which the detection pattern is printed.

16. The printing apparatus according to claim 2, further comprising a determining part for determining whether the print position setting part can determine a plurality of print positions for the detection pattern,
wherein when the print position setting part can determine a plurality of print positions for the detection pattern, the print position setting part determines the print position of the detection pattern to any one of the print position closest to the reading part, the print position having the largest length in the direction parallel to the longitudinal direction of the lenses, and the print position closest to an edge portion of the lenticular sheet out of the plurality of print positions for the detection pattern.

17. The printing apparatus according to claim 1, wherein the detection pattern includes a plurality of straight lines arranged in a direction perpendicular to the longitudinal direction of the lenses or in a direction parallel to the longitudinal direction of the lenses.

18. The printing apparatus according to claim 17, wherein the detection pattern includes a straight line representing the print position of the detection pattern.

19. The printing apparatus according to claim 1, wherein the multi-viewpoint image is synthesized by dividing a plurality of images into striped units and arranging the units divided from the same image so as to be separated from each other, and
the detection pattern is a straight line having a width smaller than the width of the striped units.

20. The printing apparatus according to claim 1, wherein the detection pattern is formed of a text, a figure, or a combination of the text and the figure, and
the printing part prints the detection pattern so as to recognize that the detection pattern is formed of a text, a figure, or a combination of the text and the figure.

21. The printing apparatus according to claim 20, wherein the printing part prints the detection pattern so that the longitudinal direction of the detection pattern is parallel to the longitudinal direction of the lenses.

22. The printing apparatus according to claim 20, wherein the printing part prints a straight line in parallel to the longitudinal direction of the detection pattern in adjacent to the detection pattern, or prints a frame surrounding the detection pattern.

23. The printing apparatus according to claim 20, further comprising a detection pattern information acquiring part for acquiring information on the detection pattern,
wherein the printing part prints the detection pattern in a font including many straight line portions or a segment display including many straight line portions when the information of the detection pattern is representing the detection pattern included with a text.

24. The printing apparatus according to claim 20, further comprising a detection pattern analyzing part for analyzing the directions and the lengths of the straight lines included in the detection pattern,
wherein the printing part prints the detection pattern with the direction of the longest straight line being parallel to the longitudinal direction of the lenses, or with the direction in which the total length of the straight lines being the largest is parallel to the longitudinal direction of the lenses.

25. The printing apparatus according to claim 20, wherein the printing part prints the detection pattern with the enlarged detection pattern in the longitudinal direction of the lenses.

26. The printing apparatus according to claim 1, wherein the printing part prints an arbitrary straight line at an arbitrary position of the lenticular sheet, the printing apparatus further comprising, a second inclination detecting part for detecting the inclination of the lenticular sheet based on the straight line printed at an arbitrary position of the lenticular sheet, wherein
the conveying part corrects the detected inclination of the lenticular sheet, and
the printing part prints the detection pattern on the lenticular sheet with the inclination being corrected by the conveying part.
